(19) United States
(12) Patent Application Publication
(10) Pub. No.: US 2025/0164712 A1
(43) Pub. Date: May 22, 2025

(54) SELF-ALIGNED STRUCTURE AND METHOD ON INTERPOSER-BASED PIC

(71) Applicant: POET Technologies, Inc., Allentown, PA (US)

(72) Inventor: Suresh Venkatesan, Los Gatos, CA (US)

(21) Appl. No.: 18/895,436

(22) Filed: Sep. 25, 2024

Related U.S. Application Data
(63) Continuation of application No. 18/753,152, filed on Jun. 25, 2024.
Application No. 18/753,152 is a continuation-in-part of application No. 18/214,076, filed on Jun. 26, 2023, now Pat. No. 12,222,566.
Application No. 18/214,076 is a continuation of application No. 17/499,323, filed on Oct. 12, 2021, now Pat. No. 11,686,906.
(63) Continuation of application No. 18/753,162, filed on Jun. 25, 2024.
Application No. 18/753,162 is a continuation-in-part of application No. 18/214,076, filed on Jun. 26, 2023, now Pat. No. 12,222,566.
Application No. 18/214,076 is a continuation of application No. 17/499,323, filed on Oct. 12, 2021, now Pat. No. 11,686,906.
(60) Provisional application No. 63/090,692, filed on Oct. 12, 2020.
(60) Provisional application No. 63/090,692, filed on Oct. 12, 2020.

(51) Int. Cl. G02B 6/42

(52) U.S. Cl. CPC G02B 6/4234; G02B 6/4203; G02B 6/423; G02B 6/4238

(57) ABSTRACT

Structures and methods that provide and maintain precise lateral registration between mounted optical devices and waveguides formed on an optical interposer structure use a methodology in which a same patterned mask layer is utilized to pattern a plurality of alignment features requiring alignment and the waveguide cores to which mounted devices are aligned in the formation of photonic integrated circuits. Subsequent burial and re-exposure of the patterned mask layer in subsequent processing steps maintains the feature registration provided with the use of the self-aligned layer throughout the formation of the optical interposer and the alignment structures provided thereon.

The present invention is a continuation of U.S. patent Ser. No. 18/753,152, filed on Jun. 25, 2024, which is a continuation in part and claims priority to U.S. patent application Ser. No. 18/214,076, filed on Jun. 26, 2023, entitled “Self-Aligned Structure and Method on Interposer-based PIC”, which is a continuation of U.S. patent application Ser. No. 17/499,323, filed on Oct. 12, 2021, entitled “Self-Aligned Structure and Method on Interposer-based PIC”, which claims priority from U.S. Provisional Patent Application Ser. No. 63/090,692, filed on Oct. 12, 2020, entitled “Self-Aligned Structure and Method on Interposer-based PIC”, hereby incorporated by reference in their entirety.

The present invention is a continuation of U.S. patent Ser. No. 18/753,162, filed on Jun. 25, 2024, which is a continuation in part and claims priority to U.S. patent application Ser. No. 18/214,076, filed on Jun. 26, 2023, entitled “Self-Aligned Structure and Method on Interposer-based PIC”, which is a continuation of U.S. patent application Ser. No. 17/499,323, filed on Oct. 12, 2021, entitled “Self-Aligned Structure and Method on Interposer-based PIC”, which claims priority from U.S. Provisional Patent Application Ser. No. 63/090,692, filed on Oct. 12, 2020, entitled “Self-Aligned Structure and Method on Interposer-based PIC”, hereby incorporated by reference in their entirety.

This application relates to U.S. patent application Ser. No. 17/499,337, filed on Oct. 12, 2021, entitled Self-Aligned Structure and Method on Interposer-based PIC, filed on Oct. 12, 2021, Attorney docket number OPE-112B, hereby incorporated by reference in its entirety.

### FIELD OF THE INVENTION

The present invention relates to photonic integrated circuits and to the methods of formation and use of alignment features that are formed on an optical interposer structure.

### BACKGROUND

Developments in methods of manufacturing of photonic integrated circuits (PICs) have enabled the fabrication and integration of electrical, optoelectrical, and optical devices on the same substrate. In some applications, pre-formed optoelectrical die are integrated within the PICs to provide functionality that may not be easily obtainable with similar devices formed directly on or within the substrate. Semiconductor lasers that emit signals at specific optical wavelengths suited for optical communications, for example, are readily fabricated from gallium arsenide and indium phosphide materials. The fabrication of devices that emit at these telecommunications wavelengths is not practical or achievable using silicon or insulating substrates, and thus requires the integration of pre-formed lasers into PIC mounting structures. The integration of optoelectrical devices, such as lasers into PICs, however, requires precise placement and subsequent alignment after placement of optical and electrical features on the die with optical and electrical features on the mounting substrate. Optical output from an integrated laser die, for example, must align with optical planar waveguides or other optical devices on the substrate to enable effective integration of the laser on the PIC substrate.

Effective alignment methodologies require the formation of alignment structures and strategies for which the alignment structures on mounted devices are compatible with alignment structures on the substrate or mounting structure and this compatibility can provide both technical and economic benefits in the manufacturing of PICs. Methodologies, for example, that enable the implementation of passive alignment techniques that do not require direct feedback during the alignment process are preferable over techniques and integration schemes that require potentially time-consuming active alignment steps, as are methodologies that are compatible with semiconductor and integrated circuit fabrication techniques and methods, and that are suitable for high-volume production.

Thus, a need in the art exists for structures and methods that enable passive alignment and integration of optical and optoelectrical devices with waveguides and other structures and devices on the substrates and interposers used in PIC assemblies.

### BRIEF DESCRIPTION OF THE DRAWINGS

FIG. 1A shows a schematic top-down drawing of an assembly having an embodiment of an optical interposer structure with self-aligned alignment aids formed in alignment with a patterned planar waveguide.

FIG. 1B shows a cross-sectional drawing of the embodiment of FIG. 1A.

FIG. 2A shows schematic perspective drawings that illustrate aspects of the alignment of the optical axes of two optical devices.

FIG. 2B shows schematic perspective drawings that illustrate aspects of the alignment of the optical axes of two optical devices mounted or otherwise formed on a substrate.

FIG. 2C shows a side view taken in a y-z plane of the perspective drawing of FIG. 2B.

FIG. 2D shows a top view taken in an x-y plane of the perspective drawing of FIG. 2B.

FIGS. 3A to 3E show a sequence of cross-sectional drawings that illustrate the formation of a planar waveguide layer on an interposer base structure in some embodiments.

FIG. 3A shows a schematic cross-sectional drawing of a portion of an embodiment of an optical interposer structure 104 having a first portion of a planar waveguide layer formed on an interposer base structure 101.

FIG. 3B shows a schematic cross-sectional drawing of a portion of an embodiment of an optical interposer structure 104 having a first patterned mask layer on the first portion of a planar waveguide layer formed on an interposer base structure 101.

FIG. 3C(a) shows a schematic cross-sectional drawing of a portion of an embodiment of an optical interposer structure 104 having a first patterned mask layer on the first portion of a planar waveguide layer formed on an interposer base structure 101 after patterning of a portion of the core layer 105_{core} to form a first portion of a patterned planar waveguide in the form of a rib waveguide.

FIG. 3C(b) shows a schematic cross-sectional drawing of a portion of another embodiment of an optical interposer structure 104 having a first patterned mask layer on the first portion of a planar waveguide layer formed on an interposer base structure 101 after patterning of the full thickness of the core layer 105_{core} to form a first portion of a patterned planar waveguide.

FIG. 3C(c) shows a schematic cross-sectional drawing of a portion of another embodiment of an optical interposer structure 104 having a first patterned mask layer on the first portion of a planar waveguide layer formed on an interposer base structure 101 after patterning of the full thickness of the core layer 105_{core} and the full thickness of the bottom cladding layer to form a first portion of a patterned planar waveguide.

FIG. 3D (a) shows a schematic cross-sectional drawing of the portion of the embodiment of an optical interposer structure 104 of FIG. 3C(a) after removal of the first patterned mask layer and formation of a second portion of a planar waveguide layer.

FIG. 3D (b) shows a schematic cross-sectional drawing of the portion of the embodiment of an optical interposer structure 104 of FIG. 3C(b) after removal of the first patterned mask layer and formation of a second portion of a planar waveguide layer.

FIG. 3D(c) shows a schematic cross-sectional drawing of the portion of the embodiment of an optical interposer structure 104 of FIG. 3C(c) after removal of the first patterned mask layer and formation of a second portion of a planar waveguide layer.

FIG. 3E shows a schematic cross-sectional drawing of the portion of the embodiment of an optical interposer structure 104 of FIG. 3D (b) after formation of an electrical interconnect layer on the second portion of the planar waveguide layer.

FIGS. 4A to 4E show a sequence of cross-sectional drawings that illustrate the formation of a planar waveguide layer on an interposer base structure in some embodiments.

FIG. 4A shows a schematic cross-sectional drawing of a portion of an embodiment of an optical interposer structure 104 having a first portion of a planar waveguide layer formed on an interposer base structure 101.

FIG. 4B shows a schematic cross-sectional drawing of a portion of an embodiment of an optical interposer structure 104 having a first patterned mask layer on the first portion of a planar waveguide layer formed on an interposer base structure 101.

FIG. 4C (a) shows a schematic cross-sectional drawing of a portion of an embodiment of an optical interposer structure 104 having a first patterned mask layer on the first portion of a planar waveguide layer formed on an interposer base structure 101 after patterning of the top cladding layer and a portion of the core layer 105_{core} to form a first portion of a patterned planar waveguide in the form of a rib waveguide.

FIG. 4C (b) shows a schematic cross-sectional drawing of a portion of another embodiment of an optical interposer structure 104 having a first patterned mask layer on the first portion of a planar waveguide layer formed on an interposer base structure 101 after patterning of the top cladding layer and the full thickness of the core layer 105_{core} to form a first portion of a patterned planar waveguide.

FIG. 4C (c) shows a schematic cross-sectional drawing of a portion of another embodiment of an optical interposer structure 104 having a first patterned mask layer on the first portion of a planar waveguide layer formed on an interposer base structure 101 after patterning of the top cladding layer, the full thickness of the core layer 105_{core}, and the full thickness of the bottom cladding layer to form a first portion of a patterned planar waveguide.

FIG. 4D (a) shows a schematic cross-sectional drawing of the portion of the embodiment of an optical interposer structure 104 of FIG. 4C (a) after removal of the first patterned mask layer and formation of a second portion of a planar waveguide layer.

FIG. 4D (b) shows a schematic cross-sectional drawing of the portion of the embodiment of an optical interposer structure 104 of FIG. 4C (b) after removal of the first patterned mask layer and formation of a second portion of a planar waveguide layer.

FIG. 4D (c) shows a schematic cross-sectional drawing of the portion of the embodiment of an optical interposer structure 104 of FIG. 4C (c) after removal of the first patterned mask layer and formation of a second portion of a planar waveguide layer.

FIG. 4E shows a schematic cross-sectional drawing of the portion of the embodiment of an optical interposer structure 104 of FIG. 4D (b) after formation of an electrical interconnect layer on the second portion of the planar waveguide layer.

FIG. 5 shows a flowchart for method 110A for forming embodiments of an optical interposer structure having alignment aids formed in a cavity, wherein the alignment aids are formed from a same patterned mask layer used in the formation of patterned planar waveguide cores.

FIG. 6A-6I show a sequence of perspective drawings that illustrate the formation of an optical interposer structure having alignment aids formed in a cavity wherein the alignment aids formed in the cavity are formed using a same patterned mask layer as planar waveguides on the optical interposer structure.

FIG. 6A shows a perspective drawing of a layered film structure used in embodiments of an optical interposer structure wherein the layered film structure comprises a first portion 105ₚₜ₁ of a planar waveguide layer 105 disposed on a base structure 101.

FIG. 6B shows a perspective drawing of a portion of an embodiment of an optical interposer structure 104 after formation of a first patterned mask layer 116_{SA}-1 comprising alignment pillar patterns 116_{SA}-1a for the formation of all or a portion of alignment pillars 134_{SA}, planar waveguide core patterns 116_{SA}-1b for the formation of all or a portion of patterned planar waveguide cores 144_{SA}, and fiducial patterns 116_{SA}-1c for the formation of all or a portion of fiducials 114_{SA}.

FIG. 6C shows a perspective drawing of a portion of an embodiment of an optical interposer structure 104 after patterning all or a portion of the planar waveguide layer 105ₚₜ₁ to form a plurality of alignment pillars 134_{SA}, patterned planar waveguide cores 144_{SA}, and fiducials 114_{SA}.

FIG. 6D shows a perspective drawing of a portion of an embodiment of an optical interposer structure 104 after formation of a second patterned mask layer 116-2 and removal of the first patterned mask layer 116-1 from all or a portion of the patterned planar waveguide cores 144.

FIG. 6E shows a perspective drawing of a portion of an embodiment of an optical interposer structure 104 after removal of the second patterned mask layer 116-2.

FIG. 6F shows a perspective drawing of a portion of an embodiment of an optical interposer structure 104 after formation of a second portion 105ₚₜ₂ of planar waveguide layer 105.

FIG. 6G shows a perspective drawing of a portion of an embodiment of an optical interposer structure 104 after formation of a third patterned mask layer 116-3 comprising patterned features for the formation of one or more cavities 148,149 having fiducials 114 and alignment pillars 134 within the one or more cavities 148,149.

FIG. 6H shows a perspective drawing of a portion of an embodiment of an optical interposer structure 104 after formation of cavities 148,149 in planar waveguide layer 105, wherein the cavities in the embodiment have alignment pillars 134_{SA} and fiducial 114_{SA} formed in alignment with the buried patterned planar waveguide cores 144_{SA}.

FIG. 6I shows a perspective drawing of a portion of an embodiment of an optical interposer structure 104 after optional removal of the third patterned mask layer 116-3.

FIGS. 7A-7I show cross-sectional schematic drawings of the formation of an embodiment of an optical interposer structure 104 having self-aligned alignment aids in a device mounting cavity 148 wherein the self-aligned alignment aids comprise alignment pillars 134 and fiducial 114 formed in alignment with a patterned planar waveguide core 144.

FIG. 7A shows a cross-sectional schematic drawing of a portion of an embodiment of optical interposer structure 104 after formation of interposer base structure 101 as in Step 110A-1.

FIG. 7B shows a cross-sectional schematic drawing of a portion of an embodiment of optical interposer structure 104 after formation of first portion 105ₚₜ₁ of planar waveguide layer 105 as in Step 110A-2, wherein the first portion 105ₚₜ₁ of planar waveguide layer 105 comprises a core layer 105_{core} disposed on bottom cladding layer 105_{bc}.

FIG. 7C shows a cross-sectional schematic drawing of a portion of an embodiment of optical interposer structure 104 after formation of first patterned mask layer 116-1 on first portion 105ₚₜ₁ of planar waveguide layer 105 as in Step 110A-3.

FIG. 7D shows a cross-sectional schematic drawing of a portion of an embodiment of optical interposer structure 104 after patterning of first portion 105ₚₜ₁ of planar waveguide layer 105 as in Step 110A-4.

FIG. 7E shows a cross-sectional schematic drawing of a portion of an embodiment of optical interposer structure 104 after formation of second patterned mask layer 116-2 and removal of patterned mask layer 116-1 from patterned planar waveguide core 144 as in Step 110A-5.

FIG. 7F shows a cross-sectional schematic drawing of a portion of an embodiment of optical interposer structure 104 after removal of second patterned mask layer 116-2 as in Step 110A-5 and formation of second portion 105ₚₜ₂ of planar waveguide layer 105 as in Step 110A-6.

FIGS. 7G-7I show cross-sectional schematic drawings of the formation of cavities 148 having self-aligned alignment pillars 134_{SA} in alignment with patterned planar waveguide cores 144_{SA} in an embodiment of an optical interposer structure 104 having self-aligned alignment aids.

FIG. 7G shows a cross-sectional schematic drawing of a portion of an embodiment of optical interposer structure 104 after formation of a third patterned mask layer 116-3 on second portion 105ₚₜ₂ of planar waveguide layer 105 as in Step 110A-7, wherein the third patterned mask layer 116-3 comprises patterns to facilitate formation of cavity 148 in planar waveguide layer 105.

FIG. 7H shows a cross-sectional schematic drawing of a portion of an embodiment of optical interposer structure 104 after formation cavity 148 in planar waveguide layer 105 as in Step 110A-8.

FIG. 7I shows a cross-sectional schematic drawing of a portion of an embodiment of optical interposer structure 104 after optional removal of third pattered mask layer 116-3 as in Step 110A-9.

FIG. 8 shows a flowchart for method 110B for forming embodiments of an optical interposer structure having alignment aids formed at multiple heights in a cavity, wherein the alignment aids at a lower height are formed from a same patterned mask layer used in the formation of patterned planar waveguides cores.

FIGS. 9A-9I show cross-sectional schematic drawings of the formation of an embodiment of an optical interposer structure 104 having self-aligned alignment aids in a device mounting cavity 148 wherein the self-aligned alignment aids comprise alignment pillars 134_{SA},134b formed at multiple heights in cavity 148.

FIG. 9A shows a cross-sectional schematic drawing of a portion of an embodiment of optical interposer structure 104 after formation of interposer base structure 101 as in Step 110B-1.

FIG. 9B shows a cross-sectional schematic drawing of a portion of an embodiment of optical interposer structure 104 after formation of first portion 105ₚₜ₁ of planar waveguide layer 105 as in Step 110B-2, wherein the first portion 105ₚₜ₁ of planar waveguide layer 105 comprises a core layer 105_{core} disposed on bottom cladding layer 105_{bc}.

FIG. 9C shows a cross-sectional schematic drawing of a portion of an embodiment of optical interposer structure 104 after formation of first patterned mask layer 116_{SA}-1 on first portion 105ₚₜ₁ of planar waveguide layer 105 as in Step 110B-3, wherein the first patterned mask layer 116_{SA}-1 comprises patterns to facilitate formation of alignment pillars 134_{SA} formed self-aligned with fiducials 114_{SA} and patterned planar waveguide cores 144_{SA}.

FIG. 9D shows a cross-sectional schematic drawing of a portion of an embodiment of optical interposer structure 104 after patterning of first portion 105ₚₜ₁ of planar waveguide layer 105 as in Step 110B-4.

FIG. 9E shows a cross-sectional schematic drawing of a portion of an embodiment of optical interposer structure 104 after formation of second patterned mask layer 116-2 and removal of patterned mask layer 116_{SA}-1 from patterned planar waveguide core 144 as in Step 110B-5.

FIG. 9F shows a cross-sectional schematic drawing of a portion of an embodiment of optical interposer structure 104 after removal of second patterned mask layer 116-2 as in Step 110B-5 and formation of second portion 105ₚₜ₂ of planar waveguide layer 105 as in Step 110B-6.

FIGS. 9G-9I show cross-sectional schematic drawings of the formation of cavities 148 that include self-aligned alignment pillars 114_{SA},134_{SA} formed in alignment with patterned planar waveguide cores 144_{SA} at a first elevation in the cavity 148 and alignment pillars 134b formed at a second elevation in the cavity in an embodiment of an optical interposer structure 104 having self-aligned alignment aids formed at multiple heights in cavity 148.

FIG. 9G shows a cross-sectional schematic drawing of a portion of an embodiment of optical interposer structure 104 after formation of a third patterned mask layer 116-3 on second portion 105ₚₜ₂ of planar waveguide layer 105 as in Step 110B-7, wherein the third patterned mask layer 116-3 comprises patterns to facilitate formation of alignment pillars 134b at a height that differs from that of the alignment pillars 134_{SA}.

FIG. 9H shows a cross-sectional schematic drawing of a portion of an embodiment of optical interposer structure 104 after formation of a third portion 105ₚₜ₃ of planar waveguide layer 105 as in Step 110B-8.

FIG. 9I shows a cross-sectional schematic drawing of a portion of an embodiment of optical interposer structure 104 after formation of a fourth patterned mask layer 116-4 on third portion 105ₚₜ₃ of planar waveguide layer 105 as in Step 110B-9, wherein the fourth patterned mask layer 116-4 comprises patterns to facilitate formation of cavity 148 in planar waveguide layer 105.

FIG. 9J shows a cross-sectional schematic drawing of a portion of an embodiment of optical interposer structure 104 after formation of cavity 148 in planar waveguide layer 105 as in Step 110B-10 wherein cavity 148 includes alignment pillars 134_{SA}, 134b formed at multiple heights within cavity 148.

FIG. 10 shows a flowchart for method 110C for forming embodiments of an optical interposer structure 104 having alignment aids formed at multiple heights in cavity 148, wherein the alignment aids at an upper height are formed from a same patterned mask layer used in the formation of patterned planar waveguides cores 144.

FIGS. 11A-11I show cross-sectional schematic drawings of the formation of an embodiment of an optical interposer structure 104 having alignment aids in a device mounting cavity 148 wherein the alignment aids include alignment pillars 134a,134b formed at multiple heights in cavity 148, and wherein the alignment pillars 134a formed at an upper height are formed self-aligned using a same patterned mask layer as used in the formation of patterned planar waveguides cores 144.

FIG. 11A shows a cross-sectional schematic drawing of a portion of an embodiment of optical interposer structure 104 after formation of interposer base structure 101 as in Step 110C-1.

FIG. 11B shows a cross-sectional schematic drawing of a portion of an embodiment of optical interposer structure 104 after formation of first portion 105ₚₜ₁ of planar waveguide layer 105 as in Step 110C-2.

FIG. 11C shows a cross-sectional schematic drawing of a portion of an embodiment of optical interposer structure 104 after formation of first patterned mask layer 116-1 on first portion 105ₚₜ₁ of planar waveguide layer 105 as in Step 110C-3.

FIG. 11D shows a cross-sectional schematic drawing of a portion of an embodiment of optical interposer structure 104 after formation of a second portion 105ₚₜ₂ of planar waveguide layer 105 as in Step 110C-4.

FIG. 11E shows a cross-sectional schematic drawing of a portion of an embodiment of optical interposer structure 104 after formation of third portion 105ₚₜ₃ of planar waveguide layer 105 as in Step 110C-5, wherein the third portion 105ₚₜ₃ of planar waveguide layer 105 comprises a core layer 105_{core} disposed on bottom cladding layer 105_{bc}.

FIG. 11F shows a cross-sectional schematic drawing of a portion of an embodiment of optical interposer structure 104 after formation of a second patterned mask layer 116-2 on third portion 105ₚₜ₃ of planar waveguide layer 105 as in Step 110C-6, wherein the second patterned mask layer 116-2 comprises patterns to facilitate formation of alignment pillars 134b formed self-aligned with fiducials 114 and patterned planar waveguide cores 144.

FIG. 11G shows a cross-sectional schematic drawing of a portion of an embodiment of optical interposer structure 104 after patterning of third portion 105ₚₜ₃ of planar waveguide layer 105 as in Step 110C-7.

FIG. 11H shows a cross-sectional schematic drawing of a portion of an embodiment of optical interposer structure 104 after formation of third patterned mask layer 116-3 and removal of second patterned mask layer 116-2 from patterned planar waveguide core 144 as in Step 110C-8.

FIG. 11I shows a cross-sectional schematic drawing of a portion of an embodiment of optical interposer structure 104 after removal of third patterned mask layer 116-3 as in Step 110C-8 and formation of fourth portion 105ₚₜ₄ of planar waveguide layer 105 as in Step 110C-9.

FIG. 11J shows a cross-sectional schematic drawing of a portion of an embodiment of optical interposer structure 104 after formation of a fourth patterned mask layer 116-4 on fourth portion 105ₚₜ₄ of planar waveguide layer 105 as in Step 110C-10, wherein the fourth patterned mask layer 116-4 comprises patterns to facilitate formation of cavity 148 in planar waveguide layer 105.

FIG. 11K shows a cross-sectional schematic drawing of a portion of an embodiment of optical interposer structure 104 after formation of cavity 148 in planar waveguide layer 105 as in Step 110C-11 wherein cavity 148 includes alignment pillars 134a,134b formed at multiple heights, and wherein alignment pillars 134b are formed self-aligned with patterned planar waveguide cores 144.

FIG. 12 shows a flowchart for method 110D for forming embodiments of an optical interposer structure 104 having alignment aids formed at multiple heights in cavity 148, wherein the alignment aids at a lower height are formed from a same patterned mask layer used in the formation of patterned planar waveguides cores 144.

FIGS. 13A-13I show cross-sectional schematic drawings of the formation of an embodiment of an optical interposer structure 104 having alignment aids formed at a plurality of heights in cavity 148, wherein the alignment aids formed at a lowest height are formed self-aligned with patterned planar waveguides cores 144 in the embodiment.

FIG. 13A shows a cross-sectional schematic drawing of a portion of an embodiment of optical interposer structure 104 after formation of first portion 105ₚₜ₁ and second portion 105ₚₜ₂ of planar waveguide layer 105 having fiducial 114 and alignment pillars 134a formed self-aligned with patterned planar waveguide cores 144 as in Steps 110D-1 to 110D-6 of method 110D (similar to Steps 110B-1 to 110B-6 of method 110B).

FIG. 13B shows a cross-sectional schematic drawing of a portion of an embodiment of optical interposer structure 104 after formation of a third patterned mask layer 116-3 on second portion 105ₚₜ₂ of planar waveguide layer 105 as in Step 110D-7, wherein the third patterned mask layer 116-3 comprises patterns to facilitate formation of alignment pillars 134b at a height that differs from that of the alignment pillars 134a.

FIG. 13C shows a cross-sectional schematic drawing of a portion of an embodiment of optical interposer structure 104 after formation of a third portion 105ₚₜ₃ of planar waveguide layer 105 as in Step 110D-8.

FIG. 13D shows a cross-sectional schematic drawing of a portion of an embodiment of optical interposer structure 104 after formation of a fourth patterned mask layer 116-4 on third portion 105ₚₜ₃ of planar waveguide layer 105 as in Step 110D-9, and after formation of a fourth portion 105ₚₜ₄ of planar waveguide layer 105 as in Step 110D-10, wherein the fourth patterned mask layer 116-4 comprises patterns to facilitate formation of alignment pillars 134c at a height that differs from that of the alignment pillars 134a and alignment pillars 134b.

FIG. 13E shows a cross-sectional schematic drawing of a portion of an embodiment of optical interposer structure 104 after formation of an nth patterned mask layer 116-n on an (n−1)^{th} portion 105ₚₜ₍ₙ₋₁₎ of planar waveguide layer 105 as in Step 110D-11, and after formation of an nth portion 105ₚₜₙ of planar waveguide layer 105 as in Step 110D-12.

FIG. 13F shows a cross-sectional schematic drawing of a portion of an embodiment of optical interposer structure 104 after formation of an (n+1)^{th} patterned mask layer 116-(n+1) on nth portion 105ₚₜₙ of planar waveguide layer 105 as in Step 110D-13, wherein the (n+1)^{th} patterned mask layer 116-(n+1) comprises patterns to facilitate formation of cavity 148 in planar waveguide layer 105.

FIG. 13G shows a cross-sectional schematic drawing of a portion of an embodiment of optical interposer structure 104 after formation of cavity 148 in planar waveguide layer 105 as in Step 110D-14 wherein cavity 148 includes alignment pillars formed at a plurality of heights.

FIG. 14 shows an assembly 102 comprising a portion of an embodiment of optical interposer structure 104 having self-aligned alignment pillars formed at a plurality of elevations in cavity 148.

FIG. 15 shows a flowchart for method 110E for forming embodiments of an optical interposer structure 104 having a dual waveguide structure.

FIGS. 16A-16O show cross-sectional schematic drawings of the formation of an embodiment of an optical interposer structure 104 having a dual waveguide structure wherein self-aligned alignment aids 134_{lower} are formed in a first cavity 148_{lower} in alignment with a lower patterned planar waveguide core 144_{lower} and alignment aids 134ᵤₚₚₑᵣ are formed in a second cavity 148ᵤₚₚₑᵣ in alignment with an upper patterned planar waveguide core 144ᵤₚₚₑᵣ.

FIGS. 16A-16F show cross-sectional schematic drawings of the formation of a lower planar waveguide layer 105_{lower} and the formation of patterned planar waveguide cores 144_{SA-lower} and associated self-aligned alignment pillars 134_{SA-lower} and fiducials 114_{SA-lower} of a dual waveguide structure in an embodiment of optical interposer structure 104.

FIG. 16A shows a cross-sectional schematic drawing of a portion of an embodiment of optical interposer structure 104 after formation of interposer base structure 101 as in Step 110E-1.

FIG. 16B shows a cross-sectional schematic drawing of a portion of an embodiment of optical interposer structure 104 after formation of first portion 105_{pt1-lower} of lower planar waveguide layer 105_{lower} as in Step 110E-2, wherein the first portion 105_{pt1-lower} of planar waveguide layer 105_{lower} comprises a core layer 105 core-lower disposed on bottom cladding layer 105_{bc-lower}.

FIG. 16C shows a cross-sectional schematic drawing of a portion of an embodiment of optical interposer structure 104 after formation of first patterned mask layer 116_{SA}-1 on first portion 105_{pt1-lower} of planar waveguide layer 105_{lower} as in Step 110E-3, wherein the first patterned mask layer 116_{SA}-1 comprises patterns to facilitate formation of alignment pillars 134_{SA-lower} and fiducials 114_{SA-lower} in self-alignment with lower patterned planar waveguide cores 144_{SA-lower}.

FIG. 16D shows a cross-sectional schematic drawing of a portion of an embodiment of optical interposer structure 104 after patterning of first portion 105_{pt1-lower} of planar waveguide layer 105_{lower} as in Step 110E-4.

FIG. 16E shows a cross-sectional schematic drawing of a portion of an embodiment of optical interposer structure 104 after formation of second patterned mask layer 116-2 and removal of patterned mask layer 116_{SA}-1 from patterned planar waveguide core 144_{SA-lower} as in Step 110E-5.

FIG. 16F shows a cross-sectional schematic drawing of a portion of an embodiment of optical interposer structure 104 after removal of second patterned mask layer 116-2 as in Step 110E-5 and formation of second portion 105_{pt2-lower} of planar waveguide layer 105_{lower} as in Step 110E-6.

FIGS. 16G-16K show cross-sectional schematic drawings of the formation of an upper planar waveguide layer 105ᵤₚₚₑᵣ and the formation of patterned planar waveguide cores 144_{SA-upper} and associated self-aligned alignment pillars 134_{SA-upper} and fiducials 114_{SA-upper} of a dual waveguide structure in an embodiment of optical interposer structure 104.

FIG. 16G shows a cross-sectional schematic drawing of a portion of an embodiment of optical interposer structure 104 after formation of first portion 105ₚₜ₁₋ᵤₚₚₑᵣ of upper planar waveguide layer 105ᵤₚₚₑᵣ as in Step 110E-7, wherein the first portion 105ₚₜ₁₋ᵤₚₚₑᵣ of planar waveguide layer 105ᵤₚₚₑᵣ comprises a core layer 105_{core-upper} disposed on bottom cladding layer 105_{bc-upper}.

FIG. 16H shows a cross-sectional schematic drawing of a portion of an embodiment of optical interposer structure 104 after formation of a third patterned mask layer 116_{SA}-3 on first portion 105ₚₜ₁₋ᵤₚₚₑᵣ of upper planar waveguide layer 105ᵤₚₚₑᵣ as in Step 110E-8, wherein the third patterned mask layer 116_{SA}-3 comprises patterns to facilitate formation of alignment pillars 134_{SA-upper} and fiducials 114_{SA-upper} in self-alignment with upper patterned planar waveguide cores 144_{SA-upper}.

FIG. 16I shows a cross-sectional schematic drawing of a portion of an embodiment of optical interposer structure 104 after patterning of first portion 105ₚₜ₁₋ᵤₚₚₑᵣ of upper planar waveguide layer 105ᵤₚₚₑᵣ as in Step 110E-9.

FIG. 16J shows a cross-sectional schematic drawing of a portion of an embodiment of optical interposer structure 104 after formation of fourth patterned mask layer 116-4 and removal of third patterned mask layer 116-3 from patterned planar waveguide core 144ᵤₚₚₑᵣ as in Step 110E-10.

FIG. 16K shows a cross-sectional schematic drawing of a portion of an embodiment of optical interposer structure 104 after removal of fourth patterned mask layer 116-4 as in Step 110E-10 and formation of second portion 105ₚₜ₂₋ᵤₚₚₑᵣ of upper planar waveguide layer 105ᵤₚₚₑᵣ as in Step 110E-11.

FIGS. 16L-16O show cross-sectional schematic drawings of the formation of an upper cavity 148ᵤₚₚₑᵣ in the upper planar waveguide layer 105ᵤₚₚₑᵣ and a portion of the lower planar waveguide layer 105_{lower} and a lower cavity 148_{lower} in the upper planar waveguide layer 105ᵤₚₚₑᵣ and the lower planar waveguide layer 105_{lower} in an embodiment of optical interposer structure 104 having a dual waveguide structure

FIG. 16L shows a cross-sectional schematic drawing of a portion of an embodiment of optical interposer structure 104 after formation of a fifth patterned mask layer 116-5 on second portion 105ₚₜ₂₋ᵤₚₚₑᵣ of upper planar waveguide layer 105ᵤₚₚₑᵣ as in Step 110E-12, wherein the fifth patterned mask layer 116-5 comprises patterns to facilitate formation of upper cavity 148ᵤₚₚₑᵣ in upper planar waveguide layer 105ᵤₚₚₑᵣ.

FIG. 16M shows a cross-sectional schematic drawing of a portion of an embodiment of optical interposer structure 104 after formation of upper cavity 148ᵤₚₚₑᵣ in upper planar waveguide layer 105ᵤₚₚₑᵣ as in Step 110E-13 wherein upper cavity 148ᵤₚₚₑᵣ includes alignment pillars 134ᵤₚₚₑᵣ formed self-aligned with patterned planar waveguide cores 144ᵤₚₚₑᵣ.

FIG. 16N shows a cross-sectional schematic drawing of a portion of an embodiment of optical interposer structure 104 after formation of a sixth patterned mask layer 116-6a,116-6b on second portion 105ₚₜ₂₋ᵤₚₚₑᵣ of upper planar waveguide layer 105ᵤₚₚₑᵣ as in Step 110E-14, wherein the sixth patterned mask layer 116-6a,116-6b comprises patterns to facilitate formation of lower cavity 148_{lower} in lower planar waveguide layer 105_{lower}

FIG. 16O shows a cross-sectional schematic drawing of a portion of an embodiment of optical interposer structure 104 after formation of lower cavity 148_{lower} in lower planar waveguide layer 105_{lower} as in Step 110E-15 wherein lower cavity 148_{lower} includes alignment pillars 134_{lower} formed self-aligned with patterned planar waveguide cores 144_{lower}.

FIG. 17A shows a top-down schematic drawing of a portion of optical interposer structure 104 comprising alignment pillars 134ᵤₚₚₑᵣ in upper cavity 148ᵤₚₚₑᵣ and alignment pillars 134_{lower} in lower cavity 148_{lower} of a dual waveguide interposer structure.

FIG. 17B shows a schematic drawing of Section A-A′ of the embodiment of the dual waveguide structure of FIG. 17A that includes a cross-section of the alignment pillars 134_{lower} in lower cavity 148_{lower}.

FIG. 17C shows a schematic drawing of Section B-B′ of the embodiment of the dual waveguide structure of FIG. 17A that includes a cross-section of the alignment pillars 134ᵤₚₚₑᵣ in upper cavity 148ᵤₚₚₑᵣ.

FIG. 18A shows a top-down schematic drawing of a portion of an assembly comprising the embodiment of optical interposer structure 104 of FIG. 17A and devices 120ᵤₚₚₑᵣ and optical device 120_{lower} mounted on alignment pillars 134ᵤₚₚₑᵣ in upper cavity 148ᵤₚₚₑᵣ and alignment pillars 134_{lower} in lower cavity 148_{lower}, respectively.

FIG. 18B shows a schematic drawing of Section A-A′ of the embodiment of the dual waveguide structure of FIG. 18A that includes a cross-section of the alignment pillars 134_{lower} in lower cavity 148_{lower}.

FIG. 18C shows a schematic drawing of Section B-B′ of the embodiment of the dual waveguide structure of FIG. 18A that includes a cross-section of the alignment pillars 134ᵤₚₚₑᵣ in upper cavity 148ᵤₚₚₑᵣ.

FIG. 19 shows a flowchart for method 110F for forming embodiments of an optical interposer structure 104 having alignment aids formed self-aligned with the patterned planar waveguide cores 144 of waveguide layer 105 wherein the alignment aids include lateral alignment pillars 151 for aligning an optical fiber in one or more of a v-groove and a fiber attachment unit (FAU).

FIGS. 20A-20D show perspective schematic drawings of some steps in the formation of an embodiment of an optical interposer structure 104 having self-aligned aligned alignment features that include lateral alignment aids for aligning an optical fiber mounted in a v-groove with a patterned planar waveguide core 144 of planar waveguide layer 105.

FIG. 20A shows a schematic perspective drawing of an embodiment of optical interposer structure 104 that includes self-aligned lateral alignment aids 151 for aligning the core 156 of an optical fiber 154 to patterned planar waveguide cores 144 as in Step 110F-3 of method 110F.

FIG. 20B shows a schematic perspective drawing of an embodiment of optical interposer structure 104 that includes self-aligned lateral alignment aids 151 for aligning the core 156 of an optical fiber 154 to patterned planar waveguide cores 144 as in Step 110F-7 of method 110F.

FIG. 20C shows a schematic perspective drawing of an embodiment of optical interposer structure 104 that includes self-aligned lateral alignment aids 151 for aligning the core 156 of an optical fiber 154 to patterned planar waveguide cores 144 as in Step 110F-8 of method 110F.

FIG. 20D shows a schematic perspective drawing of an embodiment of optical interposer structure 104 that includes self-aligned lateral alignment aids 151 for aligning the core 156 of an optical fiber 154 to patterned planar waveguide cores 144 as in Step 110F-9 of method 110F with mounted optical fiber 154 in v-groove 150ᵥ.

FIG. 21 shows a schematic perspective drawing of an embodiment of optical interposer structure 104 that includes self-aligned lateral alignment aids 151 for aligning the core 156 of an optical fiber 154 mounted in an FAU 162 to a patterned planar waveguide cores 144_{SA} as in Step 110F-8 of method 110F.

FIG. 22 shows a schematic perspective drawing of an embodiment of optical interposer structure 104 that includes self-aligned lateral alignment aids 151 for aligning the core 156 of an optical fiber 154 mounted in an FAU to patterned planar waveguide cores 144_{SA} as in Step 110F-8 of method 110F shown with mounted optical fiber 154 in FAU 162.

FIG. 23 shows a schematic perspective drawing of an embodiment of optical interposer structure 104 that includes self-aligned lateral alignment aids 151 and vertical alignment pillars 134_{fau} for aligning the core 156 of an optical fiber 154 mounted in an FAU to patterned planar waveguide cores 144 as in Step 110G-8 of method 110G after removal of the third patterned mask layer 116-3.

FIG. 24 shows a flowchart for method 112A for forming assemblies comprising embodiments of optical interposer structure 104 and mounted optical device 120 wherein the mounted optical device 120 are mounted in cavity 148 of the optical interposer structure 104.

FIG. 25 shows a flowchart for method 112B for forming assemblies comprising other embodiments of optical interposer structure 104 and mounted optical device 120 wherein the mounted optical device 120 are mounted in cavity 148 of the optical interposer structure 104.

FIG. 26 shows an example of a mountable die having alignment features.

FIGS. 27A-27C show perspective schematic drawings of assembly 102 at various steps in the formation of the assembly 102 that includes an embodiment of optical interposer structure 104 and two mounted optical device 120.

FIG. 27A shows a perspective schematic drawing of an assembly 102 that includes an embodiment of optical interposer structure 104 and a first optical device 120a after placement of first optical device 120a into cavity 148 (placement is indicated by the arrow).

FIG. 27B shows a perspective schematic drawing of an assembly 102 that includes an embodiment of optical interposer structure 104, a first optical device 120a, and a second optical device 120b after placement of second optical device 120b into cavity 148 (placement is indicated by the arrow).

FIG. 27C shows a perspective schematic drawing of an assembly 102 that includes an embodiment of optical interposer structure 104, first optical device 120a, and second optical device 120b after alignment of the first and second optical device 120a,120b (alignment direction is indicated by the arrow).

FIGS. 28A-28D show cross-sectional schematic drawings of an assembly 102 at various steps in the formation of the assembly 102 that includes the placement and alignment of an optical device 120 into cavity 148 of an embodiment of optical interposer structure 104.

FIG. 28A shows a cross-sectional schematic drawing of an embodiment of an optical interposer structure 104 and an optical device 120 after alignment and prior to placement of the optical device into cavity 148, wherein the optical device 120 and the cavity 148 are shown having electrical contacts.

FIG. 28B shows a cross-sectional schematic drawing of an embodiment of an optical interposer structure 104 and an optical device 120 after placement of the optical device into cavity 148.

FIG. 28C shows a cross-sectional schematic drawing of an embodiment of an optical interposer structure 104 and an optical device 120 after heating of the solder-based electrical contacts 130a on the optical device 120 and the solder-based electrical contacts 130b in cavity 148.

FIG. 28D shows a cross-sectional schematic drawing of an embodiment of assembly 102 comprising an optical interposer structure 104 and an optical device 120 after mounting and alignment of the optical device 120 wherein the optical axis of the optical device 120 and the optical axis of the patterned planar waveguide core 144 are brought into alignment using surface tension of the molten solder in electrical contacts 130a,130b and alignment aids 134.

FIG. 28E shows a top-down schematic drawing of the embodiment of assembly 102 shown in the cross-section of FIG. 28D.

FIG. 28F shows a cross-sectional schematic drawing of an embodiment of assembly 102 comprising an optical interposer structure 104 and an optical device 120 after mounting and alignment of the optical device 120 wherein the cross-sectional view is a left-side view from the top-down view of FIG. 28E.

FIG. 29A shows a top-down schematic drawing of another assembly 102 comprising an embodiment of optical interposer structure 104 and a mounted optical device 120 wherein the alignment pillars 134_{xy} are formed to facilitate lateral alignment in both the “x” and “y” directions and wherein fiducial 114 is shown in fiducial cavity 149.

FIG. 29B shows a schematic cross-section drawing of the assembly 102 of FIG. 29A comprising an embodiment of optical interposer structure 104 and a mounted optical device 120 wherein the alignment pillars 134_{xy} are formed to facilitate lateral alignment in both the “x” and “y” directions and wherein fiducial 114 is shown in fiducial cavity 149.

FIG. 29C shows an end view cross-sectional schematic drawing for Section C-C′ of FIG. 29A.

FIGS. 30A-30F show top-down schematic drawings of assemblies comprising embodiments of optical interposer structures 104 and mounted optical device 120 wherein alignment pillars 134_{xy} formed on the optical interposer 104 are configured to facilitate lateral alignment in both “x” and “y” directions for example complementary alignment features formed on the example optical device 120.

FIG. 30A shows a top-down schematic drawings of an assembly comprising an embodiment of an optical interposer structure 104 and mounted optical device 120 wherein the alignment pillars 134_{xy} on the optical interposer structure 104 are triangular in shape and the alignment pillars 180 on the optical device 120 are receptive to the triangularly shaped alignment pillars 134_{xy} (hatched pillars 134ₓ and 134_{xy} are of the optical interposer structure 104).

FIG. 30B shows a top-down schematic drawings of an assembly comprising an embodiment of an optical interposer structure 104 and mounted optical device 120 wherein the alignment pillars 134_{xy} on the optical interposer structure 104 are trapezoidal in shape and the alignment pillars 180 on the optical device 120 are receptive to the trapezoidal shaped alignment pillars 134_{xy} (hatched pillars 134ₓ and 134_{xy} are of the optical interposer structure 104).

FIG. 30C shows a top-down schematic drawings of an assembly comprising an embodiment of an optical interposer structure 104 and mounted optical device 120 wherein the alignment pillars 134_{xy} on the optical interposer structure 104 are semicircular in shape and the alignment pillars 180 on the optical device 120 are receptive to the semicircular shaped alignment pillars 134_{xy} (hatched pillars 134ₓ and 134_{xy} are of the optical interposer structure 104).

FIG. 30D shows a top-down schematic drawings of an assembly comprising an embodiment of an optical interposer structure 104 and mounted optical device 120 wherein the alignment pillars 134_{xy} on the optical interposer structure 104 are composite trapezoidal (multiple joined trapezoids) in shape and the alignment pillars 180 on the optical device 120 are receptive to the composite trapezoidal shaped alignment pillars 134_{xy} (hatched pillars 134ₓ and 134_{xy} are of the optical interposer structure 104).

FIG. 30E shows a top-down schematic drawings of an assembly comprising an embodiment of an optical interposer structure 104 and mounted optical device 120 wherein the alignment pillars 134_{xy} on the optical interposer structure 104 comprise multiple triangularly shaped pillars and the alignment pillars 180 on the optical device 120 are receptive to the plurality of triangularly shaped alignment pillars 134_{xy} (hatched pillars 134ₓ and 134_{xy} are of the optical interposer structure 104).

FIG. 30F shows a top-down schematic drawings of an assembly comprising an embodiment of an optical interposer structure 104 and mounted optical device 120 wherein the alignment pillars 134_{xy} on the optical interposer structure 104 are shaped having a composite of a triangular and a semicircle and the alignment pillars 180 on the optical device 120 are receptive to the composite shaped alignment pillars 134_{xy} comprising a triangular shape and a semicircular shape (hatched pillars 134ₓ and 134_{xy} are of the optical interposer structure 104).

FIG. 31A-31C show perspective schematic drawings of optical device 120 having alignment pillars 180, a mounting cavity 148 of an embodiment of an optical interposer structure 104, and an assembly formed after mounting of the optical device 120 into the cavity 148.

FIG. 31A shows a perspective schematic drawing of an optical device 120 having alignment pillars 180.

FIG. 31B shows a perspective schematic drawing of a mounting cavity 148 of an embodiment of an optical interposer structure 104 having alignment pillars 134.

FIG. 31C shows perspective schematic drawings of a portion of an assembly 102 comprising an optical device 120 and a mounting cavity 148 of an embodiment of an optical interposer structure 104 (optical interposer structure 104 is shown in solid lines and optical device is shown with dotted lines).

FIG. 32A-32C show perspective schematic drawings of another optical device 120 having alignment pillars 180, a mounting cavity 148 of another embodiment of an optical interposer structure 104 having complementary alignment pillars to those of the optical device 120, and an assembly formed after mounting of the optical device 120 into the cavity 148.

FIG. 32A shows a perspective schematic drawing of an optical device 120 having alignment pillars 180 receptive to triangular shaped alignment pillars 134b in cavity 148 of the embodiment of the optical interposer structure 104 shown in FIG. 32B.

FIG. 32B shows a perspective schematic drawing of a mounting cavity 148 of an embodiment of an optical interposer structure 104 having alignment pillars 134a, 134b complementary to the alignment pillars 180 of the configuration of the optical device 120 shown in FIG. 32A.

FIG. 32C shows perspective schematic drawings of a portion of an assembly 102 comprising the optical device 120 of FIG. 32A and a mounting cavity 148 of the embodiment of an optical interposer structure 104 shown in FIG. 32B (optical interposer structure 104 is shown in solid lines and optical device is shown with dotted lines).

FIG. 33A shows a top-down schematic drawing of optical device 120 in an example placement position in cavity 148 of an embodiment of an optical interposer structure 104.

FIG. 33B shows a top-down schematic drawing of optical device 120 in an example aligned position in cavity 148 of an embodiment of an optical interposer structure 104.

FIG. 34 shows an assembly 102 comprising an embodiment of an optical interposer structure 104 and a plurality of the optical devices 120 configured as shown in FIG. 32A.

FIG. 35A shows a perspective schematic drawing of an optical device 120_{quad} configured having a plurality of devices for alignment with a plurality of patterned planar waveguide cores 144_{SA}-1 to 144_{SA}-4 that intersect cavity 148 of optical interposer structure 104.

FIG. 35B shows an assembly 102 comprising an optical device 120_{quad-a} and an embodiment of an optical interposer structure 104 having a cavity 148 configured to be receptive to a plurality of devices 120 wherein the optical device 120_{quad-a} mounted in cavity 148 comprises a plurality of devices enabling simultaneous alignment and mounting of the plurality of devices with a plurality of patterned planar waveguide cores formed on the optical interposer structure 104, and wherein the cavity 148 is configured having a group of alignment pillars for each device on the optical device 120_{quad-a}.

FIG. 35C shows an assembly 102 comprising an optical device 120_{quad-b} and an embodiment of an optical interposer structure 104 having a cavity 148 configured to be receptive to a plurality of devices 120 wherein the optical device 120_{quad-b} mounted in cavity 148 comprises a plurality of devices enabling simultaneous alignment and mounting of the plurality of devices with a plurality of patterned planar waveguides formed on the optical interposer structure 104, and wherein the cavity 148 is configured having a single group of alignment pillars 134_{SA}a, 134_{SA}b.

FIG. 36A-36D show example steps in the formation of an electrical interconnect layer 103 on an embodiment of an optical interposer structure 104.

FIG. 36A shows a portion of an embodiment of an optical interposer structure 104 comprising substrate 100, first intermetal dielectric layer 136a, and unpatterned conductive layer 132.

FIG. 36B shows a portion of an embodiment of an optical interposer structure 104 comprising substrate 100, first intermetal dielectric layer 136a, and conductive layer 132 after patterning of conductive layer 132 to form conductive electrical interconnect traces. (may be performed, for example, using lithographic patterning and etching of the conductive layer 132 or performed using dual damascene processing).

FIG. 36C shows a portion of an embodiment of an optical interposer structure 104 comprising substrate 100, first intermetal dielectric layer 136a, patterned conductive layer 132 after patterning of conductive layer 132 to form conductive electrical interconnect traces, and formation of second intermetal dielectric layer 136b.

FIG. 36D shows an embodiment of an optical interposer structure 104 comprising substrate 100, electrical interconnect layer 103, and planar waveguide layer 105.

FIG. 36E shows an embodiment of an optical interposer structure 104 comprising substrate 100, electrical interconnect layer 103, and planar waveguide layer 105 after formation and filling of vertical conductive vias to form vertical interconnections.

FIG. 37A-37L show embodiments of optical interposer structure 104 having electrical interconnect layer 103 configured with various example routings of the conductive traces.

FIG. 38A-38D show embodiments of optical interposer structure 104 configured with one or more high thermal conductivity layers.

FIG. 39A shows an example photonic integrated circuit formed using assembly 102 comprising an embodiment of optical interposer structure 104 and mounted devices 120 as may be used for example in receiver devices and transmitter devices in optical communications networks.

FIG. 39B shows a perspective schematic drawing of a wafer level formation of a plurality of optical interposer structures 104 and in the INSET shows a singulated optical interposer structure 104 having mounted devices 120a, 120b to form an embodiment of an assembly 102.

FIG. 39C shows a perspective schematic drawing of an embodiment of a singulated optical interposer structure 104 having mounted devices 120a, 120b and mounted optical fibers 152-1 to 152-4 in FAU 162 to form an embodiment of an assembly 102 wherein the assembly 102 is mounted onto a package substrate 167.

FIG. 39D shows another perspective schematic drawing of an embodiment of a plurality of assemblies 102 mounted onto a package substrate 167 and having a plurality of optical fibers mounted to each of the assemblies 102 in the embodiment.

FIG. 40A shows a top-down schematic drawing an assembly 102 comprising a mounted device 120 and an embodiment of optical interposer structure 104 that includes patterned first portion of planar waveguide layer 105ₚₜ₁ having self-aligned features wherein the self-aligned features include patterned planar waveguides 144_{SA}, front and back DBR grating structures 118_{SA}-fr, 118_{SA}-bk, alignment pillars 134_{SA}, fiducials 114_{SA}, a loopback waveguide 117_{SA}, and FAU lateral alignment pillars 151_{SA}.

FIG. 40B shows a cross-section schematic drawing of the assembly 102 shown in FIG. 40A.

FIG. 41 shows a top-down schematic drawing an assembly 102 comprising a mounted device 120 and an embodiment of optical interposer structure 104 that includes patterned first portion of planar waveguide layer 105ₚₜ₁ having self-aligned features wherein the self-aligned features include patterned planar waveguides 144_{SA}, ring oscillator 119_{SA}, alignment pillars 134_{SA}, fiducials 114_{SA}, and FAU lateral alignment pillars 151_{SA}.

FIGS. 42A-42D show perspective schematic drawings of some steps in the formation of an embodiment of an optical interposer structure 104 having self-aligned alignment features that include lateral alignment aids for aligning a ball lens mounted in a cavity, the core of an optical fiber mounted in a v-groove, and patterned planar waveguide core 144 of planar waveguide layer 105.

FIG. 42A shows a schematic perspective drawing of an embodiment of optical interposer structure 104 that includes self-aligned lateral alignment aids 151_{SA-fiber} for laterally aligning the core 156 of an optical fiber 154 and lateral alignment aids 151_{SA}-lens for laterally aligning the optical axis of a ball lens to patterned planar waveguide cores 144_{SA} after formation of patterned first mask layer 116_{SA}-1 and patterning of first portion of patterned planar waveguide layer 105ₚₜ₁.

FIG. 42B shows a schematic perspective drawing of the embodiment of optical interposer structure 104 of FIG. 42A after removal of the first patterned mask layer 116_{SA} from the patterned planar waveguide cores 144_{SA}, after formation of the second portion of planar waveguide layer 105ₚₜ₂, formation of cavities 148, 149, and formation of a first portion of cavities for mounting a ball lens and a fiber 154.

FIG. 42C shows a schematic perspective drawing of the embodiment of optical interposer structure 104 of FIG. 42B after formation of cavity 150lens and v-groove 150ᵥ for mounting a ball lens 168 and optical fiber 154 in lateral alignment with a patterned planar waveguide core 144_{SA}.

FIG. 42D shows a schematic perspective drawing of the embodiment of optical interposer structure 104 of FIG. 42C after mounting a ball lens 168 and optical fiber 154 in lateral alignment with a patterned planar waveguide core 144_{SA}.

Other aspects and features of embodiments will become apparent to those skilled in the art upon review of the following detailed description in conjunction with the accompanying figures.

### DETAILED DESCRIPTION OF EMBODIMENTS

Embodiments are disclosed herein that pertain to structures, assemblies, and methods of formation of optical interposer structures having alignment features formed from all or a portion of a planar waveguide layer in self-alignment with patterned planar waveguide cores formed from the same planar waveguide layer. In methods disclosed herein, the alignment features and the patterned planar waveguide cores are formed using a single lithographic masking level that is maintained throughout the process of formation of embodiments and these optical interposer structures may be further combined with mounted devices including optical devices and optical fibers, for example, among other devices, to form assemblies.

Alignment is achieved in embodiments, with the formation of lateral and vertical alignment pillars that are formed using a same lithographic and patterning process that is used to pattern one or more patterned planar waveguide cores of an optical interposer structure that may be used, for example, in the formation of optical assemblies and photonic integrated circuits. Upon patterning of the alignment pillars and patterned planar waveguide cores, the patterned mask layer used in the patterning is removed from the patterned planar waveguide cores, but not removed from the alignment pillars. The still-patterned alignment pillars and mask-free patterned planar waveguide cores are then buried in a dielectric layer allowing completion of the upper layers of the planar waveguide layer including an upper cladding layer.

In embodiments, a patterned mask layer formed on the planar waveguide layer, coupled with a suitable dielectric etch process, enables the formation of cavities in the planar waveguide layer within which the already patterned mask layer buried within the dielectric layer is re-exposed to enable the formation of the alignment pillars in self-alignment with the patterned planar waveguide cores. The patterned mask layer used in the formation of the cavities is positioned on the planar waveguide layer, in embodiments, such that upon formation, a wall of the cavity intersects a patterned planar waveguide core enabling the coupling of optical signals between the patterned planar waveguide core and an optical device mounted on the alignment pillars within the cavity.

Self-alignment, in general, refers to a technique used in semiconductor processing wherein a feature of a device is used as a mask to define another feature, ensuring precise alignment between the feature used as the mask and the other feature. Self-alignment, as used herein, refers to the use of a single patterned mask layer in the patterning of two or more patterned features in a lithography process that is then used in a subsequent etch or patterning process to define the collection of alignment features. A single patterned mask layer is used in embodiments, to pattern a collection of features that includes fiducials, alignment pillars, and patterned planar waveguide cores for which the lithographic registration in alignment of the collection is maintained throughout the fabrication process. Methods of maintaining the lithographic registration in subsequent patterning steps are disclosed herein in the embodiments.

In some embodiments, the alignment features formed in one or more cavities include fiducials and alignment pillars wherein the alignment pillars may be one or more of lateral alignment pillars and vertical alignment pillars formed in self-alignment with one or more patterned planar waveguide cores on an optical interposer structure. Fiducials, formed self-aligned with the alignment pillars, facilitate accurate placement of mountable devices onto the alignment pillars, for example, using automated pick-and-place apparatus. These fiducials are formed in the cavities with the alignment pillars and have the same depth of focus to facilitate high accuracy positioning and placement. Precise lateral registration between features is achieved, in embodiments, using a methodology in which a same patterned mask layer is used to pattern all features requiring alignment. The subsequent burial and re-exposure of the patterned mask layer in subsequent processing steps ensures that the precise feature registration provided by the use of the same mask layer is maintained throughout the formation of the optical interposer substrate and the alignment structures provided thereon. The precise lateral registration provided in embodiments is in contrast to methodologies that utilize multiple masking layers in multilayer structures that require re-registration at each masking layer. Multiple masking layers can lead to significant registration error in overlapped patterns that can lead to the formation of defects and to the creation of excessive variation in the relative alignment of patterns formed on successive layers. The requirement for multilevel registration is eliminated in critical patterning layers within the multilayer planar waveguide layer in embodiments of structures, assemblies, and methods disclosed herein.

In some embodiments of an optical interposer structure, alignment pillars formed in a cavity in self-alignment with patterned planar waveguide cores facilitate vertical and lateral alignment of the optical axis of an optical device placed in the cavity with the optical axis of the patterned planar waveguide cores intersecting a cavity wall. Optical devices may be, in embodiments, emitting devices, receiving devices, waveguides, and transforming devices, for example, among other devices.

Alignment features include vertical and lateral reference structures that facilitate the registration and alignment of optical structures formed from the planar waveguide layer of an interposer structure and to the alignment of optical devices and components that are mounted onto the interposer. Such alignment features provide improvements in the manufacturability of photonic integrated circuits (PICs) that use mounted optical components and that require alignment with the patterned planar waveguide cores on an optical interposer structure that includes a planar waveguide layer.

In embodiments, an optical interposer structure comprises a planar waveguide layer formed on a base structure, wherein the base structure further comprises an electrical interconnect layer formed on a substrate. The planar waveguide layer is a layer comprising one or more patterned planar waveguide cores, and one or more of a top, side, and bottom cladding layer surrounding the patterned planar waveguide cores, and may further comprise one or more other layers including one or more spacer layers, patterned mask layers, buffer layers, and planarization layers, for example, among other layers. The core layer in some embodiments, is a single waveguide layer. In other embodiments, the core layer may be a layered structure of one or more layers that together form a core layer.

In an embodiment, the planar waveguide layer is formed on the electrical interconnect layer of the optical interposer structure and patterned using a patterned mask layer to form one or more patterned planar waveguide cores, one or more fiducials, and one or more alignment pillars. Patterning of the planar waveguide layer using a patterned mask layer includes the patterning of the core layer and may further include the patterning of one or more of the bottom cladding layer, top cladding layer, and other layers as described herein.

Alignment pillars, as used herein, refer to alignment structures that pertain to, contribute to, or otherwise enable positioning or alignment of devices or features on the interposer. The alignment pillars, in embodiments, provide for or contribute to the alignment of structures or features of the interposer and the optoelectrical die that are integrated or coupled in some way with the interposers. These alignment pillars can provide for, or contribute to, the alignment of features in the vertical direction, in one or more lateral directions, or both the vertical and one or more lateral directions. Lithographic patterning of the planar waveguides, the fiducials, and the alignment pillars in embodiments of the optical interposer structure enables the precise lateral registration of these features in relation to other features on the interposer throughout the formation process of the alignment structures and the assemblies formed on the optical interposer structures using the alignment structures.

The precise lithographic registration of the alignment fiducials relative to the alignment pillars and the patterned planar waveguide cores, provides the capability for accurate placement of pre-fabricated optical die onto the interposer when using the fiducials as a placement reference.

The alignment of optical or electrical features of an optoelectrical die with optical or electrical features on an interposer is further enabled with the formation of complementary-shaped alignment structures on both the interposer and on an optical die that is mounted on the interposer. Complementary alignment structures may be formed on mountable optical devices to enable coupling of these complementary alignment structures with the lateral alignment pillars on embodiments of the optical interposer structure. In an embodiment, for example, one or more triangular-shaped alignment pillars are formed on the interposer such that one or more complementary shaped triangular cavities on a mountable optical die, that when mounted on the interposer, restrict and guide the lateral movement of the optical die as it is moved into a position of alignment as may be functionally required by a PIC.

In an embodiment of an optical interposer structure having self-aligned patterned planar waveguides and alignment features, alignment pillars are formed on the optical interposer structure in the form of triangularly-shaped pillars as viewed from a top-down perspective of the interposer. A reference height for these triangular pillars is established by the top of the patterned mask layer used to pattern these pillars concurrently with one or more patterned planar waveguide cores and one or more fiducials.

Complementary-shaped triangular cavities formed on the mountable optical die are configured to laterally guide the movement of the optical die during an alignment process and enable the alignment of optical features on the die with optical features on the optical interposer structure to form an aligned assembly comprising the mounted die and the interposer. In these embodiments, during an assembly process, an optical die having the triangular-shaped cavities receptive to the triangular pillars of the optical interposer structure is positioned to enable the alignment features of the die to be guided into an aligned position with the alignment pillars on the optical interposer structure. As the triangular features are brought into alignment in these embodiments, the optical facets or other features of the optical die are brought into lateral alignment with the optical facets of the waveguide cores on the interposer. The vertical alignment of these features is established, in embodiments, with a vertical reference surface on the optical die, such as the surface of the substrate, that is brought into contact with, for example, the top of the alignment pillars in the cavity of the optical interposer structure. In addition to the optical features that are brought into alignment in these embodiments, electrical contacts between the interposer and the mating optoelectrical die can also be brought into alignment or used to facilitate the alignment process. Intentionally misaligned solder connections at placement, as encountered for example in some embodiments, may be used to exert a force on the optoelectrical die upon the application of a heat source. The exerted force on the placed die upon heating can act to move misaligned solder connections into alignment thereby facilitating the guiding of the moving die into a preferred lateral alignment position on the interposer. Other methods of moving the mountable die into alignment on the optical interposer structure may also be used in other embodiments.

In other embodiments of assemblies formed from the interposers having self-aligned features and mounted die, non-triangular-shaped pillars may be formed on the optical interposer structure, and complementarily-shaped features may be formed on the mountable optical die to facilitate the positioning and alignment of these die on the compatible optical interposer structures. Alignment pillars may be formed that are one or more of semi-circular, trapezoidal, and hexagonal, for example, among other shapes and combinations of shapes on the interposer with complementary-shaped alignment features formed on the optical die that allow for the alignment of the optical axes of the die to be positioned in alignment with optical features on the optical interposer structure.

Various embodiments are described herein with reference to the accompanying drawings that are intended to convey the scope of the invention to those skilled in the art. Accordingly, features and components described in the examples of embodiments described herein may be combined with features and components of other embodiments. The present invention is not limited to the relative sizes and spacings illustrated in the accompanying figures. It should be understood that a “layer” as referenced herein may include a single material layer or a plurality of layers. For example, an “insulating layer” may include a single layer of a specific dielectric material such as silicon dioxide, or may include a plurality of layers such as one or more layers of silicon dioxide and one or more other layers such as silicon nitride, aluminum nitride, among others. The term “insulating layer” in this example, refers to the functional characteristic layer provided for the purpose of providing the insulation property, and is not limited as such to a single layer of a specific material. Similarly, an electrical interconnect layer, as used herein, refers to a composite layer that includes both the electrically conductive materials for transmitting electrical signals and the intermetal and other layers required to insulate the electrically conductive materials. An electrical interconnect layer, as described herein may therefore include a patterned layer of electrically conducting material such as copper or aluminum as well as the intermetal dielectric material such as silicon dioxide, and spacer layers above and below the electrically conductive materials, for example, among other layers. Additionally, references herein to a layer formed “on” a substrate or other layer may refer to the layer formed directly on the substrate or other layer or on an intervening layer or layers formed on the substrate or other layer. References to the term “optical” devices, as used herein, may refer to a purely optical device such as a waveguide that does not have an electrical feature and to an optoelectrical device that has both an optical feature and an electrical feature, unless specified otherwise. An optical device, as used herein, is a device such as a waveguide, an arrayed waveguide, a spot size converter, a lens, a grating, among others, and an optoelectrical device is a device such as a laser or a photodetector that includes an optical feature and an electrical feature. In embodiments described herein, the use of the term “optical device” may include both optical devices and optoelectrical devices particularly in the context of the alignment of optical features of optical die that pertains to devices with or without an electrical feature. The term “die”, as used herein, refers to a substrate containing one or more devices. The term “optical die”, as used herein, refers to a substrate containing one or more optical devices.

The acronym “WG”, as used herein, refers to “waveguide”. The acronym “PWG”, as used herein, refers to “planar waveguide”. The acronym “PIC”, as used herein, refers to “photonic integrated circuit”. Other acronyms may also be used as noted herein.

Embodiments of assemblies disclosed herein may be used in the formation of PICs and thus the term “PIC” may be used interchangeably with “assembly” in reference to assemblies that utilize embodiments disclosed herein.

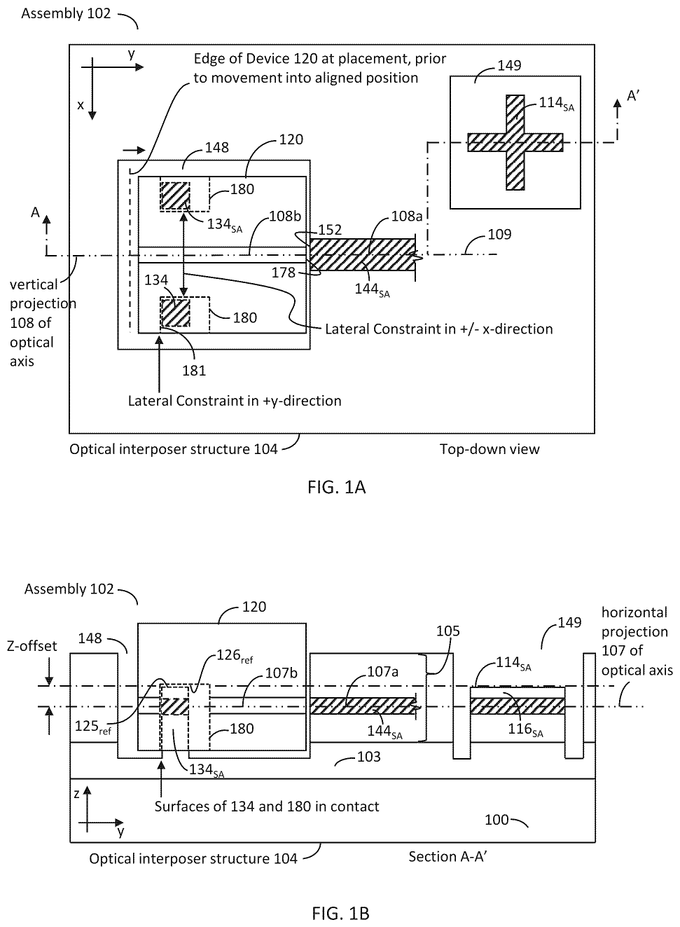

FIG. 1A shows a schematic top-down drawing of an assembly 102 having an embodiment of optical interposer structure 104 with alignment pillars 134_{SA} and fiducial 114_{SA} formed self-aligned with a patterned planar waveguide core 144_{SA}. Self-alignment, in embodiments, is achieved with the use of a single patterned mask layer 116_{SA} in the patterning of the fiducials 114, alignment pillars, and patterned planar waveguide cores for which the lithographic registration in alignment is maintained throughout the fabrication process in embodiments of optical interposer structures 104 on which these alignment features are formed as further described herein. The subscript “SA” as used herein, is used to differentiate features in embodiments that are formed having the self-aligned characteristic in comparison to features that are not self-aligned with the patterned planar waveguide cores 144.

Optical device 120 is shown mounted in cavity 148 in FIG. 1A, and further shown in the cross-sectional drawing of FIG. 1B. The cross-section of FIG. 1B is Section A-A′ of FIG. 1A. Optical device 120 may be, for example, an optical device having an optical axis 108b requiring alignment with the optical axis of 108a of the patterned planar waveguide core 144. Alignment of optical axes 108a, 108b facilitates, for example, the coupling of optical signals between optical device 120 and the patterned planar waveguide core 144 through device facet 178 of optical device 120 and facet 152 of patterned planar waveguide core 144 of optical interposer structure 104.

Alignment features 134_{SA}, shown in FIGS. 1A and 1B, are formed using a same patterned mask layer 116_{SA}, for example, as the patterned planar waveguide core 144_{SA}. Alignment of the optical axis 108b of optical device 120 mounted in cavity 148 with the optical axis 108a of a patterned planar waveguide core 144_{SA} on optical interposer structure 104 can be achieved having a high positioning resolution in configurations in which optical device 120 is mounted and aligned using alignment pillars 134_{SA} that are formed using the same patterned mask layer as is used in the formation of the patterned planar waveguides to which the mounted devices are to be aligned due to the precise alignment achieved during the lithographic patterning of the alignment pillars 134_{SA} and the patterned planar waveguide cores 144_{SA}. Lithographic resolution within a patterned structure can be on the order of tenths of a micron or less depending on the technology used. Similar alignment of fiducials 114_{SA} with alignment pillars 134_{SA} and the patterned planar waveguides 144_{SA} further ensures that the lithographic precision used in embodiments is extended to the use of pick-and-place apparatus for the accurate placement of devices such as optical device 120 onto the alignment pillars 134_{SA} formed in cavity 148 of the optical interposer structure 104 having the self-aligned features 134_{SA}.

The use of a same patterned mask layer 116_{SA} to achieve self-alignment of fiducials 114_{SA} and alignment features 134_{SA} with patterned planar waveguide cores 144 in embodiments further requires that the integrity of the alignment between the patterned features be maintained throughout the fabrication process. In embodiments, this is achieved firstly with the removal of the patterned mask layer 116_{SA} from the patterned planar waveguide cores 144, after patterning of all or a portion of the patterned planar waveguide cores 144, to enable the completion of the formation of planar waveguide layer 105, including, for example, the formation of top and side cladding layers. Secondly, with the completion of the top and side cladding layers, patterned fiducials 114_{SA} and alignment pillars 134 are buried within one or more of the top and side cladding layers with the remaining portion of the patterned mask layer used in the formation of the partially formed alignment pillars 134_{SA} to maintain the integrity of the self-aligned features. Thirdly, one or more cavities are formed using another patterned mask layer and within which the partially formed fiducials and alignment pillars 134_{SA} are re-exposed with the removal of the top and side cladding layers, and other optional layers that may be present. Each of these steps are described in detail in embodiments described herein.

The schematic top-down and cross-section drawings in FIGS. 1A and 1B show assembly 102 comprising an embodiment of interposer structure 104 and an optical device 120 mounted in cavity 148. The interposer structure 104, in the embodiment, comprises a planar waveguide layer 105 and an optional electrical interconnect layer 103 formed on a substrate 100, and further comprises alignment pillars 134_{SA} and fiducials 114_{SA} formed from all or a portion of a planar waveguide layer 105, wherein the planar waveguide layer 105 comprises a bottom cladding layer and a core layer, and optionally may include a top cladding layer, among other layers. Patterned planar waveguide core 144_{SA} is formed from all or a portion of the core layer of planar waveguide layer 105. Formation of the alignment pillars 134_{SA} and fiducials 114_{SA}, and the patterned planar waveguide core 144_{SA} from all or a portion of planar waveguide layer 105, in the embodiment, enables precise lateral alignment of the alignment pillars 134_{SA} and fiducials 114_{SA} formed from planar waveguide layer 105 with the lateral dimensions of patterned planar waveguide cores 144, including the vertical projection 108a of the optical axis, also formed from the planar waveguide layer 105. Patterned planar waveguide core 144_{SA} comprise at least a patterned portion of a waveguide core layer of the planar waveguide layer 105. In the embodiment of the optical interposer structure 104, self-aligned alignment aids shown include alignment pillars 134_{SA} formed in cavity 148 and fiducial 114_{SA} formed in cavity 149. Other alignment aids may also be formed as described herein. Optical device 120 is shown mounted on self-aligned alignment pillars 134_{SA} such that the horizontal projection 107b of the horizontal projection 107 of the optical axis of the assembly 102, and the vertical projection 108b of the vertical projection 108 of the optical axis of the assembly 102 are in alignment with the horizontal projection 107a and vertical projection 108a of patterned planar waveguide core 144_{SA}.

Placement of an optical device 120 into cavity 148 is facilitated with the use of fiducial 114_{SA}. Accurate positioning of the fiducial 114 in relation to the alignment pillars 134_{SA} formed in the cavity 148 enables accurate placement of the optical device 120, particularly with the use of automated pick-and-place apparatus commonly used in semiconductor device fabrication methods. Formation of the fiducial 114_{SA} and the alignment pillars 134_{SA} using the methods described herein in conjunction with the formation of the patterned planar waveguide cores 144_{SA}, further enables the formation of embodiments of optical interposer structures 104 that benefit from the methods of formation described herein having high relative dimensional positioning accuracy in comparison to structures formed that lack self-alignment.

Having the optical axis of a mounted optical device 120 in alignment with the optical axis of a patterned planar waveguide core 144_{SA}, for example, provides fabricational and operational benefits in assemblies such as assembly 102 used in the formation of photonic integrated circuits. In this disclosure, the alignment of the optical axis of two devices is described, firstly, in relation to the vertical alignment of the horizontal projections 107a,107b of the optical axes of two or more devices for which the alignment aids are used to facilitate alignment, and secondly, in relation to the lateral alignment of the vertical projections 108a, 108b of the two devices.

The optical axis of a device, as used herein, refers to the primary center of activity for an optical feature of an optical device. By way of example, the optical axis of a laser, may be, for example, the center of the emitting facet from which the optical signal from the laser emerges from the laser cavity. Optical signal, as used herein, may be for example, the electromagnetic radiation in the range of wavelengths from 200 nm to 2000 nm. Optical signal may also be referred to as optical output from an optical device. In another example, a photodiode, the optical axis may be the center of the receiving surface for which an optical signal is received by the photodiode. The term “optical axis”, as used herein, is intended to identify a primary intended axis of alignment between two or more devices. In some embodiments, the optical axis of an emitting device may be aligned, for example, with the center of the peak optical output from an emitting portion of the emitting device. In other embodiments, the optical axis may be aligned with another parameter of the optical signal. In some embodiments, the optical axis of a device may be, for example, a preferred axis of alignment used in the alignment of a device to another device. In some embodiments, optimal optical coupling between two devices, for example, may be used to ascertain whether or not two devices are in alignment and thus the optical axes of the two devices may be the characteristic axes of two devices that yield such optimal optical coupling. The optical axis of a device, as used in some embodiments herein, is a characteristic of a device that may be user-defined and based on one or more physical properties, operational properties, or other properties and characteristics of the device. In other embodiments, the optical axis, as used herein, is derived from one or more properties or characteristics of two or more devices in an assembly.

Horizontal projection 107 of the optical axis of the assembly 102 is shown in the section view in FIG. 1B. The horizontal projection 107b of the optical device 120 is shown in alignment with horizontal projection 107a of the optical axis of the patterned planar waveguide core 144_{SA} of the optical interposer structure 104, in the embodiment, to form aligned horizontal projection 107 of the assembly 102. The horizontal projection 107 of the assembly 102 is shown as the double dotted, dashed line in FIG. 1B and other figures herein.

Likewise, the vertical projection 108 of the optical axis of the assembly 102 is shown in the top-down view in FIG. 1A. The vertical projection 108b of the optical axis of optical device 120 is shown in alignment with the vertical projection 108a of the optical axis of the patterned planar waveguide core 144_{SA} of the interposer structure 104, in the embodiment, to form aligned vertical projection 108 of the assembly 102. As used herein and as shown in the figures throughout this disclosure, the vertical projection 108 of the assembly 102 is also shown as a double dotted, dashed line having two dots between dashes in the figures herein.

The alignment of the horizontal projection 107 and vertical projection 108 of the optical axis in embodiments of the optical interposer structure 104 used in assembly 102 benefits from the formation and accuracy of formation of the alignment features described herein.

The embodiment of the optical interposer structure 104 in the assembly 102 in FIGS. 1A and 1B, shows alignment pillars 134_{SA} used to laterally constrain the movement of the mounted optical device 120 that may be used to facilitate the alignment of the mounted optical device 120 with the patterned planar waveguide core 144_{SA} of the optical interposer structure 104 in the embodiment. In the embodiment, the horizontal projections 107a, 107b and vertical projections 108a, 108b, of the optical axes of a patterned planar waveguide core 144 and mounted optical device 120, respectively, are shown in alignment as facilitated by the alignment pillars 134_{SA} and the complementary alignment feature 180 formed on the optical device 120. In the assembly 102 shown, alignment features 180 of the optical device 120 have been brought into contact with alignment pillars 134_{SA} formed in cavity 148. Accurate placement of the optical device 120 using pick-and-place apparatus, for example, is facilitated using fiducial 114_{SA}. During assembly, the optical device 120 is firstly placed in a placement position as noted by the dotted line in cavity 148 that denotes the left edge of optical device 120 upon placement in the assembly 102, and is secondly, moved into an aligned position for which the facet 178 of the optical device 120 is brought into alignment with the facet 152 of the patterned planar waveguide core 144_{SA} of the optical interposer structure 104.

In the embodiment shown in FIGS. 1A and 1B, a surface contact is shown formed between a sidewall 181 of alignment feature 180 of mounted optical device 120 and the alignment pillar 134_{SA} of the optical interposer structure 104 that limits the lateral movement of the optical device 120 in the +y direction in the embodiment. In other embodiments, the movement in the +y direction may be limited by the wall of the cavity 148. And in yet other embodiments, the movement in the +y direction may be limited by other alignment aids as further described herein. (Reference coordinates are shown superimposed on the drawings.) Alignment of the horizontal projections 107a, 107b and vertical projections 108a, 108b of the optical axes of the patterned planar waveguide core 144 and mounted optical device 120 are also facilitated during the movement of mounted optical device 120 into the aligned position as shown in FIGS. 1A and 1B. The resolution of the alignment of the optical axis in the +/−x directions may be limited in the configuration shown, to the resolution of the allowable placement tolerance for the dimension of the “Lateral Constraint in +/−x-direction” shown in FIG. 1A in comparison to that of the spacing between the alignment pillars 134_{SA} of the optical interposer structure 104. This potentially limited resolution is reduced in other embodiments described herein.

Patterning of the self-aligned fiducial 114_{SA} is formed in the same horizontal plane as the alignment pillars 134_{SA} and the patterned planar waveguide cores 144_{SA} of the optical interposer structure 104. Self-aligned features are highlighted by the hatched areas in FIGS. 1A and 1B. Fiducial 114_{SA} provides a lateral reference position in the x and y directions, as indicated by the reference coordinate systems superimposed on the drawings that facilitates placement of the optical device 120 over alignment features 134_{SA} in the cavity 148. Accuracy of placement is enhanced with the accuracy of the positioning of the fiducial 114_{SA} with respect to the alignment aids 134_{SA}.

The formation of self-aligned fiducial 114_{SA} in cavity 149, as shown, or in a same cavity 148 as alignment pillars 134_{SA} in other embodiments, enables formation of the fiducial at the same horizontal plane as the alignment pillars 134_{SA} of the optical interposer structure 104 and thus further enables improved visibility and optical resolution of the fiducial 114_{SA} for lateral positioning apparatus used in the placement of the devices 120 into cavity 148. Having two or more features at a same focal distance can provides the highest resolution for sensing apparatus that utilizes the same optical inspection system to detect fiducial 114_{SA} and alignment pillar 134_{SA} wherein the fiducial provides the wafer level resolution of the lateral position of the fiducial 114_{SA}, and the alignment feature 134_{SA} provides the destination for the placement of the optical device 120. Having a high dimensional precision in the relative lateral positioning of the fiducial 114_{SA} and the alignment pillars 134_{SA} upon which optical device 120 is placed facilitates higher placement accuracy in comparison to configurations that lack lateral positional resolution. Coupled with the formation of the alignment pillars 134_{SA} and the fiducial 114_{SA} at the same elevation in the one or more cavities 148,149, the improved lateral resolution is achievable with the capability to achieve optical focus on the exposed fiducial that may not be achievable in structures for which fiducials are not formed on a same focal plane. Fiducials 114_{SA} formed at or near a same horizontal plane as the features within which mountable devices are placed enable a higher degree of positioning accuracy than fiducials formed at other focal planes above or below the focal plane used in placement apparatus.

In embodiments described herein, the reference position established by any portion of the fiducial 114_{SA} typically, although not necessarily, is laterally offset in one or both the x and y directions relative to the position of the vertical projection 108a of the optical axis of patterned planar waveguide core 144_{SA} (or other device) of the optical interposer structure 104. The lateral reference position provided by the fiducial 114_{SA}, in embodiments, provides a means for accurately placing the optical device 120 into cavity 148 of the interposer structure 104. Current placement accuracies of commercial pick-and-place apparatus used in the placement of mountable devices onto interposers or other substrates is on the order of 3-10 micrometers. Thus, to avoid a collision between the optical device 120 and an alignment pillar 134_{SA} or other feature on the interposer structure 104, a spacing of between 3-10 micrometers is typically allowed during placement. After placement, the optical device 120 must then be moved into an aligned position such as the aligned position shown in the embodiment in FIGS. 1A and 1B.

In addition to the lateral positioning and alignment facilitated by fiducial 114_{SA} and alignment pillars 134_{SA}, alignment features formed on the optical interposer structure 104 also facilitate alignment of the horizontal projection 107b of the optical axes of optical device 120 with that of the horizontal projection 107a of the optical axis of a patterned planar waveguide core 144_{SA} of the optical interposer 104 in the embodiment shown in FIGS. 1A and 1B. As shown in FIG. 1B, a surface-to-surface contact is formed between the top surface 125_{ref} of the alignment pillar 134 and a bottom surface 126_{ref} on the optical device 120 upon placement of the optical device 120 into the cavity 148 to establish the height of the optical axis of the optical device 120 in relation to the optical axis of the patterned planar waveguide core 144_{SA} of the optical interposer structure 104. In some embodiments, the reference height established by the top surface of the alignment pillar 134 has a vertical offset (shown as “z-offset” in Section A-A′ of FIG. 1B) from the horizontal projections 107a, 107b of the optical axes of the patterned planar waveguide core 144_{SA} of the optical interposer structure 104 and the optical device 120, respectively, as shown for the embodiment in FIG. 1B. In the embodiment shown in FIG. 1B, the z-offset is a distance between the top of the alignment pillar 134_{SA} and the horizontal projection of the optical axis 107a. In an embodiment, this distance may be obtained, for example, by adding the thickness of a mask layer used to pattern the alignment pillar 134_{SA} and half the thickness of the patterned layer (hatched layer shown). Other z-offsets may be used in other embodiments.

Similar z-offsets are provided for the alignment pillars 134_{SA} and in the optical device 120 to offset the reference surface 126_{ref} from the horizontal projection 107b of the optical axis to enable the alignment with the horizontal projection 107a of the patterned planar waveguide core 144_{SA} of the optical interposer structure 104 in the embodiment. In other embodiments, the top surface of the alignment pillar 134_{SA} is aligned with the horizontal projections 107a of the optical axis of the patterned planar waveguide core 144_{SA} of the interposer structure 104 although these embodiments are not shown in FIGS. 1A and 1B.

Alignment pillar 134_{SA}, in some embodiments may form all or a portion of a lateral constraint that limits the movement of the optical device 120 in the lateral y-direction as indicated by the reference coordinates shown in FIG. 1A. An optical device 120 may be placed in the cavity 148 of an embodiment of an interposer structure 104, for example, and the placement of optical device 120 is such that it does not make contact with the sidewalls of the cavity 148 within which the optical device 120 is placed. To prevent contact with the sidewalls of the cavity 148 during placement, optical device 120 is placed with adequate clearance between the sidewalls of the cavity 148 and then moved into position after placement. The alignment aids 180 of optical device 120 limit the movement of the optical device 120 in at least one of the lateral directions, namely the x and y directions. In the embodiment shown in FIGS. 1A and 1B, the alignment aids 180, as shown, limit the movement in both the x and y directions. Movement of the optical device 120 in the positive and negative x-directions (as indicated with the reference coordinate system) is limited by the fixed position of the alignment pillars 134_{SA} of the interposer structure 104 and the walls of the alignment feature 180 that are formed on the underside of the optical device 120. The range of possible movement of the optical device 120 in the +/−x-directions is limited to the distance between the alignment pillars 134_{SA} of the interposer structure 104 and the alignment feature 180 of the optical device 120 at placement. Adequate clearance must be provided between the spacing of the alignment pillars 134_{SA} and the spacing between the alignment features 180 of optical device 120. Movement of the optical device 120 is further limited in the y direction by the fixed position of the alignment pillar 134_{SA} of the interposer structure 104 as the wall surface 181 of the alignment feature 180 of the optical device 120 contacts the sidewall of the alignment pillar 134 of the interposer structure 104 as optical device 120 is moved into the aligned position in the +y-direction shown in FIGS. 1A and 1B. Movement in the x-direction for the embodiment, in summary, is constrained motion in that the optical device 120 is free to move in the +/−x directions within the spacing of the alignment pillars 134. Movement in the y-direction, in summary, is not initially constrained in that the alignment feature 180 of optical device 120 is free to move in either direction (within a small range) at placement but is constrained as the alignment feature 180 of the optical device 120 is brought into contact with the sidewall of one or more alignment pillar 134. Other embodiments and features of embodiments of lateral alignment aids are further described herein.

The alignment features shown in FIGS. 1A and 1B may be used to limit the motion of a mounted device such as mounted optical device 120 over alignment aids 134_{SA}. In other embodiments, alignment pillars 134 may be configured to restrict the lateral movement of other configurations of devices 120 mounted on interposer structures 104 and used in the formation of assemblies 102. Complementary alignment aids on mountable devices may be combined with alignment pillars on other embodiments of interposer structures 104 to restrict movement laterally and vertically. In some embodiments, for example, lateral movement of an optical device 120 may be limited by contact between a vertical surface of a mounted optical device 120 and all or a portion of a vertical surface on a sidewall of cavity 148.

Further described herein are methods of formation of embodiments of optical interposer structures wherein the methods describe the formation of self-aligned patterned planar waveguides 144_{SA} and alignment features that include one or more of a fiducial 114_{SA} and one or more alignment pillar 134_{SA}. In the methods of formation of embodiments of the optical interposer structure described herein, the resolution and accuracy of the spacing between the self-aligned fiducials 114_{SA}, the self-aligned alignment pillars 134_{SA}, and the self-aligned patterned planar waveguide cores 144_{SA} is enhanced by the formation of these alignment features in the same horizontal plane using a same patterned first mask layer 116_{SA}.

The embodiment of assembly 102 shown in FIGS. 1A and 1B, comprises the embodiment of the optical interposer structure 104 and the optical device 120 wherein the embodiment of the optical interposer structure 104 has self-aligned alignment features that include fiducial 114_{SA}, alignment pillars 134_{SA} formed in cavity 148, and patterned planar waveguide core 144_{SA} buried in a dielectric layer that includes one or more of a bottom cladding layer, a top cladding layer and optionally one or more of a spacer layer, buffer layer, and a planarization layer, among other optional layers. Other embodiments may include other optical devices 120 mounted or otherwise coupled to the optical interposer structure 104 and may include additional optical and optoelectrical devices, electrical devices, and other circuit elements. And yet other embodiments may include other optical devices 120 mounted or otherwise coupled to the optical interposer structure 104, may include one or more of additional optical and optoelectrical devices, electrical devices, other circuit elements, and one or more optical fibers coupled to the interposer structure as further described herein.

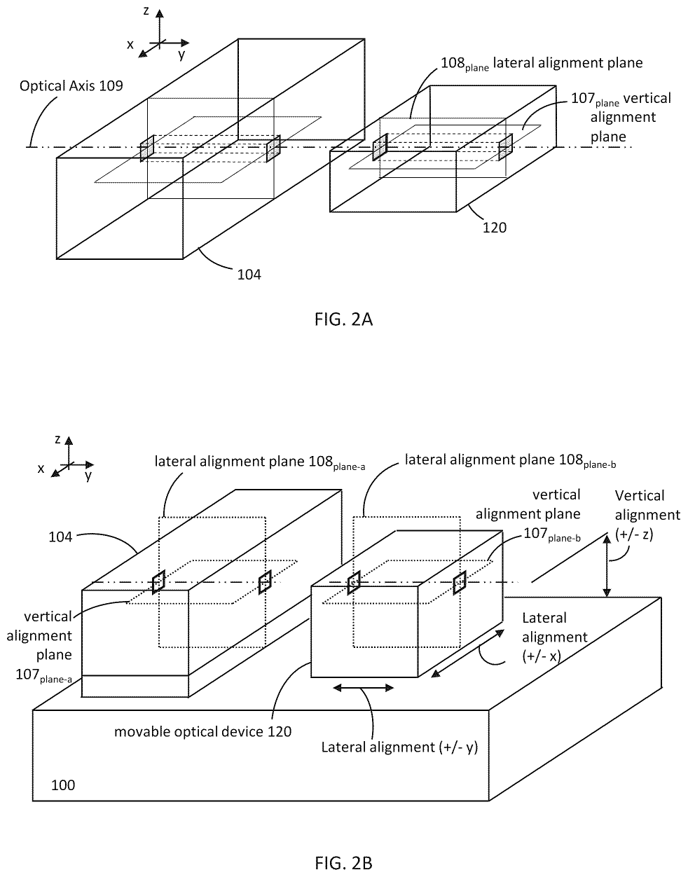

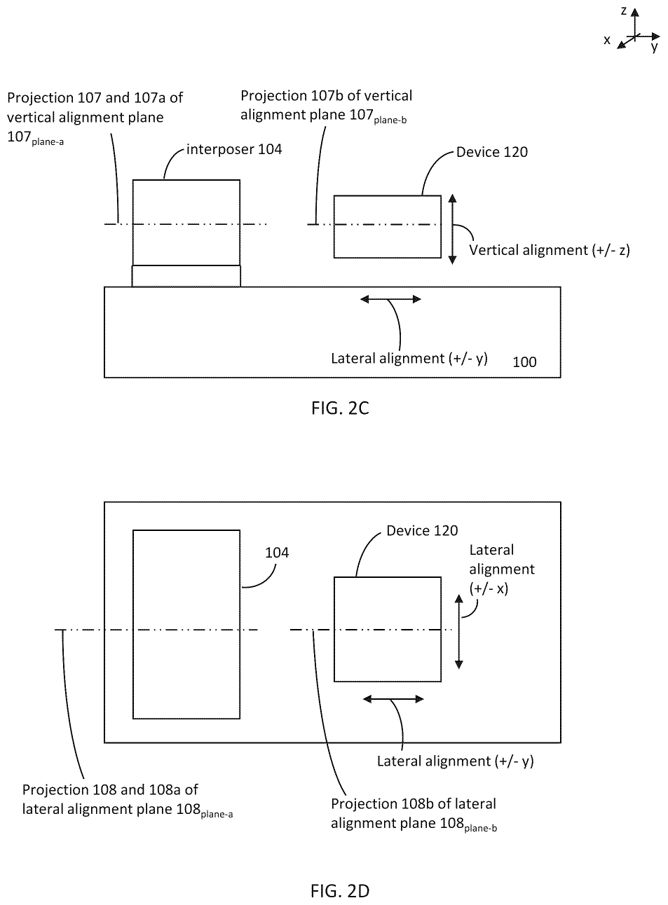

FIGS. 2A and 2B show schematic perspective drawings that further illustrate aspects of the alignment of the optical axes of two optical devices.

FIG. 2A shows a schematic perspective drawing of two optical devices having a common aligned optical axis 109. FIGS. 2A and 2B are provided to illustrate the concept of the optical axis used in the description of embodiments herein. The common optical axis 109 is the optical axis to which the two devices having optical axes 109a, 109b, respectively, are aligned to enable functional operation of an assembly comprising the two devices. In embodiments described herein, a first device may be a patterned planar waveguide core 144, for example, of optical interposer structure 104 and a second device may be an optical device 120, mounted on the optical interposer structure 104.

Common optical axis 109, for the assembly 102, comprises a horizontal projection 107 of a horizontal plane 107ₚₗₐₙₑ through the common optical axis 109 and a vertical projection 108 of a vertical plane 108ₚₗₐₙₑ through the common optical axis 109. The common optical axis 109 of the assembly 102, as described herein, further comprises (1) an optical axis 109a for a patterned planar waveguide core 144 formed on the optical interposer device 104 having a horizontal projection 107a and a vertical projection 108a, and (2) an optical axis 109b for optical device 120 having a horizontal projection 107b and a vertical projection 108b.

The horizontal and vertical alignment planes are conceptual orthogonal reference planes that intersect the optical axes of optical devices mounted or otherwise formed on embodiments of the optical interposer structure 104. Referencing the orthogonal coordinate system shown in FIG. 2A, a vertical alignment plane 107 plane, as described herein, is a geometrical plane parallel to a reference x-y plane. The vertical position of the vertical alignment plane, and hence the vertical position of the optical axis 109 of the assembly 102, is determined by the location of the common x-y plane along the z-axis in the reference coordinate system shown. The location of the reference x-y plane, may be, for example, the top surface of a substrate, the top of a layer formed on the substrate, the bottom of a layer formed on a substrate, among other. And the location of a common x-y plane that includes the optical axis of the assembly, may be, for example, at a height or elevation above the reference x-y plane.

Again referencing the orthogonal coordinate system shown in FIG. 2A, a lateral alignment plane 108ₚₗₐₙₑ, as described herein, is a geometrical plane parallel to a reference y-z plane. The lateral position of a lateral alignment plane, and hence the horizontal or lateral position of the optical axis 109 of the assembly, is determined by the location of the common y-z plane along the x-axis in the reference coordinate system shown.

Alignment of the optical axes of two devices, in the illustrative example shown in FIG. 2A, requires the alignment of both the horizontal and the vertical alignment planes for optimal alignment of the optical axes of two devices. To align the heights of the optical axes of two devices, for example, the vertical alignment planes for each device as shown must be brought into alignment. And to align the lateral positions, the lateral alignment planes for each device as shown must be brought into alignment. In embodiments described herein, optical device 120 is a mountable device mounted or otherwise formed on an optical interposer structure 104 having patterned planar waveguide cores 144 to which the optical axis 109b of the mounted device 120 is aligned.

With respect to the alignment of the vertical alignment planes, the cross-sectional drawing of the embodiment in FIG. 1B, for example, shows the projections of the vertical alignment planes to be in alignment to provide a common horizontal projection 107 of the optical axis 109 of the assembly 102 comprising the mounted optical device 120 and the optical interposer structure 104 having the patterned planar waveguide core 144. Similarly, the top-down drawing of the embodiment in FIG. 1A, for example, shows the projections of the lateral alignment planes 108a, 108b to be in alignment to provide a common vertical projection 108 of the optical axis 109 of the assembly 102. The aligned projections coincide with the optical axis 109 of the assembly 102, as shown in FIGS. 1A and 1B.

The planes parallel to the reference x-y planes (shown in the superimposed coordinate system) are referenced herein as vertical alignment planes. FIG. 2A shows the vertical alignment planes 107ₚₗₐₙₑ₋ₐ, 107_{plane-b} of two optical devices to be in alignment along the z-axis. Two optical devices are said to be in alignment, as referenced herein, when the vertical alignment planes 107ₚₗₐₙₑ₋ₐ, 107_{plane-b} for the two devices are in alignment at a same elevation.

The planes parallel to the reference y-z planes (shown in the superimposed coordinate system) are referenced herein as lateral alignment planes. FIG. 2A shows the lateral alignment planes 108ₚₗₐₙₑ₋ₐ, 108_{plane-b} of two optical devices to be in alignment along the x-axis. Two optical devices are said to be in alignment, as referenced herein, when the lateral alignment planes 108ₚₗₐₙₑ₋ₐ, 108_{plane-b} for the two devices are in alignment.

Devices 104, 120, as shown, are optical devices that include an optical element to or from which an optical signal can be emitted by, received by, or propagated through and include emissive devices such as lasers and LEDs, receiving devices such as photodetectors, and passive devices such as waveguides, among many others. Optical device 120 may be one or more device, for example, used in the formation of a photonic integrated circuit (PIC) and may be optical devices such as a waveguide, an arrayed waveguide, a grating, among others, or may be an optoelectrical device such as a laser or photodiode, among other devices, that have both an optical and an electrical feature.

In embodiments of optical interposer structure 104, the optical axis may be the optical axis of all or a portion of a waveguide such as, for example, a patterned planar waveguide core 144 that forms the primary path of propagation for a waveguide comprising the patterned planar waveguide core 144 and the cladding layers that surround the patterned planar waveguide core 144. Defining a patterned planar waveguide core 144 as an optical device, in embodiments disclosed herein, provides a more definitive structure than a waveguide that includes the cladding layers since the surrounding cladding layers can vary considerably in thickness and orientation. Herein, in embodiments, therefore, patterned planar waveguide cores 144 are described as “devices” having an optical axis although the functionality of the patterned planar waveguide cores is understood to require suitable cladding to function as a waveguide device.

In PICs, devices 104, 120 benefit from accurate placement and alignment of the optical features in applications in which efficient optical signal transfer provides improved operation of the PICs that are fabricated from these devices. The effectiveness of an alignment method on the alignment of the optical devices can be measured, for example, by the loss in one or more of signal power and signal intensity as an optical signal is transferred or is otherwise propagated from one to another device in the PIC. And although the effectiveness of the alignment of optical devices is ultimately measured by the efficiency in the power or quality of signal transfer between optical devices, the use of a power measurement during fabrication of the PICs can require an active alignment method in which the power or optical signal strength is measured during the alignment process to ascertain the optimal positions for peak signal transfer. More preferably, passive techniques and the associated structures used in these methods are used to allow for effective alignment of the optical devices in a PIC without the need for acquiring active measurements and feedback in the alignment process. Embodiments described herein enable passive alignment techniques.

An optical device, as referenced herein, is a device that has an optical feature that sends, receives, reflects, transmits, focuses, alters, amplifies, or somehow influences the formation, transmission, propagation, detection, or transfer, or any property of an optical signal. An optoelectrical device, as referenced herein, is a form of optical device with an electrical feature. The electrical feature can be integral to the optoelectrical device or can be a portion of an optoelectrical device that is coupled to one or more other optoelectrical devices to send, receive, reflect, transmit, focus, alter, amplify, or somehow influences the formation, transmission, propagation, detection, or transfer, or any property of an optical signal. Optoelectrical devices such as lasers are used, for example, to form an optical signal from an electrical signal applied to the lasing device. Photodetectors, are used, for example, to convert an optical signal to an electrical signal. These and many other forms of optical and optoelectrical devices can be used in the formation of photonic integrated circuits that benefit from structures and methods that ensure the devices are properly aligned as required by the design and functionality of the circuit. The term “optical devices” as used herein, is intended to include optoelectrical devices, as the alignment techniques described herein pertain to the optical axes and features of either optical or optoelectrical devices.

Referring to FIG. 2B, optical devices 104, 120 are shown positioned on substrate 100. FIG. 2B shows a movable optical device 120 having vertical alignment plane 107_{plane-b} positioned on optical interposer structure 104 and in alignment with vertical alignment plane 107ₚₗₐₙₑ₋ₐ. The alignment of the vertical alignment planes is hereinafter referred to as alignment in the “z” direction as indicated by the reference coordinate frames in FIG. 2B. Alignment of the optical axes in the “z” direction can be in the “+z” or “−z” direction and can be influenced, for example, by the vertical position of the optical devices on the substrate or a feature on the substrate upon which the device 120 is mounted, and by the position of the optical signal axis within the optical devices. Disclosed herein in embodiments are structures and methods for aligning the vertical alignment planes 107ₚₗₐₙₑ₋ₐ, 107_{plane-b} of two or more devices 104, 120.

FIG. 2B shows a moveable optical device 120 also having lateral alignment plane 108_{plane-b} in alignment with lateral alignment plane 108ₚₗₐₙₑ₋ₐ of optical interposer device 104. In general, the alignment of the lateral alignment planes such as lateral alignment planes 108ₚₗₐₙₑ₋ₐ, 108_{plane-b} can be made in reference to any lateral plane, but for the purposes of discussion herein, specific reference planes are identified to facilitate illustration of the features of embodiments. Accordingly, the alignment of the lateral alignment planes 108ₚₗₐₙₑ₋ₐ, 108ₚₗₐₙₑ-b in a lateral or horizontal direction of movement as shown in FIG. 2B is hereinafter referred to as alignment in the “x” direction as indicated by the reference coordinate frames in FIG. 2B. Alignment in the “x” direction can be in the “+x” or “−x” direction and can be influenced, for example, by the horizontal placement and positioning of the optical devices on the substrate 100 or a feature on the substrate upon which the device 120 is mounted, and by the position of the optical signal axis within the optical devices. Disclosed herein are structures and methods for aligning the lateral alignment planes 108ₚₗₐₙₑ₋ₐ, 108_{plane-b} of two or more devices 104, 120.

Lateral alignment of the two devices 104,120 in FIG. 2B may be further influenced with respect to the lateral positioning of characteristic x-z planes of the two devices. Although the optical axis may be in alignment for the two devices as shown, the optical signal transfer, for example, for the two devices may further be affected by the distance between the two devices. Optical signal dispersion, for example, can vary with distance from an output facet of an optical device. This dispersion, may be reduced or minimized in some embodiments, with the minimization of the spacing between the facets of two coupled optical devices. In other embodiments, such as a lens, for example, an optimal spacing may exist that is linked to a characteristic focal length of a device.

Alignment of the optical structures in the Disclosed herein are structures and methods for providing spacing between devices mounted and otherwise formed on the optical interposer structure 104. The alignment of the lateral x-z planes is hereinafter referred to as alignment in the “y” direction as indicated by the reference coordinate frames in FIG. 2B. Alignment of the optical devices in the “y” direction may be in the “+y” or “−y” direction and can be influenced, for example, by the lateral position of the optical devices on the substrate or a feature on the substrate upon which the device 120 is mounted. Disclosed herein in embodiments are structures and methods for aligning and spacing of optical devices and spacing between features on the optical devices of two or more devices 104, 120.

Key points from FIGS. 2A and 2B are further illustrated in FIGS. 2C and 2D.

FIG. 2C shows a side view taken in a y-z plane of the perspective drawing of FIG. 2B. The side view of FIG. 2C shows the projections 107a,107b of the vertical alignment planes 107ₚₗₐₙₑ₋ₐ, 107_{plane-b} that include the optical axes of the patterned planar waveguide core 144 of the optical interposer structure 104 and the optical device 120, respectively. The projection 107 of the optical axis of the assembly 102 and the projection 107a of the optical axis of the patterned planar waveguide core 144 are the same in the embodiment shown having a single axis and as a result of the patterned planar waveguide core 144 being fixed in place on the optical interposer structure 104. The projection 107b of the vertical alignment plane 107_{plane-b} of the mounted device 120 is also shown. Vertical alignment, in the embodiment, may result from vertical positioning of the optical device 120 and the corresponding vertical positioning of the projection 107b of the vertical alignment plane 107_{plane-b}.

FIG. 2D shows a top view taken in an x-y plane of the perspective drawing of FIG. 2B. The top view of FIG. 2D shows the projections 108a, 108b of the lateral alignment planes 108ₚₗₐₙₑ₋ₐ, 108_{plane-b} that include the optical axes of the patterned planar waveguide core 144 of the optical interposer structure 104 and the optical device 120, respectively. The projection 108 of the optical axis of the assembly 102 and the projection 108a of the optical axis of the patterned planar waveguide core 144 are the same in the embodiment shown having a single axis and as a result of the patterned planar waveguide core 144 being fixed in place on the optical interposer structure 104. The projection 108b of the lateral alignment plane 108_{plane-b} of the mounted device 120 is also shown. Lateral alignment, in the embodiment, may result from lateral positioning of the optical device 120 and the corresponding lateral positioning of the projection 108b of the lateral alignment plane 108_{plane-b}. Further lateral alignment may result from the lateral positioning in the +y and −y directions.

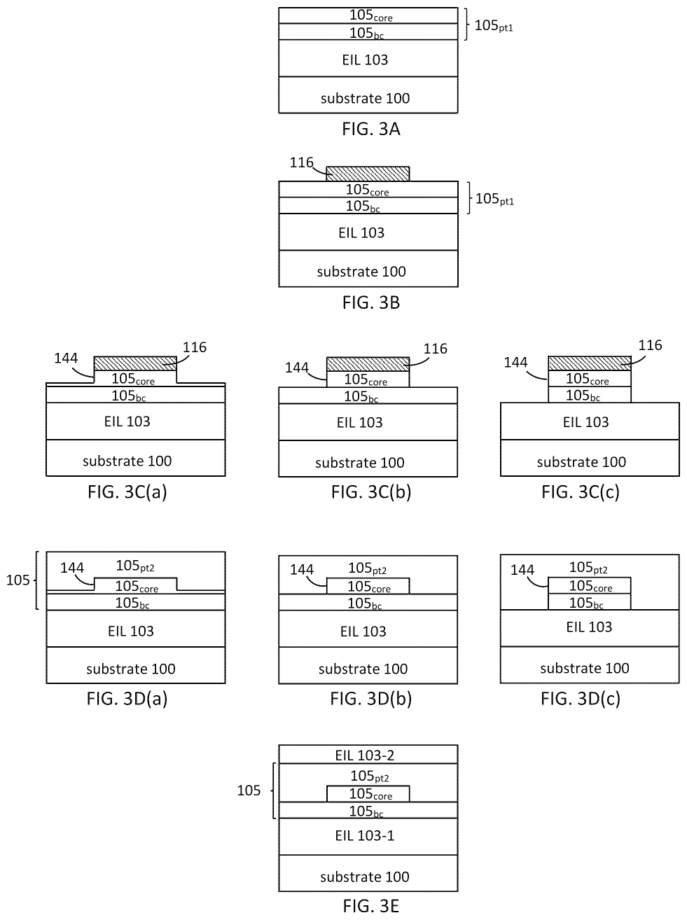

FIGS. 3A to 3E show a sequence of cross-sectional drawings that illustrate the formation of a planar waveguide layer on an interposer base structure in some embodiments.

Typically, a planar waveguide layer in its simplest form comprises a waveguide core through which an optical signal propagates and the cladding material that surrounds the waveguide core that acts to confine the optical signal propagating within the core. The cladding material has a refractive index lower than that of the core material. In the context of optical planar waveguides, the difference in the indices of refraction between the core and the cladding causes total internal reflection to occur at the core-cladding boundary along the length of a waveguide to facilitate propagation and confinement of optical signals within the core.

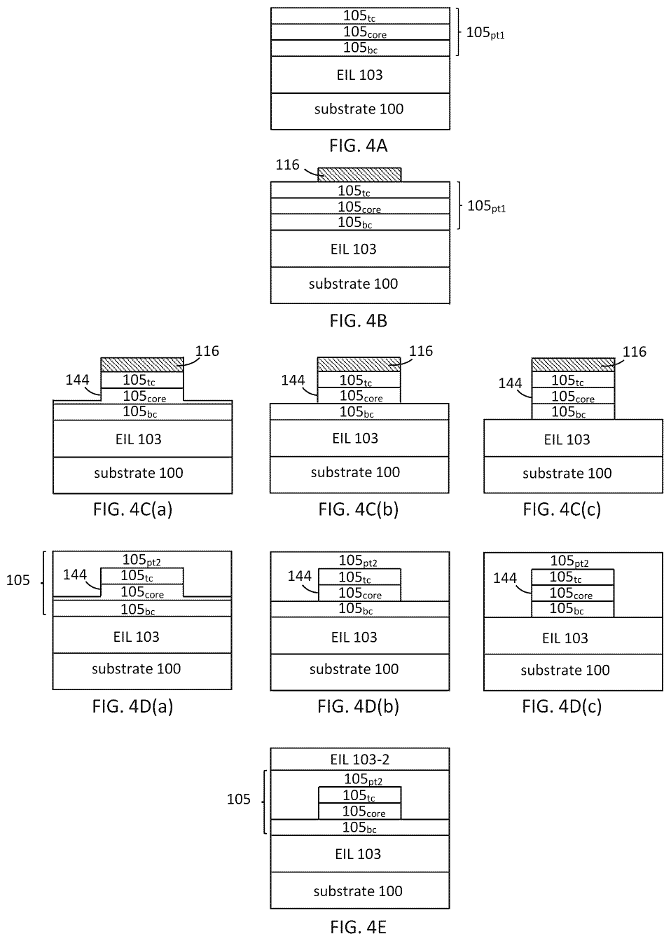

Methods of formation of planar waveguide layer 105 as shown for example, in the cross-sectional drawing of FIG. 1B, are described in FIGS. 3A-3E and FIGS. 4A-4E that show a sequence of steps in the formation of planar waveguide structures 105 that include patterned planar waveguide cores 144.

FIG. 3A shows a schematic cross-sectional drawing of a portion of an embodiment of optical interposer structure 104 having a first portion 105ₚₜ₁ of planar waveguide layer 105 formed on an interposer base structure 101. Interposer base structure 101 comprises electrical interconnect layer 103 formed on interposer substrate 100. First portion 105ₚₜ₁ of planar waveguide layer 105, for the embodiment shown in FIG. 3A, comprises core layer 105_{core} and a bottom cladding layer 105_{bc}. Bottom cladding layer 105_{bc} includes a layer having a lower index of refraction than the core layer 105_{core} and may optionally include one or more of a spacer layer, a buffer layer, among other layers. Core layer 105_{core} may be formed, in an embodiment, from a dielectric layer such as silicon oxynitride. In another embodiment, core layer 105_{core} may be formed from a dielectric layer such as silicon nitride. In yet another embodiment, core layer 105_{core} may be formed from a semiconductor material such as silicon. And in yet other embodiments, core layer 105_{core} may be formed from a polymer layer. Bottom cladding layer 105_{bc} may be formed, in some embodiments, from one or more layers of silicon dioxide, silicon oxynitride, and silicon nitride, among other layers. In some embodiments, a polymer may be used to form the bottom cladding layer 105_{bc}.

FIG. 3B shows a schematic cross-sectional drawing of a portion of an embodiment of optical interposer structure 104 having a patterned mask layer 116 formed on the first portion 105ₚₜ₁ of planar waveguide layer 105. In some embodiments, patterned mask layer 116 may be formed from an aluminum or aluminum containing alloy, for example. In other embodiments, other materials may be used to form patterned hard mask layer 116.

FIGS. 3C(a) to 3C(c) show embodiments of the planar waveguide layer 105 having differing patterning depths of the core layer 105_{core}.

FIG. 3C(a) shows a schematic cross-sectional drawing of a portion of an embodiment of optical interposer structure 104 having a patterned mask layer 116 on the first portion 105ₚₜ₁ of planar waveguide layer 105 formed on an interposer base structure 101 after patterning of a portion of the thickness of the core layer 105_{core} to form a rib waveguide. A rib waveguide is formed from a core layer that is not fully patterned and for which a portion of the core layer 105_{core} remains after patterning.

FIG. 3C(b) shows a schematic cross-sectional drawing of a portion of another embodiment of an optical interposer structure 104 having a patterned mask layer 116 on the first portion 105ₚₜ₁ of planar waveguide layer 105 after patterning of the full thickness of the core layer 105_{core}.

FIG. 3C(c) shows a schematic cross-sectional drawing of a portion of yet another embodiment of optical interposer structure 104 having a patterned mask layer 116 on first portion 105ₚₜ₁ of planar waveguide layer 105 after patterning of the full thickness of the core layer 105_{core} and the full thickness of the bottom cladding layer to form first portion 105ₚₜ₁ of patterned planar waveguide layer 105.

FIGS. 3D(a) to 3D(c) show schematic cross-sectional drawings of the portions of the embodiment of an optical interposer structure 104 of FIGS. 3C(a) to 3C (c), respectively, after removal of the patterned mask layer 116 and formation of second portions 105ₚₜ₂ of planar waveguide layer 105 on first portions 105ₚₜ₁. Second portion 105ₚₜ₂ of planar waveguide layer 105, in the embodiments shown, encapsulates the patterned core layers 105_{core} to provide a top and side cladding layer, and optionally one or more of a spacer layer, a buffer layer, a planarization layer, among other layers.

FIG. 3E shows a schematic cross-sectional drawing of the portion of the embodiment of an optical interposer structure 104 of FIG. 3D (b) after formation of an electrical interconnect layer 103-2 on the second portion 105ₚₜ₂ of the planar waveguide layer 105 for an embodiment having an electrical interconnect layer 103-2 formed on the planar waveguide layer 105 in addition to an underlying electrical interconnect layer 103-1 formed as shown between the substrate 100 and the planar waveguide layer 105.

The formation of the planar waveguide structures 105 in the embodiments shown in FIGS. 3A-3E illustrate the formation of patterned planar waveguide cores 144 from the core layer 105_{core} and the subsequent encapsulation of the patterned planar waveguide cores 144 with the second portions 105ₚₜ₂ of planar waveguide layer 105 to form the waveguide structures used in embodiments. In the following section, additional embodiments are shown in which all or a portion of a top cladding layer is provided in the first portion 105ₚₜ₁ of planar waveguide 105.

FIGS. 4A to 4E show a sequence of cross-sectional drawings that illustrate the formation of a planar waveguide layer on an interposer base structure in some embodiments.

FIG. 4A shows a schematic cross-sectional drawing of a portion of an embodiment of optical interposer structure 104 having a first portion of a planar waveguide layer 105ₚₜ₁ formed on an interposer base structure 101. Interposer base structure 101 comprises electrical interconnect layer 103 formed on interposer substrate 100. First portion 105ₚₜ₁ of planar waveguide layer 105, for the embodiment shown in FIG. 4A, comprises core layer 105_{core}, bottom cladding layer 105_{bc}, and all or a portion of a top cladding layer 105_{tc}. In some embodiments, such as is shown in FIG. 4A, inclusion of all or a portion of a top cladding layer 105_{tc} in the first portion 105ₚₜ₁ of planar waveguide layer 105 may be beneficial to one or more of the functionality and the method of formation of the planar waveguide layer 105. Bottom cladding layer 105_{bc} and core layer 105_{core} are as described for the embodiments of FIGS. 3A-3E. The top cladding layer shown in FIGS. 4A-4E includes all or a portion of a layer having a lower index of refraction than the core layer 105_{core} and may optionally include one or more of a spacer layer, a buffer layer, among other layers. Top cladding layer 105_{tc} may be formed, in some embodiments, from one or more layers of silicon dioxide, silicon oxynitride, and silicon nitride, among other layers. In some embodiments, a polymer may be used to form the top cladding layer 105_{tc}.

FIG. 4B shows a schematic cross-sectional drawing of a portion of an embodiment of an optical interposer structure 104 having patterned mask layer 116 on the first portion 105ₚₜ₁ of planar waveguide layer 105 formed on an interposer base structure 101 wherein the first portion 105ₚₜ₁ includes top cladding layer 105_{tc}.

FIG. 4C (a) shows a schematic cross-sectional drawing of a portion of an embodiment of an optical interposer structure 104 having a patterned mask layer 116 on the first portion 105ₚₜ₁ of planar waveguide layer 105 after patterning of the top cladding layer 105_{tc} and a portion of the core layer 105_{core} to form a rib waveguide.

FIG. 4C (b) shows a schematic cross-sectional drawing of a portion of another embodiment of an optical interposer structure 104 having a patterned mask layer 116 on the first portion 105ₚₜ₁ of planar waveguide layer 105 formed after patterning of the top cladding layer 105_{tc} and the full thickness of the core layer 105_{core}.

FIG. 4C (c) shows a schematic cross-sectional drawing of a portion of another embodiment of an optical interposer structure 104 having a patterned mask layer 116 on the first portion 105 pt₁ of planar waveguide layer 105 after patterning of the top cladding layer 105_{tc}, the full thickness of the core layer 105_{core}, and the full thickness of the bottom cladding layer 105_{bc}.

FIGS. 4D (a) to 4D (c) show schematic cross-sectional drawings of the portions of the embodiment of an optical interposer structure 104 of FIGS. 3C(a) to 3C (c), respectively, after removal of the patterned mask layer 116 and formation of second portions 105ₚₜ₂ of planar waveguide layer 105 on first portions 105ₚₜ₁ wherein the first portions 105ₚₜ₁ include all or a portion of a top cladding layer 105_{tc}. Second portion 105ₚₜ₂ of planar waveguide layer 105, in the embodiments shown, encapsulates the patterned top cladding layers 105_{tc} and core layers 105_{core}, and to provide side cladding to the patterned core layer 105_{core}, and to optionally provide one or more of an additional top cladding layer and optionally to provide one or more of a spacer layer, a buffer layer, a planarization layer, among other layers. In the embodiment shown in FIG. 4C (c), second portion 105ₚₜ₂ also encapsulates the patterned bottom cladding layer.

FIG. 4E shows a schematic cross-sectional drawing of the portion of the embodiment of an optical interposer structure 104 of FIG. 4D (b) after formation of an electrical interconnect layer 103-2 on the second portion 105ₚₜ₂ of the planar waveguide layer 105 for an embodiment having an electrical interconnect layer 103-2 formed on the planar waveguide layer 105 in addition to an underlying electrical interconnect layer 103-1 formed as shown between the substrate 100 and the planar waveguide layer 105.

The structures described in FIGS. 3A-3E and in 4A-4E illustrate the partitioning of the formation of the planar waveguide layer 105 into first portions 105ₚₜ₁ and second portions 105ₚₜ₂ that are used in the formation of embodiments of optical interposer structures having self-aligned alignment features such as fiducials 114_{SA} and alignment pillars 134_{SA} that are formed self-aligned to the patterned planar waveguide cores 144_{SA}. Methods of formation of embodiments are disclosed in the following sections with flowcharts and sequences of figures that further illustrate the formation of the patterned planar waveguide core structures of FIGS. 3A-3E and 4A-4E in conjunction with the formation of self-aligned alignment features.

The methods of forming embodiments of optical interposer structure 104 and the methods of forming assemblies 102 that include embodiments of optical interposer structure 104 include a sequence of steps for which patterned planar waveguide cores and alignment features are formed from a planar waveguide layer 105 using a same first patterned mask layer, burying the patterned planar waveguide layer after removal of the first patterned mask layer from the patterned planar waveguides, and using another patterned mask layer as described herein to form cavities and to form the self-aligned alignment features within the cavities.

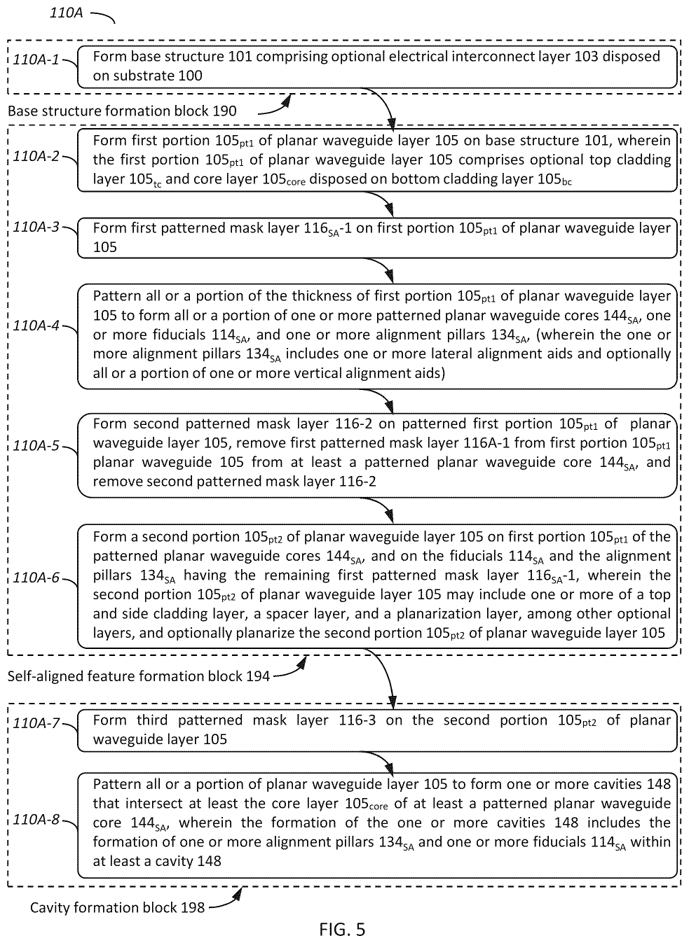

FIG. 5 shows a flowchart for method 110A for forming embodiments of an optical interposer structure 104 having alignment pillars 134_{SA} and fiducial 114_{SA} formed in cavity 148, wherein the alignment pillars 134_{SA} and fiducial 114_{SA} are formed from a same patterned mask layer 116_{SA} used in the formation of patterned planar waveguide cores 144_{SA}.

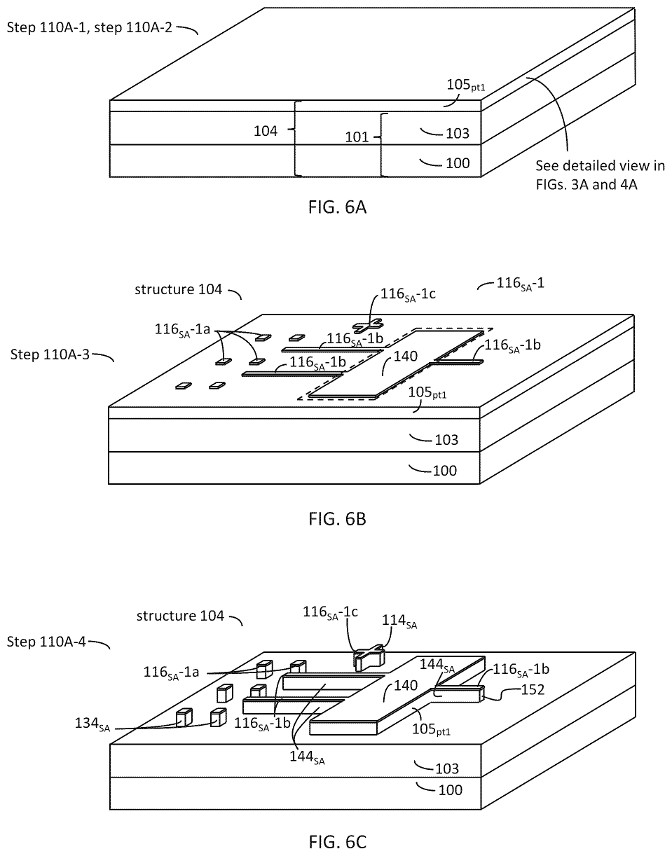

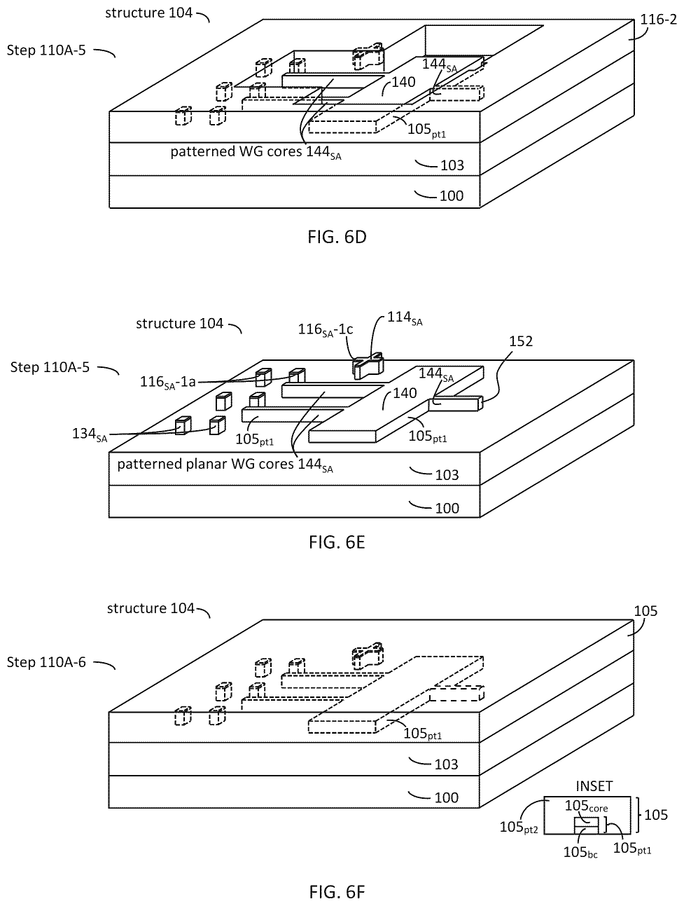

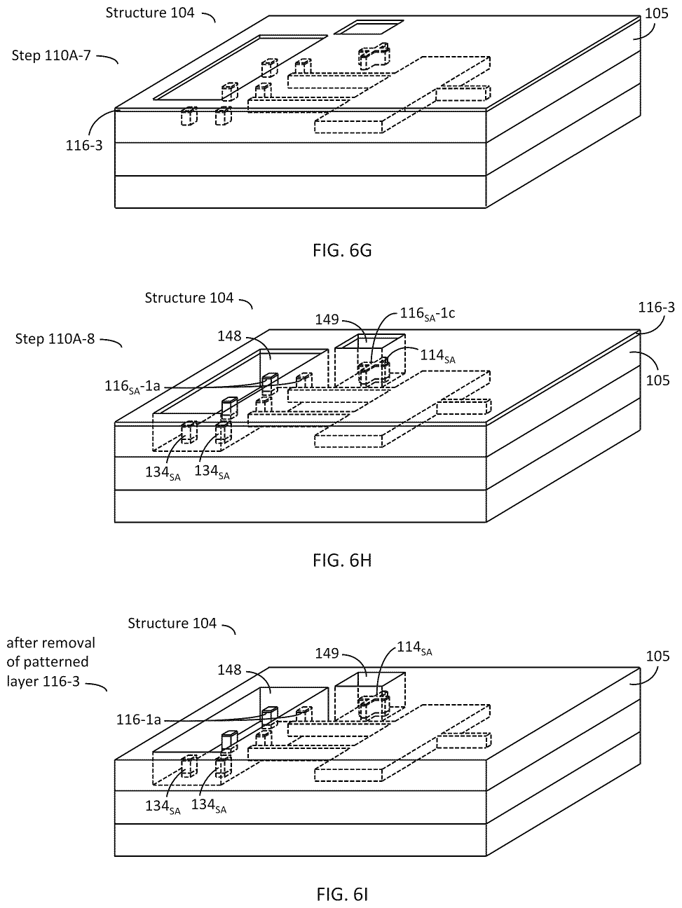

The steps in method 110A in the flowchart in FIG. 5 are further described in conjunction with the sequence of perspective drawings in FIGS. 6A-6I.

Step 110A-1 of method 110A is a forming step in which interposer base structure 101 is formed, wherein base structure 101 comprises an optional electrical interconnect layer 103 disposed on a substrate 100. In some embodiments having self-aligned features, electrical interconnectivity may not be required rendering the electrical interconnect layer an optional layer. In embodiments that do not require electrical interconnectivity, self-alignment of alignment pillars 134_{SA} and fiducials 114_{SA} with patterned planar waveguide cores 144_{SA} may be used to align an optical device 120 in cavity 148 utilizing methods and structures disclosed herein.

Electrical interconnect layer 103, in embodiments, may be used to form interconnections between two or more electrical devices mounted or otherwise formed on, or connected to, the interposer structure 104. Electrical interconnections may also lead to electrical terminations, contact pads formed on the planar waveguide layer 105 to enable, for example, interconnectivity to submounts, externally mounted devices, among other devices that may benefit with electrical contact with conductive layers formed in electrical interconnect layer 103.

Base structure formation block 190 of method 110A comprises Step 110A-1 wherein a base structure 101 is formed. In method 110A, base structure formation block 190 is followed by self-aligned feature formation block 194 and cavity formation block 198.

As used herein, the term “block” is one or more steps of a method of formation associated with the completion of a portion of an optical interposer. A “base structure formation block”, for example, is one or more steps in the formation of a base structure, wherein the base structure is a portion of method 110A for forming embodiments of optical interposer structure 104.

Step 110A-2 is a forming step in which a first portion 105ₚₜ₁ of planar waveguide layer 105 is formed on base structure 101, wherein the base structure comprises the optional electrical interconnect layer 103 disposed on a substrate, and wherein the first portion 105ₚₜ₁ of planar waveguide layer 105 comprises core layer 105_{core} disposed on at least a bottom cladding layer 105_{bc}, and may further comprise an optional top cladding layer 105_{tc} on the core layer 105_{core}. Other layers may be also formed between the bottom cladding layer 105_{bc} and electrical interconnect layer 103.

FIG. 6A shows a perspective drawing of a layered film structure used in embodiments of an optical interposer structure 104 wherein the layered film structure comprises a first portion 105ₚₜ₁ of a planar waveguide layer 105 disposed on a base structure 101. The perspective drawing of FIG. 6A shows first portion 105ₚₜ₁ of planar waveguide layer 105 on base structure 101, after steps 110A-1 and 110A-2 of method 110A, that may be used in the formation of embodiments of optical interposer structure 104. Substrate 100 is formed in some embodiments from a semiconductor such as silicon. Other semiconducting substrates such as indium phosphide, gallium arsenide, or other semiconductors can also be used. In other embodiments, a ceramic or insulating substrate can be used. In yet other embodiments, a metal substrate can be used. And in yet other embodiments, a combination of one or more semiconductor layers, insulating layers, and metal layers are used to form substrate 100 upon which the optional electrical interconnect layer 103 and planar waveguide layer 105 are formed. In some embodiments, electrical interconnect layer 103 is not in direct contact with substrate 100 but rather an intervening layer is present. Similarly, planar waveguide layer 105, in some embodiments, is not in direct contact with underlying electrical interconnect layer 103 but rather an intervening layer or layers may be present. Electrical interconnect layer 103 is further described herein.

Step 110A-3 of method 110A is a forming step in which a first patterned mask layer 116_{SA}-1 is formed on the first portion 105ₚₜ₁ of the planar waveguide layer 105. The first patterned mask layer 116_{SA}-1 may include, for example, patterned portions to facilitate the formation of all or a portion of patterned planar waveguide cores 144_{SA}, fiducials 114_{SA}, and alignment pillars 134_{SA} wherein the alignment pillars 134 may facilitate one or more of lateral alignment and vertical alignment of optical device 120 mounted or otherwise formed on embodiments of optical interposer structure 104. The designation “SA” on the patterned mask layer 116_{SA}-1 indicates that the mask layer includes patterned features that will be formed self-aligned to patterned planar waveguide cores 144 of the planar waveguide layer 105. The trailing number, “1”, indicates that the 116_{SA} is the first mask layer in a described sequence of patterned mask layers.

FIG. 6B shows a perspective drawing of a portion of an embodiment of an optical interposer structure 104 after formation of a first patterned mask layer 116_{SA}-1 comprising alignment pillar patterns 116_{SA}-1a for the formation of all or a portion of alignment pillars 134_{SA}, planar waveguide core patterns 116_{SA}-1b for the formation of all or a portion of patterned planar waveguide cores 144_{SA}, and fiducial patterns 116_{SA}-1c for the formation of all or a portion of fiducials 114_{SA}. The perspective drawing of FIG. 6B shows optical interposer structure 104 of FIG. 6A with the inclusion of first patterned mask layer 116_{SA}-1 having mask patterns 116_{SA}-1a to 116_{SA}-1c on first portion 105ₚₜ₁ of planar waveguide layer 105. First patterned mask layer 116_{SA}-1 includes patterns for the formation of all or a portion of patterned planar waveguide cores 144_{SA} and for the formation of all or a portion of fiducials 114_{SA} and alignment pillars 134_{SA} from the planar waveguide layer 105. When used with a suitable patterning process for the planar waveguide layer 105, first patterned mask layer 116_{SA}-1 enables formation of the patterned planar waveguide cores 144_{SA} and alignment features from the patterns 116_{SA}-1a to 116_{SA}-1c provided in the first patterned mask layer 116_{SA}-1. In the perspective drawing of FIG. 6B, an embodiment of optical interposer structure 104 is shown for which patterned portions of the first patterned mask layer 116_{SA}-1 are provided for the formation of alignment aids that include fiducials 114_{SA} and alignment pillars 134_{SA} that may facilitate one or more of lateral alignment and vertical alignment of optical device 120 mounted or otherwise formed on embodiments of optical interposer structure 104. In the embodiment shown, patterned mask layer portion 116_{SA}-1a shown in FIG. 6B provides a patterned portion for the formation of alignment pillars that may facilitate one or more of lateral alignment and vertical alignment of optical device 120 mounted or otherwise formed on embodiments of optical interposer structure 104. Patterned mask layer portion 116_{SA}-1b provides a patterned portion for the formation of patterned planar waveguide cores 144_{SA}; and patterned mask layer portion 116_{SA}-1c provides a patterned portion for the formation of fiducial 114_{SA}. A plurality of patterns 116_{SA}-1a and 116_{SA}-1b are shown in FIG. 6B for the formation of a plurality of alignment pillars 134_{SA} and patterned planar waveguide cores 144_{SA} as further described herein.

Step 110A-4 of method 110A is a patterning step in which all or a portion of the thickness of the first portion 105ₚₜ₁ of planar waveguide layer 105 is patterned to form all or a portion of one or more patterned planar waveguide cores 144_{SA}, all or a portion of one or more alignment pillars 134_{SA}, and all or a portion of one or more fiducials 114_{SA}. In the embodiment, alignment pillars 134_{SA} may be used to facilitate one or more of lateral alignment and vertical alignment of optical device 120 mounted or otherwise formed in cavity 148, as shown for example, in the embodiment in FIGS. 1A and 1B.

FIG. 6C shows a perspective drawing of a portion of an embodiment of an optical interposer structure 104 after patterning all or a portion of the planar waveguide layer 105ₚₜ₁ to form a plurality of alignment pillars 134_{SA}, patterned planar waveguide cores 144_{SA}, and fiducials 114_{SA}. The perspective drawing of FIG. 6C shows optical interposer structure 104 of FIG. 6B after patterning all or a portion of the first portion 105ₚₜ₁ of planar waveguide layer 105 to form all or a portion of one or more patterned planar waveguide cores 144_{SA}, all or a portion of one or more fiducials 114_{SA}, and all or a portion of one or more alignment pillars 134_{SA} wherein the one or more alignment pillars 134_{SA} includes alignment pillars that facilitate lateral alignment and optionally facilitate vertical alignment. FIG. 6C shows the interposer structure 104 having the first patterned mask layer 116_{SA}-1 remaining on the patterned features from the planar waveguide layer 105.

Portions of the first patterned mask layer 116_{SA}-1, may be used in some embodiments to form all or a portion of optical devices 140 for embodiments in which the optical devices 140 are formed wholly or in part from the planar waveguide layer 105. Optical devices 140 may be waveguides, arrayed waveguides, gratings, lenses, or any device or multiplicity of devices that can be formed from at least a portion of the planar waveguide layer 105. Alternatively, in other embodiments, optical devices 140 are mounted devices, and not fabricated directly from the planar waveguide layer 105 but added to an assembly that includes the optical interposer structure 104 at a later step. In some embodiments, optical device 140 can be one or more of a portion of a device formed from the planar waveguide layer 105 and one or more of a portion of a mounted device.

In some embodiments, planar waveguide layer 105 is formed of one or more layers of silicon dioxide, silicon nitride, silicon oxynitride, and silicon as described herein. Patterning of planar waveguide layer 105 to form patterned planar waveguides 144 from such layers using dry etching processing known in the art of semiconductor processing may be performed using, for example, fluorinated etch chemistries that include one or more commonly utilized gases such as CF₄, CHF₃, C₂F₈, SF₆, among others. In embodiments, aluminum or an alloy of aluminum may also be used to form a first patterned mask layer. Aluminum and alloys of aluminum exhibit a high resistance to dry etching in fluorinated chemistries and thus the dimensions of first patterned mask layer 116_{SA}-1 in the embodiment shown in FIG. 6B, for example, can be substantially maintained during an etch process in which the planar waveguide layer 105 is patterned to provide all or a portion of the patterned fiducial 114_{SA}, the patterned alignment pillars 134_{SA}, and the patterned planar waveguide cores 144_{SA} as in Step 110A-4 of method 110A, for example. Use of a patterned aluminum layer, for example, to form a hard mask to be used for first patterned mask layer 116_{SA}-1 can provide a high resistance to etching chemistries that include fluorine-containing molecules. A hard mask, as used herein, refers to a non-polymer-based masking layer with a material that has a high resistance to the plasma etch, dry etch, or wet etch, used in the patterning of surrounding materials. Aluminum is an example of a hard mask material that may be used in embodiments for the first patterned mask layer 116_{SA}-1 given that this material has a high resistance to fluorine containing etch chemistries. In other embodiments, other hard masks may be used that also exhibit high resistance to a suitable etch chemistry such as Au, Ag, Ni, and Pt. In other embodiments, hard masks layers such as titanium, titanium oxide, tantalum, tantalum oxide, aluminum oxide, silicon carbide, or a combination of one or more of these and other materials may be used. In some embodiments, oxygen or other oxygen-containing gas may be added to the etching chemistry to increase the resistance of the first patterned mask layer 116_{SA}-1 to a suitable etch chemistry. In yet other embodiments, diluents are added to a fluorinated etching chemistry such as one or more of argon, helium, nitrogen, and oxygen, among others to increase the resistance of the mask layer to a fluorinated etch chemistry, or other suitable etching chemistry. In embodiments, the masking layer typically has a slow rate of removal in comparison to the rate of removal of the planar waveguide layer 105. Methods for etching of silicon dioxide, silicon nitride, silicon oxynitride, and silicon are well understood by those skilled in the art of semiconductor processing, as are methods of increasing the resistance of aluminum hard mask layers and other hard mask layers using fluorinated etch chemistries. In subsequent processing steps, as further described herein, the first patterned mask layer 116_{SA}-1 is buried in a second portion 105ₚₜ₂ and exposed to additional patterning processes during the formation of cavities in the planar waveguide layer 105 within which the patterned first mask layer 116_{SA}-1 is buried.

Terminal facet 152 is shown in FIG. 6C. Terminal facets such as terminal facet 152 as shown enable coupling of patterned planar waveguide cores 144 to other optical devices mounted or otherwise formed on embodiments of optical interposer structure 104.

Step 110A-5 of method 110A is a forming and removing step in which a second patterned mask layer 116-2 is formed on the patterned first portion 105ₚₜ₁ of the planar waveguide layer 105, the first patterned mask layer 116_{SA}-1b is removed from one or more patterned planar waveguide cores 144_{SA}, and the second patterned mask layer 116-2 is removed from the optical interposer structure 104. Openings in the second patterned mask layer 116-2, in embodiments, enable removal of the first patterned mask layer 116_{SA}-1b from the first portions 105ₚₜ₁ of the patterned planar waveguide cores 144_{SA} formed in Step 110A-4.

In embodiments, the use of a metal mask layer for the first patterned mask layer 116_{SA}-1 can interfere with the propagation of optical signals through patterned planar waveguide cores 144_{SA}. Removal of the first patterned mask layer, particularly for embodiments for which a metal-based hard mask layer is used for the first patterned mask layer, will eliminate interference from the first patterned mask layer in the propagation of optical signals through the patterned planar waveguides.

Step 110A-5 of method 110A includes the formation of second patterned mask layer 116-2 to enable the removal of the first patterned mask layer 116_{SA}-1 from the patterned planar waveguide cores 144_{SA} while providing protection to other portions of the optical interposer structure 104, the subsequent removal of the first patterned mask layer 116_{SA}-1 from the patterned planar waveguide cores 144_{SA}, and the subsequent removal of the second patterned mask layer 116-2. The second patterned mask layer 116-2, may be, for example, a photoresist layer having openings that enable removal of the patterned portions 116_{SA}-1b of first patterned mask layer 116_{SA}-1 from the patterned planar waveguide cores 144_{SA}. For embodiments in which a polymer-based photoresist material is used to form the second patterned mask layer 116-2, an oxygen plasma or a suitable solvent may be used, for example, to remove this layer.

FIG. 6D shows a perspective drawing of a portion of an embodiment of an optical interposer structure 104 after formation of a second patterned mask layer 116-2 and removal of the first patterned mask layer 116_{SA}-1b from all or a portion of the patterned planar waveguide cores 144_{SA}. Second patterned mask layer may be, for example, a photoresist mask. The second patterned mask layer 116-2 shows openings that enable removal of the portions 116_{SA}-1b of the first patterned mask layer 116_{SA}-1 from the fully or partially formed patterned planar waveguide cores 144_{SA}. That is, after the patterning of all or a portion of the first portion 105ₚₜ₁ of planar waveguide layer 105 to form all or a portion of one or more patterned planar waveguide cores 144_{SA}, all or a portion of fiducials 114_{SA}, and all or a portion of one or more alignment pillars 134_{SA}, the second patterned mask layer 116-2 is used to form a protective layer over the patterned portions 116_{SA}-1a and 116_{SA}-1c and to form unmasked areas that expose patterned portions 116_{SA}-1b of the first patterned mask layer 116_{SA}-1. Removal of the patterned portions 116_{SA}-1b of first patterned mask layer 116_{SA}-1 may be performed, for example, using a suitable wet etch chemistry that selectively etches or otherwise removes the first patterned mask layer preferably with minimal or no deleterious effects on the underlying patterned planar waveguides or other portions of the optical interposer structure 104 that may be exposed to the wet etch chemistry. A suitable wet etch chemistry such as a phosphoric acid based wet chemistry may be used, for example, for a first patterned mask layer 116_{SA}-1 formed from aluminum that would have little or no effect on underlying dielectric layers formed from such materials as silicon oxide, silicon oxynitride, silicon nitride, and silicon. Other suitable wet chemical removal processes or plasma etches may also be used for embodiments in which aluminum or other material is used to form the first patterned mask layer 116_{SA}-1. Other suitable wet chemical removal processes or plasma etches may be used in the formation of other embodiments in which another material or combination of materials is used to form the first patterned mask layer 116_{SA}-1.

FIG. 6E shows a perspective drawing of a portion of an embodiment of an optical interposer structure 104 after removal of the second patterned mask layer 116-2.

Step 110A-6 of method 110A is a forming step in which a second portion 105ₚₜ₂ of planar waveguide layer 105 is formed on the first portion 105ₚₜ₁ of the patterned planar waveguide cores 144_{SA} and on the fiducial 114_{SA} and the alignment pillars 134_{SA} having the remaining patterned portions 116_{SA}-1c and 116_{SA}-1a, respectively, of first patterned mask layer 116_{SA}-1, wherein the second portion 105ₚₜ₂ of planar waveguide layer 105 may include one or more of a top and side cladding layer 105_{tc}, a spacer layer, and a planarization layer, among other optional layers. The second portion 105ₚₜ₂ of the planar waveguide layer 105 is formed on the patterned planar waveguide cores 144_{SA} after removal of the patterned portion 116_{SA}-1b of the first patterned mask layer 116_{SA}-1 whereas the patterned portions 116_{SA}-1c and 116_{SA}-1a of the first patterned mask layer 116_{SA}-1 is remaining on the fiducial 114_{SA} and the alignment pillars 134_{SA}, respectively, resulting in the burying of the patterned portions 116_{SA}-1c and 116_{SA}-1a of the first patterned mask layer 116_{SA}-1 within the second portion 105ₚₜ₂ of planar waveguide layer 105.

The second portion 105ₚₜ₂ of planar waveguide layer 105 may be formed, for example, from one or more layers of silicon dioxide, silicon nitride, or silicon oxynitride and may include one or more of a top cladding layer, an encapsulating layer, a buffer layer, a spacer layer, and a passivation layer, among others. In some embodiments, second portion 105ₚₜ₂ may include a planarization layer.

In step 110A-5, the first patterned mask layer 116_{SA}-1 is removed from the patterned planar waveguide cores 144_{SA} to avoid interference with optical signals propagating within the patterned planar waveguide cores 144_{SA} in PICs formed from embodiments of the optical interposer structure 104. The first patterned mask layer 116_{SA}-1, however, is not removed from fiducial 114_{SA} and alignment pillars 134_{SA} in step 110A-5. In embodiments formed using method 110A to form the optical interposer structure 140, the second portion 105ₚₜ₂ of planar waveguide layer 105 is formed in forming step 110A-6 on the remaining portions 116_{SA}-1c and 116_{SA}-1a of first patterned mask layer 116_{SA}-1 on patterned features that include fiducial 114_{SA} and alignment pillars 134_{SA}, respectively, whereas this second portion 105ₚₜ₂ of planar waveguide layer 105 is formed on the patterned planar waveguide cores 144_{SA} of the first portion 105ₚₜ₁ of planar waveguide layer 105 and surrounding areas after patterning and removal of the patterned portion 116_{SA}-1b of first patterned mask layer 116 from the patterned planar waveguide cores 144_{SA}. Upon formation of the second patterned portion 105ₚₜ₂ of planar waveguide layer 105, an optional planarization step may be used in some embodiments to planarize one or more of the second portion 105ₚₜ₂ of the planar waveguide layer 105.

Self-aligned feature formation block 194 follows base structure formation block 190 and comprises steps 110A-2 to 110A-6. The steps 110A-2 to 110A-6 in method 110A include a sequence of steps for which patterned planar waveguide cores and alignment features are formed from a first portion of a planar waveguide layer using a same patterned mask layer and buried in a second portion of the planar waveguide layer after removal of the patterned mask layer from the patterned planar waveguides. In method 110A, self-aligned feature formation block 194 is followed by cavity formation block 198.

FIG. 6F shows a perspective drawing of a portion of an embodiment of an optical interposer structure 104 after formation of a second portion 105ₚₜ₂ of planar waveguide layer 105. The INSET of FIG. 6F shows planar waveguide layer 105 for an embodiment having a first portion 105ₚₜ₁ comprising a patterned core layer 105_{core} on a patterned bottom cladding layer 105_{bc}. Second portion 105ₚₜ₂ is shown on patterned first portion 105ₚₜ₁ of planar waveguide layer 105 as shown in FIG. 3D(c). Other embodiments shown in FIGS. 3A-3D(c) and FIGS. 4A-4D (c) may also be used in the formation of the optical interposer structure 104 as shown in FIG. 6F.

The second portion 105ₚₜ₂ of planar waveguide layer 105 formed in step 110A-6 of method 110A in embodiments, is an encapsulating dielectric layer formed on the patterned planar waveguide cores 144_{SA}, and on the one or more fiducials 114_{SA} and the one or more alignment pillars 134_{SA} having the remaining first patterned mask layer 116_{SA}-1. In embodiments, the encapsulating second portion 105ₚₜ₂ of planar waveguide layer 105 may provide a side cladding for the patterned planar waveguides, all or a portion of a top cladding layer, and all or a portion of a spacer layer, buffer layer, planarization layer, among other optional layers.

Step 110A-7 of method 110A is a forming step in which a third patterned mask layer 116-3 is formed on the second portion 105ₚₜ₂ of planar waveguide layer 105. As noted in step 110A-6 of method 110A, an optional planarization step may be used to planarize the second portion 105ₚₜ₂ of planar waveguide layer 105 prior to formation of third patterned mask layer 116-3 in some embodiments. Patterned openings in the third patterned mask layer 116-3, enable the formation of cavities 148 in one or more of the second portion 105ₚₜ₂ and first portion 105ₚₜ₁ of planar waveguide layer 105.

FIG. 6G shows a perspective drawing of a portion of an embodiment of an optical interposer structure 104 after formation of a third patterned mask layer 116-3 on planar waveguide layer 105 wherein the third patterned mask layer 116-3 comprises patterned features for the formation of one or more of one or more cavities 148,149 having fiducials 114_{SA} and alignment pillars 134_{SA} within the one or more cavities 148,149. The formation of cavities 148,149 having alignment features formed using first patterned mask layer 116_{SA}-1 enables the completion of the self-aligned fiducial 114_{SA} and self-aligned alignment pillars 134 having lithographic alignment with patterned planar waveguide cores 144_{SA}.

Third patterned mask layer 116-3 may be a hard mask layer, for example, formed from a layer of aluminum or an alloy of aluminum having a high resistance to a patterning process used in the patterning of an underlying planar waveguide layer 105 formed of a dielectric material that may be patterned using a fluorinated etching process. In some embodiments, the same material may be used to form all or a portion of the third patterned mask layer 116-3 as is used in the formation of the first patterned mask layer 116_{SA}-1.

Step 110A-8 of method 110A is a patterning step in which all or a portion of the second portion 105ₚₜ₂ of planar waveguide layer 105 is patterned and optionally all or a portion of the first portion 105ₚₜ₁ of planar waveguide layer 105 is also patterned to form one or more cavities that intersect at least the core layer 105_{core} of at least a patterned planar waveguide core 144_{SA}, wherein the formation of the one or more cavities includes the formation of one or more of one or more alignment pillars 134_{SA} and one or more fiducials 114_{SA} within at least a cavity. The alignment pillars 134_{SA}, in embodiments, may be alignment pillars formed to facilitate one or more of lateral alignment and vertical alignment of optical device 120 mounted or otherwise formed on embodiments of optical interposer structure 104.

FIG. 6H shows a perspective drawing of a portion of an embodiment of an optical interposer structure 104 after formation of cavities 148,149 in planar waveguide layer 105, wherein the cavities 148,149 in the embodiment have alignment pillars 134_{SA} and fiducial 114_{SA} formed in alignment with the buried patterned planar waveguide cores 144_{SA}. Cavity 148 is show to intersect patterned planar waveguide cores 144_{SA}. Fiducial 114 is shown in cavity 149 to enable clear focusing at the same horizontal plane as alignment pillars 134_{SA}. Patterned portions 116_{SA}-1a and 116_{SA}-1c of first patterned mask layer 116_{SA}-1 are shown remaining on alignment pillars 134_{SA} and fiducial 114, respectively, after formation of the cavities 148, 149, respectively.

Cavity formation block 198 follows self-aligned feature formation block 194 and comprises steps 110A-7 and 110A-8. The steps 110A-7 and 110A-8 in method 110A include a sequence of steps for which one or more cavities having alignment features are formed on the optical interposer structure 104.

Upon completion of the formation of cavities 148,149 in Step 110A-8 of method 110A, additional processing may be performed to continue with the formation of embodiments of optical interposer structure 104. Additional processing may also be performed to continue with the formation of assemblies 102 comprising optical interposer structure 104 and one or more devices as further described herein. Additional processing may include the removal of the third patterned mask layer 116-3, for example, the formation of a second electrical interconnect layer 103-2 as shown for example, in FIGS. 3E and 4E, among other additional processing steps.

In embodiments, the formation of the one or more cavities 148 includes the formation of one or more alignment pillars 134_{SA} within the one or more cavities 148 using a same first patterned mask layer 116_{SA}-1 in conjunction with a suitable patterning process to remove all or a portion of the thickness of planar waveguide layer 105 within the openings formed in third patterned mask layer 116-3 with the exception of the material comprising the one or more alignment pillars 134_{SA} that remains within the one or more cavities 148 after formation of the cavities 148. With the formation of the alignment pillars 134_{SA} within the cavities 148 upon exposure of the buried first patterned mask layer 116_{SA} used in both the patterning of the alignment pillars 134_{SA} and the patterned planar waveguide cores 144_{SA}, the self-aligned alignment pillars 134_{SA} and fiducials 114_{SA} are thereby formed in alignment with the patterned planar waveguide cores 144.

As the one or more cavities 148 are formed on the optical interpose structure 104, the buried portions of the first patterned mask layer 116_{SA}-1 will become exposed to the patterning process as the planar waveguide layer 105 is removed from the cavity 148. Patterning processes that are selective to the planar waveguide layer 105, in comparison to the material used in the formation of the first patterned mask layer 116_{SA}-1, are used to enable the removal of the material used in the formation of the planar waveguide layer 105 without excessive removal of the buried first patterned mask layer 116_{SA}-1 that is exposed during formation of the one or more cavities 148.

In some embodiments, one or more cavities 148 are formed in patterning step 610A-8 in which all or a portion of the second portion 105ₚₜ₁ of planar waveguide layer 105 and optionally all or a portion of the first portion 105ₚₜ₁ of the planar waveguide layer 105 are patterned to form one or more cavities 148 that intersect at least the core layer 105_{core} of at least a patterned planar waveguide core 144_{SA}, wherein the formation of the one or more cavities 148 includes the formation of one or more of one or more alignment pillars 134_{SA} and optionally one or more fiducials 114_{SA} within at least a cavity 148.

In some embodiments, the depth of the cavities 148 may be limited to at or within the depth of the planar waveguide layer 105. In some embodiments, the depth of the cavities 148 may be limited to at or within the depth of the second portion 105ₚₜ₂ of the planar waveguide layer 105.

In other embodiments, the depth of the cavities 148 may extend through all or a portion of the underlying planar waveguide layer 105, and may further extend, in some embodiments, through all or a portion of the intermetal dielectric portions of an underlying electrical interconnect layer 103. In other embodiments, the depth of the cavities 148 may extend through the second portion of the planar waveguide layer 105 and may extend into all or a portion of the first portion of the planar waveguide layer 105, and may further extend, in some embodiments, through all or a portion of the intermetal dielectric portions of the underlying electrical interconnect layer 103. The depths of the cavities 148 formed in embodiments of the optical interposer structure 104 can vary over the range of depths at which the alignment pillars emerge from the patterning of the cavities to a depth that includes a portion of the intermetal dielectric layer of the underlying electrical interconnect layer 103.

In the formation of the one or more cavities 148, the third patterned mask layer 116-3 and the first patterned mask layer 116_{SA}-1 may be simultaneously exposed to the patterning process used in the formation of the cavities 148, resulting in the formation of alignment features 134_{SA} within the cavities 148.

In some embodiments, the insulating dielectric layer 138 is formed of one or more layers of silicon dioxide. In some embodiments, the insulating dielectric layer 138 is formed of one or more layers of silicon dioxide, silicon nitride, and silicon oxynitride. To pattern the layer 138 and in some embodiments, all or a portion of the underlying layers below the layer 138 and all or a portion of the electrical interconnect layer using a dry etch process, fluorinated etch chemistries in which one or more commonly utilized gases such as CF₄, CHF₃, C₂F₈, SF₆, among others, may be used. In an example embodiment, the first patterned mask layer is formed from aluminum or an alloy of aluminum. Aluminum hard masks are known to exhibit a high resistance to dry etching in fluorinated chemistries and thus the dimensions of the first patterned mask layer, a hard mask, can be maintained during the etching of the dielectric insulating layer 138 and other dielectric layers susceptible to chemical etching using fluorinated etch processes used in the formation of the alignment pillars 134, the fiducials 114, and other alignment aids that may be present. In other embodiments, other hard masks may be used that also exhibit high resistance to the etch chemistry such as gold, silver, nickel, and platinum, among others. In other embodiments, hard masks layers such as titanium, titanium oxide, tantalum, tantalum oxide, aluminum oxide, silicon nitride, silicon carbide, or a combination of one or more of these materials may be used. In some embodiments, oxygen or other oxygen-containing gas is added to the etching chemistry to increase the resistance of the first patterned mask layer to a suitable etch chemistry. In yet other embodiments, diluents are added to the fluorinated gas chemistry such as one or more of argon, helium, nitrogen, and oxygen, among others to increase the resistance of the hard mask to the fluorinated etch chemistry. In embodiments, the masking layer typically has a slow rate of removal in comparison to the rate of removal of dielectric layer 138 and, in some embodiments, all or a portion of the planar waveguide layer 105. Methods for etching of silicon dioxide, silicon nitride, silicon oxynitride, and silicon are well understood by those skilled in the art of semiconductor processing, as are methods of increasing the resistance of aluminum hard mask layers and other hard mask layers using fluorinated etch chemistries.

Cavity 148, for the embodiment in FIG. 6H, shows the resulting alignment pillars 134 that are formed from the removal of the material to form the cavity 148 and the exposure of the buried first patterned mask layer portion 116b on the alignment pillars 134. A fiducial 114 is shown in a cavity 149 that is separated from the cavity 148. The fiducials 114 are formed at the same depth in cavity 149, as shown, to facilitate precise positioning using, for example, pick-and-place apparatus that utilize the fiducials for location detection on the interposer structure 104. Use of the same first patterned mask layer 116 to form the fiducials 114, enables the precise focal correspondence between the fiducials 114 and the alignment pillars 134 over which devices mounted in the cavities 148 will be placed. In other embodiments, one or more fiducials 114 may be formed with one or more alignment pillars 134 in cavity 148. In the embodiment shown in FIG. 6H, the alignment pillars 134 are formed in alignment with the patterned planar waveguides 144 to facilitate alignment of devices mounted in cavity 148 with the patterned planar waveguide core 144 that intersects the cavity 148.

In the embodiment shown in FIG. 6H, the alignment pillars 134 are shown in cavity 148 and the fiducials 114 are shown in cavity 149. In other embodiments, the fiducials 114 may be formed in the same cavity 148 as the alignment pillars 134. In other embodiments, two or more fiducials 114 may be formed. In embodiments with two or more fiducials 114, one or more fiducials 114 may be formed within the cavity 148 and one or more fiducials 114 may be formed in a separate cavity 149. In yet other embodiments with two or more fiducials 114, multiple cavities 149 may be formed with fiducials 114. The fiducials 114 illustrated herein are shown in the shape of a “+” sign. Other shapes may also be used in other embodiments. Fiducials may also be formed using features formed in the first patterned mask layer that have other structural or photonic functions.

FIG. 6I shows a perspective drawing of a portion of an embodiment of an optical interposer structure 104 after optional removal of the third patterned mask layer 116-3. The perspective drawing in FIG. 6I shows optical interposer structure 104 of FIG. 6H after optional removal of the third patterned mask layer 116-3. FIG. 6I shows cavity 148 having the alignment pillars 134_{SA} and cavity 149 having fiducial 114 on the optical interposer structure 104. In some embodiments, third patterned mask layer 116-3 may be removed prior to the continuation of processing for the formation of embodiments of optical interposer structure 104 and assemblies formed from the embodiments of optical interposer structure 104. In some embodiments, third mask layer 116-3 may not be removed prior to subsequent processing. In some embodiments, all or a portion of third mask layer 116-3 may be used in the formation of all or a portion of an electrical interconnect layer 103-2 formed on the planar waveguide layer 105.

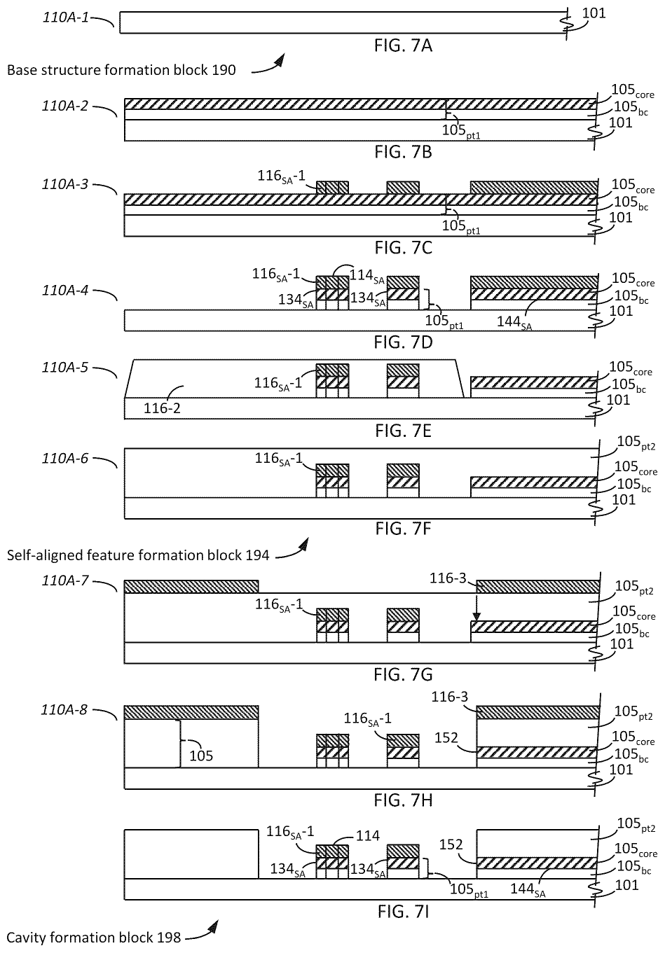

FIGS. 7A-7I show cross-sectional schematic drawings of the formation of an embodiment of an optical interposer structure 104 having self-aligned alignment aids in a device mounting cavity 148 wherein the self-aligned alignment aids comprise alignment pillars 134_{SA} and fiducial 114_{SA} formed in alignment with a patterned planar waveguide core 144_{SA}. The sequence of cross-sections in FIGS. 7A-7I further illustrates the steps described in the sequence of drawings in FIGS. 6A-6I, and in particular, that further illustrates the formation and patterning of the planar waveguide layer 105 to form planar waveguide cores 144_{SA}, as described, for example, in method 110A. The sequence of cross-section drawings in FIGS. 6A-6I will be used as a basis to describe other embodiments of optical interposer structure 104 having alignment pillars 134 formed at multiple heights in cavity 148 and other embodiments having multiple planar waveguide layers.

FIG. 7A shows a cross-sectional schematic drawing of a portion of an embodiment of optical interposer structure 104 after formation of interposer base structure 101 as in Step 110A-1. Method block 190 comprising Step 110A-1 is a base structure formation block 190. In method 110A, base structure formation block 190 is followed by self-aligned feature formation block 194 and cavity formation block 198.

FIGS. 7B-7F pertain to the formation of planar waveguide layer 105 and the self-aligned alignment features such as alignment pillars 134_{SA} and fiducial 114_{SA} within the planar waveguide layer 105, prior to the formation of any cavities that may be formed in the optical interposer structure 104.

FIG. 7B shows a cross-sectional schematic drawing of a portion of an embodiment of optical interposer structure 104 after formation of first portion 105ₚₜ₁ of planar waveguide layer 105 as in Step 110A-2, wherein the first portion 105ₚₜ₁ of planar waveguide layer 105 comprises a core layer 105_{core} disposed on bottom cladding layer 105_{bc} in the embodiment. In other embodiments, the first portion 105ₚₜ₁ may include a top cladding layer 105_{tc} as described, for example, in reference to embodiments shown in FIGS. 4A-4D.

FIG. 7C shows a cross-sectional schematic drawing of a portion of an embodiment of optical interposer structure 104 after formation of first patterned mask layer 116_{SA}-1 on first portion 105ₚₜ₁ of planar waveguide layer 105 as in Step 110A-3. In embodiments described herein, label “116” refers to a patterned mask layer. Label “116_{SA}” having the subscript “SA” refers to a patterned mask layer 116 used in the formation of self-aligned patterned planar waveguide cores 144_{SA} and alignment aids such as alignment pillars 134_{SA} and fiducial 114_{SA} all or in part from the underlying core layer 105_{core} of the planar waveguide layer 105. And the “−1” of the label “116-1” and “116_{SA}-1” refers to a numerical index used in sequences having more than one patterned mask layers 116. A “−1” refers to the first patterned mask layer in a sequence of steps described in an embodiment of a method of forming embodiments of optical interposer structure 104. A “−2” refers to the second patterned mask layer in a sequence of steps described in an embodiment of a method of forming embodiments of optical interposer structure 104. A “−3” refers to the third patterned mask layer in a sequence of steps described in an embodiment of a method of forming embodiments of optical interposer structure 104, and so on.

FIG. 7D shows a cross-sectional schematic drawing of a portion of an embodiment of optical interposer structure 104 after patterning of first portion 105ₚₜ₁ of planar waveguide layer 105 as in Step 110A-4. In the embodiment shown, the patterning of the first portion of planar waveguide layer 105 includes the patterning of a core layer 105_{core} and a bottom cladding layer 105_{bc} of planar waveguide layer 105. In other embodiments, as described in FIGS. 3A-3D and FIGS. 4A-4D, other portions of the planar waveguide layer 105 may be patterned.

In the embodiment shown in FIG. 7D, the self-aligned alignment pillars 134_{SA} include fiducial 114_{SA} as shown. Vertical markings are provided on the left alignment pillar 134_{SA} in FIG. 7D to indicate the dual role of the alignment pillar 134_{SA} as both a lateral alignment aid and a fiducial. The top surface of the alignment pillar 134_{SA} is labeled as fiducial 114 to further illustrate the dual role of the alignment pillar shown on the left of the cavity 148.

FIG. 7E shows a cross-sectional schematic drawing of a portion of an embodiment of optical interposer structure 104 after formation of second patterned mask layer 116-2 and removal of patterned mask layer 116_{SA}-1 from patterned planar waveguide core 144_{SA} as in Step 110A-5.

FIG. 7F shows a cross-sectional schematic drawing of a portion of an embodiment of optical interposer structure 104 after removal of second patterned mask layer 116-2 as in Step 110A-5 and formation of second portion 105ₚₜ₂ of planar waveguide layer 105 as in Step 110A-6.

FIGS. 7G-7I pertain to the formation of cavities 148 having alignment features such as alignment pillars 134_{SA} and fiducial 114_{SA} formed self-aligned with patterned planar waveguide cores 144_{SA} in an embodiment of an optical interposer structure 104 having self-aligned alignment aids.

FIG. 7G shows a cross-sectional schematic drawing of a portion of an embodiment of optical interposer structure 104 after formation of a third patterned mask layer 116-3 on second portion 105ₚₜ₂ of planar waveguide layer 105 as in Step 110A-7, wherein the third patterned mask layer 116-3 comprises patterns to facilitate formation of cavity 148 in planar waveguide layer 105. In other embodiments, an additional cavity 149 may be formed within which a self-aligned fiducial 114_{SA} may be formed. The patterned mask layer 116-3 may, in some embodiments, enable the formation of a terminal end facet 152 of the patterned planar waveguide core 144_{SA} as indicated by the arrow highlighting the offset in the alignment between the opening in the third patterned mask layer 116-3 and the end of the patterned planar waveguide core 144 shown in FIG. 7G.

FIG. 7H shows a cross-sectional schematic drawing of a portion of an embodiment of optical interposer structure 104 after formation of cavity 148 in planar waveguide layer 105 as in Step 110A-8. With the formation of cavity 148, the alignment pillars 134_{SA}, protected with the remaining patterned portions of the first patterned mask layer 116_{SA}-1, are more fully formed as are the cavity walls that include terminal facet 152 of the patterned planar waveguide core 144_{SA}.

FIG. 7I shows a cross-sectional schematic drawing of a portion of an embodiment of optical interposer structure 104 after optional removal of third pattered mask layer 116-3. FIG. 7I shows an embodiment of an optical interposer structure 104 having the self-aligned alignment pillars 134_{SA}, including an alignment pillar 134_{SA} having a dual role as a fiducial 114_{SA}. Alignment pillars 134_{SA} are shown formed in cavity 148 self-aligned to patterned planar waveguide core 144_{SA}, wherein the patterned planar waveguide core 144_{SA} includes an end facet 152 that intersects a cavity wall of cavity 148. FIG. 7I further shows the layered structure of the embodiment including first portion 105ₚₜ₁ and second portion 105ₚₜ₂ of planar waveguide layer 105. The formation of the second portion 105ₚₜ₂ of planar waveguide layer 105 in the embodiment provides one or more of a top cladding layer 105_{tc}, a spacer layer, a buffer layer, and a planarization layer on the first portion 105ₚₜ₁ that includes the patterned core layer 105_{core}.

The cross-sectional drawings in FIGS. 7A to 7I are partitioned into the base structure formation block 190, self-aligned feature formation block 194, and cavity formation block 198 of method 110A to more clearly illustrate the relevance of the drawings to the steps of method 110A, and relevance of the steps to each of the groupings of steps delineated in FIG. 5.

In methods 110B and 110C, embodiments of optical interposer structure 104 are formed in which an additional patterned mask layer is provided in comparison to embodiments formed using the method 110A. The additional patterned mask layer enables the formation of additional alignment pillars at an elevation in the planar waveguide film structure and the resulting cavities formed in the planar waveguide layer, other than that of the patterned mask layer 116_{SA} having the self-aligned features formed in alignment with the patterned planar waveguide cores 144_{SA}. In assemblies 102 comprising embodiments of the optical interposer structure 104 and optical devices 120 mounted in cavity 148, the optical devices 120 may be configured having bearing surfaces at multiple heights. Methods 110B and 110C enable and facilitate the use and alignment of such optical devices 120 by enabling the formation of alignment pillars 134 at multiple elevations within cavity 148.

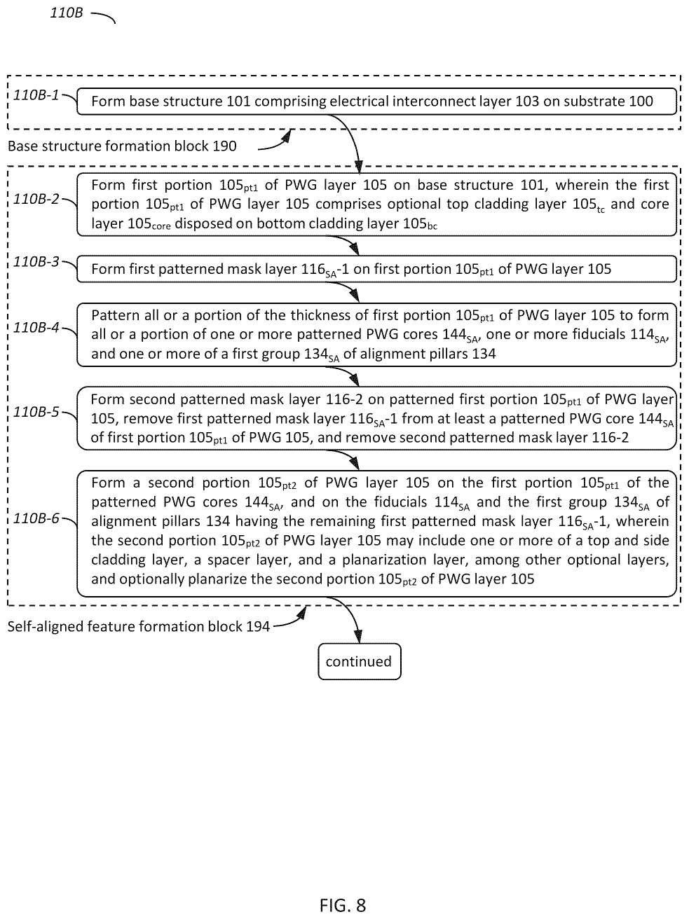

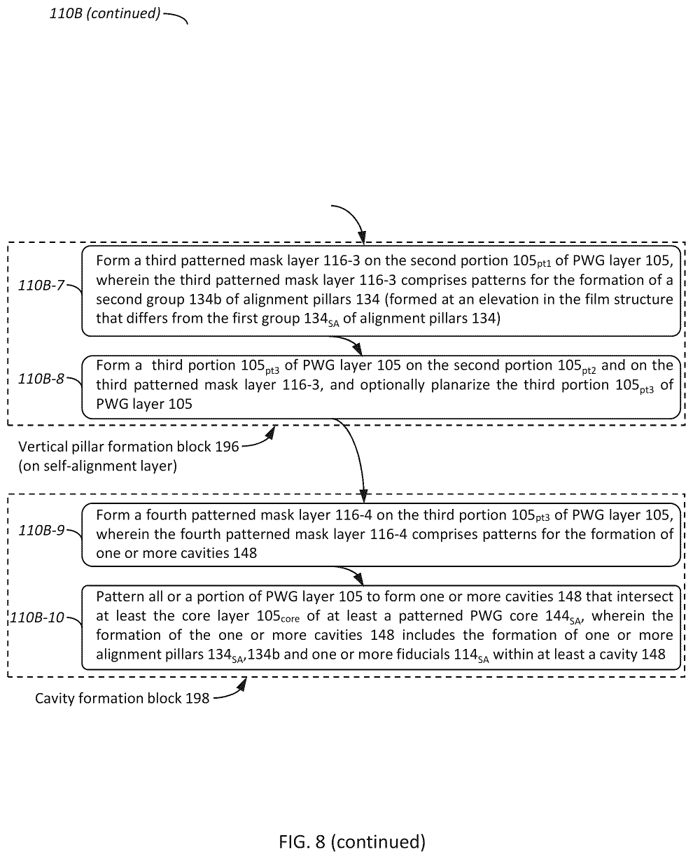

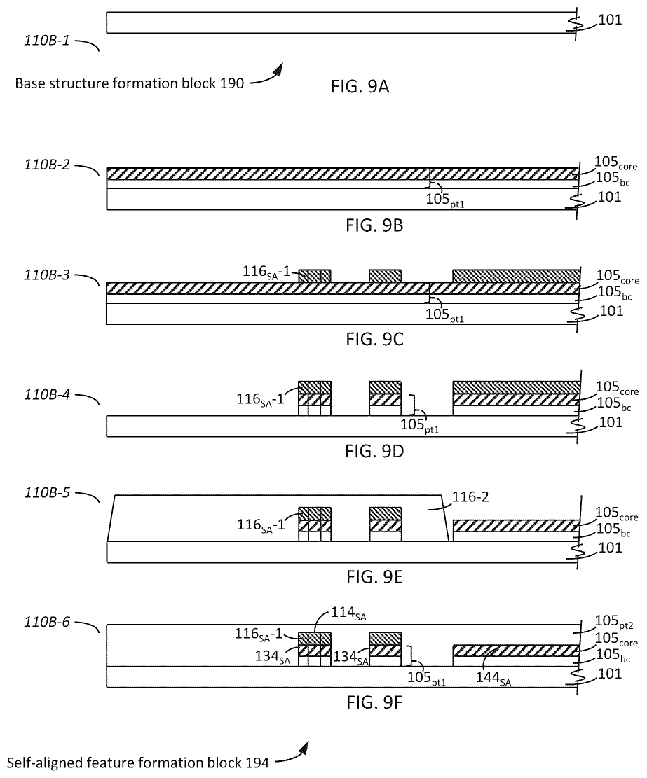

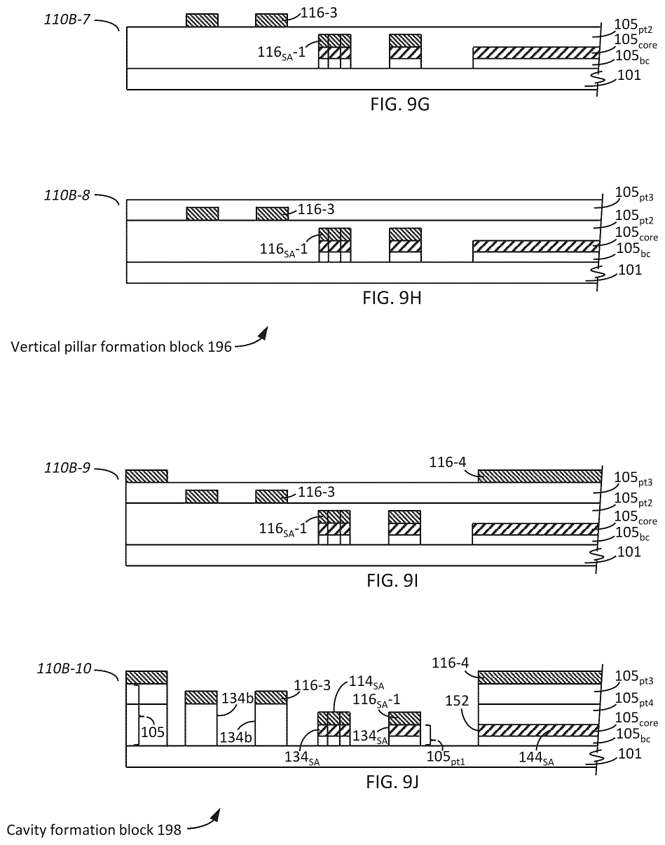

FIG. 8 shows a flowchart for method 110B for forming embodiments of an optical interposer structure 104 having alignment pillars 134 formed at multiple heights in cavity 148, wherein the alignment pillars 134 at a lower height are formed from a same patterned mask layer 116_{SA} used in the formation of patterned planar waveguides cores 144. The steps in method 110B are described in conjunction with FIGS. 9A-9J.

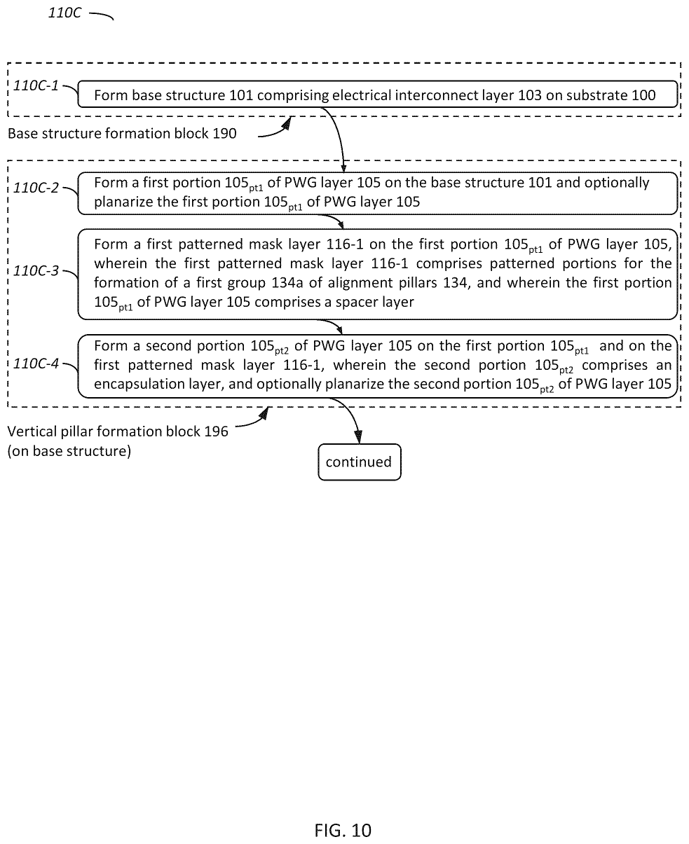

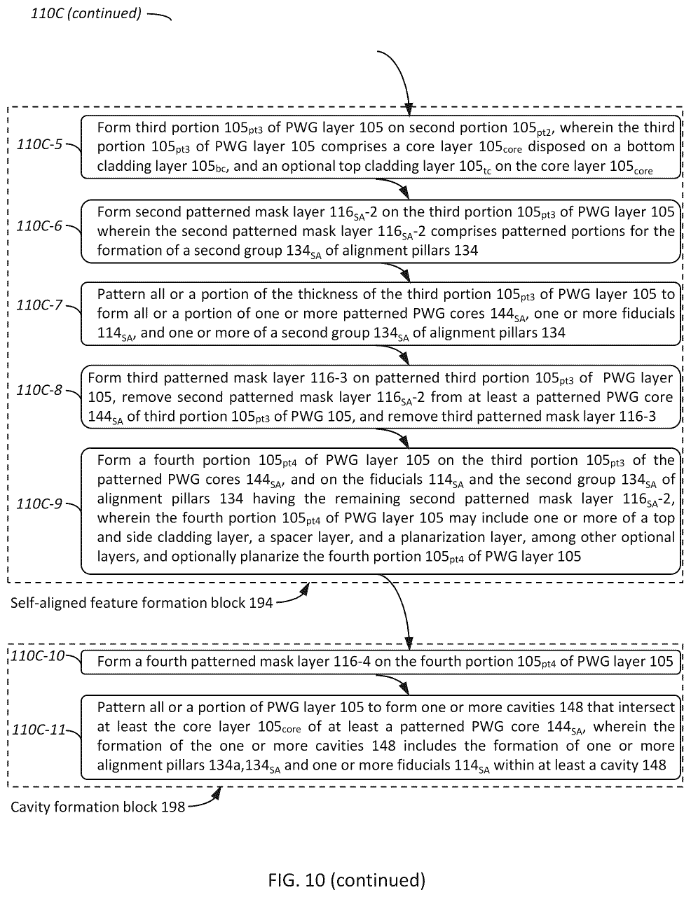

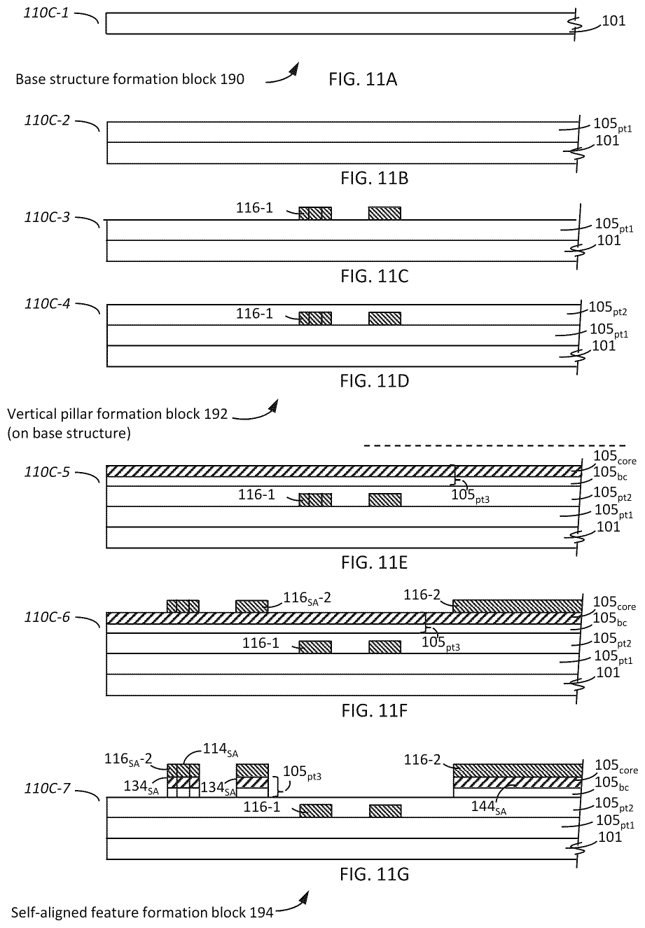

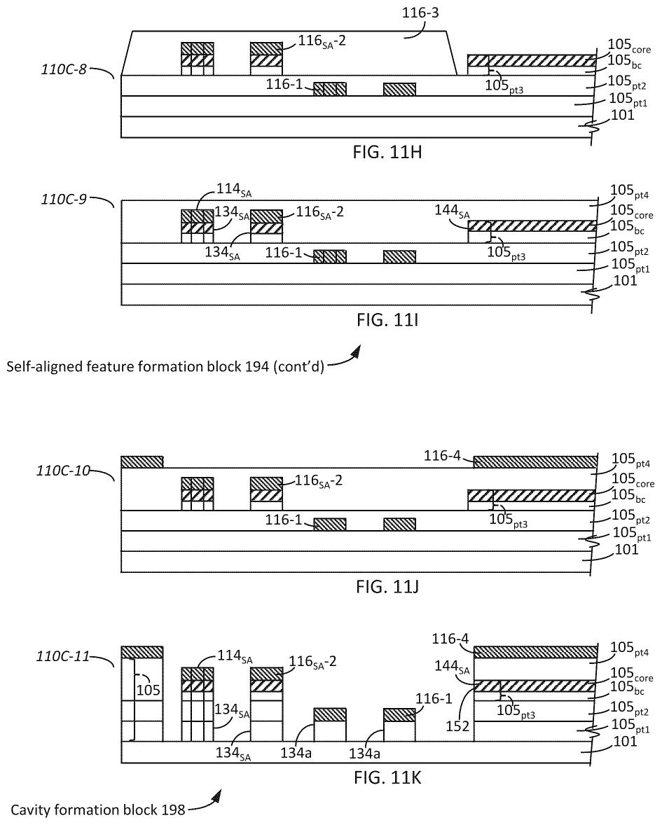

In method 110C shown in FIG. 10, steps for the formation of embodiments of optical interposer structure 104 configured having alignment pillars 134 formed at multiple heights in cavity 148 wherein the alignment pillars 134 at the upper height are formed from a same patterned mask layer 116_{SA} as used in the formation of patterned planar waveguide cores 144. The steps in method 110C are described in conjunction with FIGS. 11A-11K.

In embodiments formed using methods 110B and 110C, the additional alignment pillars 134b,134a, respectively, formed at a second elevation in cavity 148 are not formed self-aligned with the patterned planar waveguide cores 144_{SA} and are therefore preferably used to provide alignment in the vertical direction. The precision of the vertical alignment of optical devices 120 mounted in cavity 148 is determined largely by the precision of the processes used in forming the layer thickness upon which the patterned mask layer used to pattern the alignment pillars at the second elevation is formed.

Steps 110B-1 to 110B-6 of method 110B are the same as steps 110A-1 to 110A-6 of method 110A with the exception that the patterned alignment pillars formed in step 110B-4 of method 110B are identified as a “first group 134_{SA} of alignment pillars 134”. The first group of alignment pillars 134_{SA} are the same for both method 110A and 110B and the structures are identical, in the embodiment, up to the completion of step 110A-6 of method 110A and step 110B-6 of method 110B. Descriptions of FIGS. 9A to 9F are also the same as the descriptions provided herein for FIGS. 7A-7F, respectively.

Base structure formation block 190 of method 110B comprises Step 110B-1 wherein a base structure 101 is formed. In method 110B, base structure formation block 190 is followed by self-aligned feature formation block 194, vertical pillar formation block 196, and cavity formation block 198.

FIG. 9A shows a cross-sectional schematic drawing of a portion of an embodiment of optical interposer structure 104 after formation of interposer base structure 101 as in Step 110B-1.

FIG. 9B shows a cross-sectional schematic drawing of a portion of an embodiment of optical interposer structure 104 after formation of first portion 105ₚₜ₁ of planar waveguide layer 105 as in Step 110B-2, wherein the first portion 105ₚₜ₁ of planar waveguide layer 105 comprises a core layer 105_{core} disposed on bottom cladding layer 105_{bc}. In other embodiments, other configurations for the first portion 105ₚₜ₁ may be used.

FIG. 9C shows a cross-sectional schematic drawing of a portion of an embodiment of optical interposer structure 104 after formation of first patterned mask layer 116_{SA}-1 on first portion 105ₚₜ₁ of planar waveguide layer 105 as in Step 110B-3, wherein the first patterned mask layer 116_{SA}-1 comprises patterns to facilitate formation of alignment pillars 134_{SA} formed self-aligned with fiducials 114_{SA} and patterned planar waveguide cores 144_{SA}.

FIG. 9D shows a cross-sectional schematic drawing of a portion of an embodiment of optical interposer structure 104 after patterning of first portion 105ₚₜ₁ of planar waveguide layer 105 as in Step 110B-4.

FIG. 9E shows a cross-sectional schematic drawing of a portion of an embodiment of optical interposer structure 104 after formation of second patterned mask layer 116-2 and removal of patterned mask layer 116_{SA}-1 from patterned planar waveguide core 144 as in Step 110B-5.

FIG. 9F shows a cross-sectional schematic drawing of a portion of an embodiment of optical interposer structure 104 after removal of second patterned mask layer 116-2 as in Step 110B-5 and formation of second portion 105ₚₜ₂ of planar waveguide layer 105 as in Step 110B-6.

Self-aligned feature formation block 194 of method 110B follows base structure formation block 190 and comprises steps 110B-2 to 110B-6. The steps 110B-2 to 110B-6 in method 110B, as in step 110A, include a sequence of steps for which patterned planar waveguide cores and alignment features are formed from a first portion of a planar waveguide layer 105 using a same patterned mask layer and buried in a second portion of the planar waveguide layer after removal of the patterned mask layer from the patterned planar waveguides. In method 110B, self-aligned feature formation block 194 is followed by vertical pillar formation block 196 and cavity formation block 198.

Following step 110B-6 of method 110B, step 110B-7 of method 110B is a forming step in which a third patterned mask layer 116-3 is formed on the second portion 105ₚₜ₂ of planar waveguide layer 105, wherein the third patterned mask layer 116-3 comprises patterns for the formation of a second group 134b of alignment pillars 134 and wherein the third patterned mask layer 116-3 is formed on a surface having an elevation in the layered film structure of optical interposer structure 104 that differs from that of the patterns used in the first patterned mask layer 116_{SA} to facilitate formation of first group 134_{SA} of alignment pillars 134.

FIGS. 9G-9I show cross-sectional schematic drawings of the formation of cavities 148 that include self-aligned alignment pillars 114_{SA}, 134_{SA} formed in alignment with patterned planar waveguide cores 144_{SA} at a first elevation in the cavity 148 and alignment pillars 134b formed at a second elevation in the cavity in an embodiment of an optical interposer structure 104 having self-aligned alignment aids formed at multiple heights in cavity 148.

FIG. 9G shows a cross-sectional schematic drawing of a portion of an embodiment of optical interposer structure 104 after formation of third patterned mask layer 116-3 on second portion 105ₚₜ₂ of planar waveguide layer 105 as in step 110B-7, wherein the third patterned mask layer 116-3 comprises patterns to facilitate formation of alignment pillars 134b at a height that differs from that of the alignment pillars 134a. The third patterned mask layer 116-3 is shown in FIG. 9G at a higher elevation than the first patterned mask layer 116_{SA}-1. The relative elevation of the bottom of the third patterned mask layer 116-3 within the layered film structure of optical interposer structure 104 with respect to the bottom of first patterned mask layer 116_{SA}-1 is determined by the thickness of the second portion 105ₚₜ₂ of planar waveguide layer 105 between the top of the first alignment pillar 134_{SA} and the top of the second portion 105ₚₜ₂ of the planar waveguide layer 105 and the thicknesses of the patterned mask layers 116_{SA}-1, 116-3. The difference in elevation between the two patterned mask layers, and therefore, the elevations of the top surfaces of the alignment pillars formed using the patterned mask layers can vary over a wide range from hundredths of a micron to tens of microns.

Step 110B-8 of method 110B is a forming step in which a third portion 105ₚₜ₃ of planar waveguide layer 105 is formed on the second portion 105ₚₜ₂ of planar waveguide layer 105 and on third patterned mask layer 116-3. Third portion 105ₚₜ₃ of planar waveguide layer 105 may include one or more of a spacer layer, a buffer layer, and a planarization layer, among other optional layers.

Vertical pillar formation block 196 follows base structure formation block 190 and self-alignment feature formation block 194, and comprises steps 110B-7 and 110B-8. The steps 110B-7 and 110B-8 in method 110B, include a sequence of steps in which a patterned mask layer is formed and buried in a dielectric layer wherein the buried patterned layer comprises patterns to facilitate formation of one or more vertical alignment pillars. In method 110B, the vertical pillar formation block 196 is followed by cavity formation block 198.

FIG. 9H shows a cross-sectional schematic drawing of a portion of an embodiment of optical interposer structure 104 after formation of a third portion 105ₚₜ₃ of planar waveguide layer 105 as in Step 110B-8. The cross-sectional schematic drawing shows the embodiment of optical interposer structure 104 shown in FIG. 9G after formation of the third portion 105ₚₜ₃ of planar waveguide layer 105. Third portion 105ₚₜ₃ of planar waveguide layer 105 may be optionally planarized.

Step 110B-9 of method 110B is a forming step in which a fourth patterned mask layer 116-4 is formed on the third portion 105ₚₜ₃ of planar waveguide layer 105, wherein the fourth patterned mask layer 116-4 comprises patterned portions to facilitate the formation of one or more cavities 148 in planar waveguide layer 105.

FIG. 9I shows a cross-sectional schematic drawing of a portion of an embodiment of optical interposer structure 104 as shown in FIG. 9H after formation of fourth patterned mask layer 116-4. The fourth patterned mask layer 116-4 provided in forming step 110B-9 includes patterned portions to facilitate the formation of cavities 148 in the optical interposer structure 104.

Step 110B-10 of method 110B is a patterning step in which all or a portion of the thickness of planar waveguide layer 105 is patterned to form one or more cavities 148 that intersect at least the core layer 105_{core} of at least a patterned planar waveguide core 144_{SA}, wherein the formation of the one or more cavities 148 includes the formation of one or more of one or more of a first group of alignment pillars 134_{SA} having a top surface at a first elevation in the cavity 148, one or more of a second group 134b of alignment pillars 134 having a top surface at a second elevation in the cavity 148, and one or more fiducials 114_{SA} within at least a cavity SA.

Cavity formation block 198 follows vertical pillar formation block 196 of method 110B and comprises steps 110B-9 and 110B-10. The steps 110B-9 and 110B-10 in method 110A include a sequence of steps for which one or more cavities having alignment features are formed on the optical interposer structure 104.

FIG. 9J shows a cross-sectional schematic drawing of a portion of an embodiment of optical interposer structure 104 after formation of cavity 148 in planar waveguide layer 105 as in Step 110B-10 wherein cavity 148 includes alignment pillars formed at multiple heights within cavity 148. The cross-sectional schematic drawing in FIG. 9J shows the embodiment of optical interposer structure 104 after patterning to form cavity 148 in planar waveguide layer 105.

The first group 134_{SA} of alignment pillars 134, in the embodiment shown in FIG. 9J, may facilitate one or more of lateral alignment and vertical alignment of optical device 120 mounted or otherwise formed on embodiments of optical interposer structure 104. In the embodiments described in the flowchart of FIG. 8, the second group 134b of alignment pillars 134 are not self-aligned with the patterned planar waveguide cores 144 so the lateral resolution of the alignment between the alignment pillars 134 and the patterned planar waveguide cores 144 is limited to the resolution obtainable between the two lithographic patterning steps used in (1) the formation of the second group 134b of alignment pillars and (2) the formation of the patterned planar waveguide cores 144. The embodiment shown in FIG. 9J may facilitate vertical alignment of optical device 120.

FIG. 10 shows a flowchart for method 110C for forming embodiments of an optical interposer structure 104 having alignment pillars 134a,134_{SA} formed at multiple heights in cavity 148 wherein the alignment pillars 134_{SA} at an upper height are formed from a same patterned mask layer 116_{SA} used in the formation of patterned planar waveguide cores 144_{SA}. The steps in method 11C are described in conjunction with FIGS. 11A-11K.

FIGS. 11A-11I show cross-sectional schematic drawings of the formation of an embodiment of an optical interposer structure 104 having alignment aids in a device mounting cavity 148 wherein the alignment aids include alignment pillars 134a, 134_{SA} formed at multiple heights in cavity 148, and wherein the alignment aids 134a formed at an upper height are formed self-aligned using a same patterned mask layer as used in the formation of patterned planar waveguides cores 144.

Step 110C-1 of method 110C is a forming step in which interposer base structure 101 is formed, wherein base structure 101 comprises an optional electrical interconnect layer 103 disposed on a substrate 100.

Base structure formation block 190 of method 110C comprises Step 110C-1 wherein a base structure 101 is formed. In method 110C, base structure formation block 190 is followed by vertical pillar formation block 196, self-aligned feature formation block 194, and cavity formation block 198.

FIG. 11A shows a cross-sectional schematic drawing of a portion of an embodiment of optical interposer structure 104 after formation of interposer base structure 101 as in Step 110C-1.

Step 110C-2 is a forming step in which a first portion 105ₚₜ₁ of planar waveguide layer 105 is formed on base structure 101, wherein the first portion 105ₚₜ₁ of planar waveguide layer 105 comprises one or more of a spacer layer, a buffer layer, a planarization layer, among other layers. The thickness of first portion 105ₚₜ₁ of planar waveguide layer 105, in embodiments, forms the lower elevation in the layered film structure upon which the first patterned mask layer 116-1 is formed. First portion 105ₚₜ₁ of planar waveguide layer 105 may be optionally planarized in step 110C-2.

FIG. 11B shows a cross-sectional schematic drawing of a portion of an embodiment of optical interposer structure 104 after formation of first portion 105ₚₜ₁ of planar waveguide layer 105 as in Step 110C-2.

Step 110C-3 of method 110C is a forming step in which a first patterned mask layer 116-1 is formed on the first portion 105ₚₜ₁ of planar waveguide layer 105 wherein the first patterned mask layer 116-1 comprises patterned portions for the formation of a first group 134a of alignment pillars 134, and wherein the first portion 105ₚₜ₁ of patterned planar waveguide layer 105 comprises at least a spacer layer.

FIG. 11C shows a cross-sectional schematic drawing of a portion of an embodiment of optical interposer structure 104 after formation of first patterned mask layer 116-1 on first portion 105ₚₜ₁ of planar waveguide layer 105 as in Step 110C-3.

Step 110C-4 of method 110C is a forming step in which a second portion 105ₚₜ₂ of planar waveguide layer 105 is formed on the first portion 105ₚₜ₁ and on the first patterned mask layer 116-1 wherein the second portion 105ₚₜ₂ of planar waveguide layer 105 comprises an encapsulation layer, and wherein the second portion 105ₚₜ₂ is optionally planarized.

Vertical pillar formation block 196 follows base structure formation block 190 and comprises steps 110C-2 to 110C-4. The steps 110C-2 to 110C-4 in method 110C, include a sequence of steps in which a patterned mask layer is formed and buried in a dielectric layer wherein the buried patterned layer comprises patterns to facilitate formation of one or more vertical alignment pillars. In method 110C, the vertical pillar formation block 196 is followed by self-aligned feature formation block 194 and cavity formation block 198.

FIG. 11D shows a cross-sectional schematic drawing of a portion of an embodiment of optical interposer structure 104 after formation of a second portion 105ₚₜ₂ of planar waveguide layer 105 as in Step 110C-4.

Step 110C-5 of method 110C is a forming step in which a third portion 105ₚₜ₃ of planar waveguide layer 105 is formed on second portion 105ₚₜ₂, wherein the second portion 105ₚₜ₂ of planar waveguide layer 105 comprises core layer 105_{core} disposed on at least a bottom cladding layer 105_{bc}, and may further comprise an optional top cladding layer 105_{tc} on the core layer 105_{core}. Other layers may be also formed between the bottom cladding layer 105_{bc} the second portion 105ₚₜ₂ of planar waveguide layer 105.

FIG. 11E shows a cross-sectional schematic drawing of a portion of an embodiment of optical interposer structure 104 after formation of third portion 105ₚₜ₃ of planar waveguide layer 105 as in Step 110C-5, wherein the third portion 105ₚₜ₃ of planar waveguide layer 105 comprises a core layer 105_{core} disposed on bottom cladding layer 105_{bc}. In other embodiments, third portion 105ₚₜ₃ may include a top cladding layer as shown, for example, in FIGS. 4A-4D.

Step 110C-6 of method is a forming step in which a second patterned mask layer 116_{SA}-2 is formed on third portion 105ₚₜ₃ of planar waveguide layer 105 wherein the second patterned mask layer 116_{SA}-2 comprises patterned portions for the formation of a second group 134_{SA} of alignment pillars 134. In embodiments described by method 110C, second group 134_{SA} are formed self-aligned with patterned planar waveguide cores 144_{SA} and fiducials 114_{SA}.

FIG. 11F shows a cross-sectional schematic drawing of a portion of an embodiment of optical interposer structure 104 after formation of a second patterned mask layer 116_{SA}-2 on third portion 105ₚₜ₃ of planar waveguide layer 105 as in Step 110C-6, wherein the second patterned mask layer 116_{SA}-2 comprises patterns to facilitate formation of alignment pillars 134_{SA} formed self-aligned with fiducials 114_{SA} and patterned planar waveguide cores 144_{SA}.

Step 110-7 of method 110 is a patterning step in which all or a portion of the thickness of the third portion 105ₚₜ₃ of planar waveguide layer 105 is patterned to form all or a portion of one or more patterned planar waveguide cores 144_{SA}, one or more fiducials 114_{SA}, and one or more of the second group 134_{SA} of alignment pillars.

FIG. 11G shows a cross-sectional schematic drawing of a portion of an embodiment of optical interposer structure 104 after patterning of third portion 105ₚₜ₃ of planar waveguide layer 105 as in Step 110C-7.

Step 110-8 of method 110 is a forming and removing step in which a third patterned mask layer 116-3 is formed on patterned third portion 105ₚₜ₃ of planar waveguide layer 105, the second patterned mask layer 116_{SA}-2 is removed from at least a patterned planar waveguide core 144_{SA}, and the third patterned mask layer 116-3 is removed from the optical interposer structure 104.

FIG. 11H shows a cross-sectional schematic drawing of a portion of an embodiment of optical interposer structure 104 after formation of third patterned mask layer 116-3 and removal of second patterned mask layer 116_{SA}-2 from patterned planar waveguide core 144_{SA} as in Step 110C-8.

Step 110C-9 of method 110C is a forming step in which a fourth portion 105ₚₜ₄ of planar waveguide layer 105 is formed on the third portion 105ₚₜ₃ of the patterned planar waveguide cores 144_{SA}, on the fiducials 114_{SA}, and on the second group 134_{SA} of alignment pillars 134 having the remaining second patterned mask layer 116_{SA}-2, wherein the fourth portion 105ₚₜ₄ of planar waveguide layer 105 may include one or more of a top and side cladding layer, a spacer layer, and a planarization layer, among other optional layers. The fourth portion 105ₚₜ₄ of planar waveguide layer 105 may be optionally planarized in step 110C-9 of method 110C.

Self-aligned feature formation block 194 in method 110C follows base structure formation block 190 and vertical pillar formation block 196, and comprises steps 110C-5 to 110C-9. The steps 110C-5 to 110C-9 in method 110C include a sequence of steps in which patterned planar waveguide cores and alignment features are formed from a first portion of a planar waveguide layer 105 using a same patterned mask layer and buried in a second portion of the planar waveguide layer after removal of the patterned mask layer from the patterned planar waveguides. In method 110C, self-aligned feature formation block 194 is followed by cavity formation block 198.

FIG. 11I shows a cross-sectional schematic drawing of a portion of an embodiment of optical interposer structure 104 after removal of third patterned mask layer 116-3 as in Step 110C-8 and formation of fourth portion 105ₚₜ₄ of planar waveguide layer 105 as in Step 110C-9.

Step 110C-10 of method 110C is a forming step in which a fourth patterned mask layer 116-4 is formed on the fourth portion 105ₚₜ₄ of planar waveguide layer 105.

FIG. 11J shows a cross-sectional schematic drawing of a portion of an embodiment of optical interposer structure 104 after formation of a fourth patterned mask layer 116-4 on fourth portion 105ₚₜ₄ of planar waveguide layer 105 as in Step 110C-10, wherein the fourth patterned mask layer 116-4 comprises patterns to facilitate formation of cavity 148 in planar waveguide layer 105.

Step 110C-11 is a patterning step in which all of a portion of planar waveguide layer 105 is patterned to form one or more cavities 148 that intersect at least the core layer 105_{core} of at least a patterned planar waveguide core 144_{SA} wherein the formation of the one or more cavities 148 includes the formation of one or more fiducials 114_{SA} within the cavity 148, one or more of a first group 134a of alignment pillars having a top surface at a first elevation within the cavity 148, and one or more of a second group 134_{SA} of alignment pillars having a top surface at a second elevation within the cavity 148. In some embodiments, fiducials 114_{SA} may be formed form one or more alignment pillars 134_{SA}. And in some embodiments, fiducials 114_{SA} may be formed in a cavity 149 separate from cavity 148.

Cavity formation block 198 follows self-aligned feature formation block 194 of method 110C and comprises steps 110C-10 and 110C-11. The steps 110C-10 and 110C-11 in method 110C include a sequence of steps for which one or more cavities having alignment features are formed on the optical interposer structure 104.

FIG. 11K shows a cross-sectional schematic drawing of a portion of an embodiment of optical interposer structure 104 after formation of cavity 148 in planar waveguide layer 105 as in Step 110C-11 wherein cavity 148 includes alignment pillars 134a,134_{SA} formed at multiple heights, and wherein alignment pillars 134_{SA} are formed self-aligned with patterned planar waveguide cores 144_{SA}.

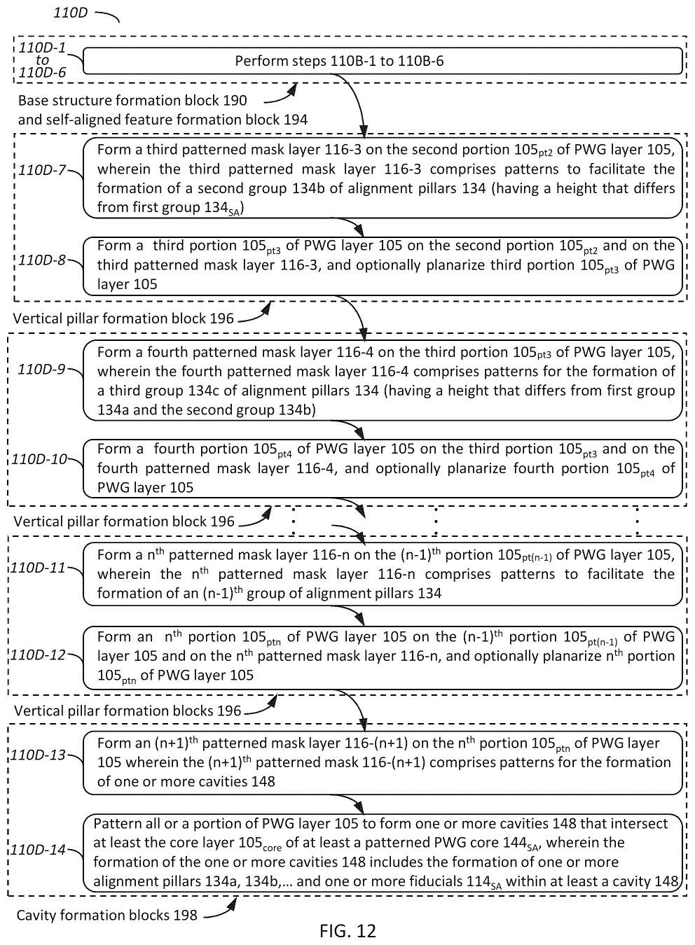

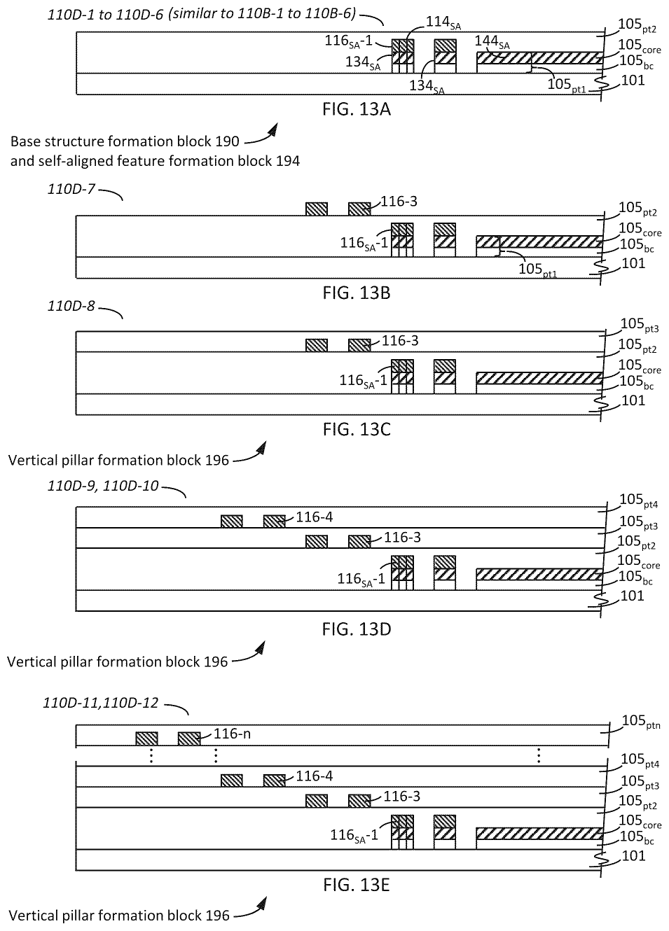

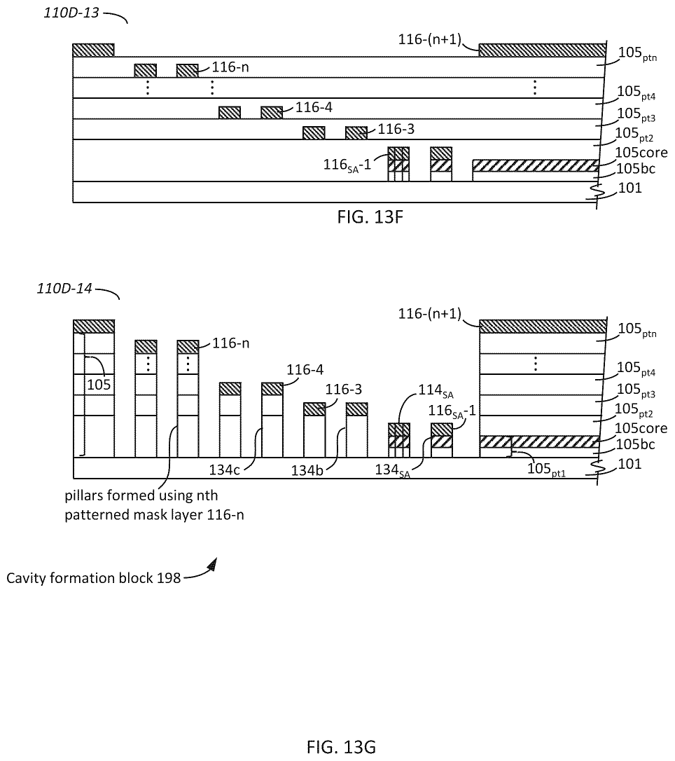

FIG. 12 shows a flowchart for method 110D for forming embodiments of an optical interposer structure 104 having alignment aids formed at multiple heights in cavity 148, wherein the alignment pillars 134_{SA} and fiducials 114_{SA} at a lower height are formed from a same patterned mask layer used in the formation of patterned planar waveguides cores 144_{SA}. Step in method 110D are described in conjunction with FIGS. 13A-13G.

FIGS. 13A-13G show cross-sectional schematic drawings of the formation of an embodiment of an optical interposer structure 104 having alignment aids formed at a plurality of elevations in cavity 148, wherein the alignment aids 134_{SA} formed at a lowest height are formed self-aligned with patterned planar waveguides cores 144_{SA} in the embodiment. The plurality of elevations of the alignment pillars 134 described in method 110D may be three or more. Embodiments having less than three are described herein in methods 110A-110C.

Steps 110D-1 to 110D-6 of method 110D are the same or similar to steps 110B-1 to 110B-6 of method 110B up to and including the formation of the second portion 105ₚₜ₂ of planar waveguide layer 105 for the embodiments formed using method 110B, and as illustrated for these embodiments in FIG. 9F.

Base structure formation block 190 of method 110D comprises Step 110D-1 wherein a base structure 101 is formed. In method 110D, base structure formation block 190 is followed by a self-aligned feature formation block 194, a plurality of vertical pillar formation blocks 196, and cavity formation block 198. Self-aligned feature formation block 194 of method 110D follows base structure formation block 190 and comprises steps 110D-2 to 110D-6. The steps 110D-2 to 110D-6 in method 110D include a sequence of steps for which patterned planar waveguide cores and alignment features are formed from a first portion of a planar waveguide layer using a same patterned mask layer and buried in a second portion of the planar waveguide layer after removal of the patterned mask layer from the patterned planar waveguides. In method 110D, self-aligned feature formation block 194 is followed by a plurality of vertical pillar formation blocks 196 and cavity formation block 198.

FIG. 13A shows a cross-sectional schematic drawing of a portion of an embodiment of optical interposer structure 104 after formation of first portion 105ₚₜ₁ and second portion 105ₚₜ₂ of planar waveguide layer 105 having fiducial 114_{SA} and alignment pillars 134_{SA} formed self-aligned with patterned planar waveguide cores 144_{SA} as in Steps 110D-1 to 110D-6 of method 110D (similar to Steps 110B-1 to 110B-6 of method 110B). Patterned mask layer 116_{SA}-1 has been removed from patterned planar waveguide core 144_{SA} and is shown remaining on alignment pillars 134_{SA} in FIG. 13A. Second mask layer 116-2 has also been formed and removed as in step 110B-5 of method 110B.

Step 110D-7 of method 110D is a forming step in which a third patterned mask layer 116-3 is formed on the second portion 105ₚₜ₂ of planar waveguide layer 105 wherein the third patterned mask layer 116-3 comprises patterns to facilitate the formation of a second group 134b of alignment pillars 134 having a height that differs from that of the first group 134_{SA} of alignment pillars 134.

FIG. 13B shows a cross-sectional schematic drawing of a portion of an embodiment of optical interposer structure 104 after formation of a third patterned mask layer 116-3 on second portion 105ₚₜ₂ of planar waveguide layer 105 as in Step 110D-7, wherein the third patterned mask layer 116-3 comprises patterns to facilitate formation of alignment pillars 134b at a height that differs from that of the alignment pillars 134_{SA}.

Step 110D-8 of method 110D is a forming step in which a third portion 105ₚₜ₃ of planar waveguide layer 105 is formed on the second portion 105ₚₜ₂ and on the third patterned mask layer 116-3 and optionally planarized.

Vertical pillar formation block 196 follows base structure formation block 190 and self-alignment feature formation block 194, and comprises steps 110D-7 and 110D-8. The steps 110D-7 and 110D-8 in method 110D include a sequence of steps in which a patterned mask layer is formed and buried in a dielectric layer wherein the buried patterned layer comprises patterns to facilitate formation of one or more vertical alignment pillars. In method 110D, the vertical pillar formation block 196 is followed by one or more vertical pillar formation blocks 196 and cavity formation block 198.

FIG. 13C shows a cross-sectional schematic drawing of a portion of an embodiment of optical interposer structure 104 after formation of a third portion 105ₚₜ₃ of planar waveguide layer 105 as in Step 110D-8.

Step 110D-9 of method 110D is a forming step in which a fourth patterned mask layer 116-4 is formed on the third portion 105ₚₜ₃ of planar waveguide layer 105 wherein the fourth patterned mask layer 116-4 comprises patterns to facilitate the formation of a third group 134c of alignment pillars 134 having a height that differs from first group 134_{SA} and second group 134b of alignment pillars 134.

Step 110D-10 of method 110D is a forming step in which a fourth portion 105ₚₜ₄ of planar waveguide layer 105 is formed on third portion 105ₚₜ₃ and on the fourth patterned mask layer 116-4, and optionally planarized.

Vertical pillar formation block 196 follows base structure formation block 190, self-alignment formation block 194, and prior vertical pillar formation block 196, and comprises steps 110D-9 and 110D-10. The steps 110D-9 and 110D-10 in method 110D include a sequence of steps in which a patterned mask layer is formed and buried in a dielectric layer wherein the buried patterned layer comprises patterns to facilitate formation of one or more vertical alignment pillars. In method 110D, the vertical pillar formation block 196 is followed by one or more vertical pillar formation blocks 196 and cavity formation block 198.

FIG. 13D shows a cross-sectional schematic drawing of a portion of an embodiment of optical interposer structure 104 after formation of a fourth patterned mask layer 116-4 on third portion 105ₚₜ₃ of planar waveguide layer 105 as in Step 110D-9, and after formation of a fourth portion 105ₚₜ₄ of planar waveguide layer 105 as in Step 110D-10, wherein the fourth patterned mask layer 116-4 comprises patterns to facilitate formation of alignment pillars 134c at a height that differs from that of the alignment pillars 134_{SA} and alignment pillars 134b.

Step 110D-11 of method 110D is a forming step in which an nth patterned mask layer 116-n is formed on the (n−1)^{th} portion 105ₚₜ₍ₙ₋₁₎ of planar waveguide layer 105 wherein the nth patterned mask layer comprises patterns to facilitate the formation of an (n−1)^{th} group of alignment pillars 134, and wherein ‘n’ is the quantity of patterned mask layers used in formation of the plurality of alignment pillars formed in cavity 148. The heights of the alignment pillars in the (n−1) groups of alignment pillars 134 differ in height from groups of alignment pillars formed prior in method 110D.

Step 110D-12 of method 110D is a forming step in which an nth portion 105ₚₜₙ of planar waveguide layer 105 is formed on the (n−1)^{th} portion 105ₚₜ₍ₙ₋₁₎ of planar waveguide layer 105 and on the nth patterned mask layer 116-n and optionally planarized.

Vertical pillar formation block 196 follows base structure formation block 190, self-alignment formation block 194, and prior vertical pillar formation block 196, and comprises steps 110D-11 and 110D-12. The steps 110D-11 and 110D-12 in method 110D include a sequence of steps in which a patterned mask layer is formed and buried in a dielectric layer wherein the buried patterned layer comprises patterns to facilitate formation of one or more vertical alignment pillars. In method 110D, the vertical pillar formation block 196 is optionally followed by one or more vertical pillar formation blocks 196 and cavity formation block 198.

FIG. 13E shows a cross-sectional schematic drawing of a portion of an embodiment of optical interposer structure 104 after formation of an nth patterned mask layer 116-n on an (n−1)^{th} portion 105ₚₜ₍ₙ₋₁₎ of planar waveguide layer 105 as in Step 110D-11, and after formation of an nth portion 105ₚₜₙ of planar waveguide layer 105 as in Step 110D-12.

Steps 110D7-110D-10 of method 110D provide a method of forming embodiments having alignment pillars 134 at three or more elevations in cavity 148. For embodiments configured having alignment pillars 134 at three elevations in cavity 148, steps 110D-11 and 110D-12 may be eliminated form method 110D. Embodiments having alignment pillars 134 at two elevations in cavity are described in methods 110B and 110C. Embodiments having alignment pillars 134 formed at more than three elevations may be formed using method 110D by the repeating of steps similar to steps 110D-9 and 110D-10, for example. The repeating formation of a patterned mask layer 116 having patterned portions for the formation of a corresponding group of alignment pillars 134, and the subsequent formation of an encapsulation layer over the encapsulation layer enables for alignment pillars to be formed at a multiplicity of elevations in cavity 148. Having alignment pillars formed at a multiplicity of elevations in cavity 148 enables complementary devices 120 having a plurality of bearing surfaces to be mounted on the corresponding bearing surfaces of the alignment pillars formed at the multiplicity of elevations.

Also, having alignment pillars formed at a multiplicity of elevations further enables the mounting of a plurality of devices requiring differing pillar height elevations within a cavity 148.

Steps 110D-13 and 110D-14 facilitate formation of cavity 148.

Step 110D-13 of method 110D is a forming step in which an (n+1)^{th} patterned mask layer 116-(n+1) is formed on the nth portion 105ₚₜₙ of planar waveguide layer 105 wherein the (n+1)^{th} patterned mask layer 116-(n+1) comprises patterned to facilitate formation of one or more cavities 148 in planar waveguide layer 105.

FIG. 13F shows a cross-sectional schematic drawing of a portion of an embodiment of optical interposer structure 104 after formation of an (n+1)^{th} patterned mask layer 116-(n+1) on nth portion 105ₚₜₙ of planar waveguide layer 105 as in Step 110D-13, wherein the (n+1)^{th} patterned mask layer 116-(n+1) comprises patterns to facilitate formation of cavity 148 in planar waveguide layer 105.

Step 110D-14 of method 110D is a patterning step in which all or a portion of planar waveguide layer 105 is patterned to form one or more cavities 148 that intersect at least the core layer 105_{core} of at least a patterned planar waveguide core 144_{SA}, wherein the formation of the one or more cavities 148 includes the formation of one or more alignment pillars 134a, 134b, 134c, . . .

Cavity formation block 198 follows two or more vertical pillar formation blocks 196 of method 110D and comprises steps 110D-13 and 110D-14. The steps 110D-13 and 110D-14 in method 110D include a sequence of steps for which one or more cavities having alignment features are formed on the optical interposer structure 104.

FIG. 13G shows a cross-sectional schematic drawing of a portion of an embodiment of optical interposer structure 104 after formation of cavity 148 in planar waveguide layer 105 as in Step 110D-14 wherein cavity 148 includes alignment pillars formed at a plurality of heights.

Step 110C-11 is a patterning step in which all of a portion of planar waveguide layer 105 is patterned to form one or more cavities 148 that intersect at least the core layer 105_{core} of at least a patterned planar waveguide core 144_{SA} wherein the formation of the one or more cavities 148 includes the formation of one or more fiducials 114_{SA} within the cavity 148, one or more of a first group 134_{SA} of alignment pillars having a top surface at a first elevation within the cavity 148, one or more of a second group 134b of alignment pillars having a top surface at a second elevation within the cavity 148, one or more of a third group 134c of alignment pillars having a top surface at a third elevation within the cavity 148, . . . , and one or more of an (n−1)^{th} group of alignment pillars having a top surface at an (n−1)^{th} elevation within the cavity 148, where “n” is the quantity of patterned mask layers used in the formation of the plurality of alignment pillar heights in cavity 148. In some embodiments, fiducials 114_{SA} may be formed form one or more alignment pillars 134_{SA}. And in some embodiments, fiducials 114_{SA} may be formed in a cavity 149 separate from cavity 148.

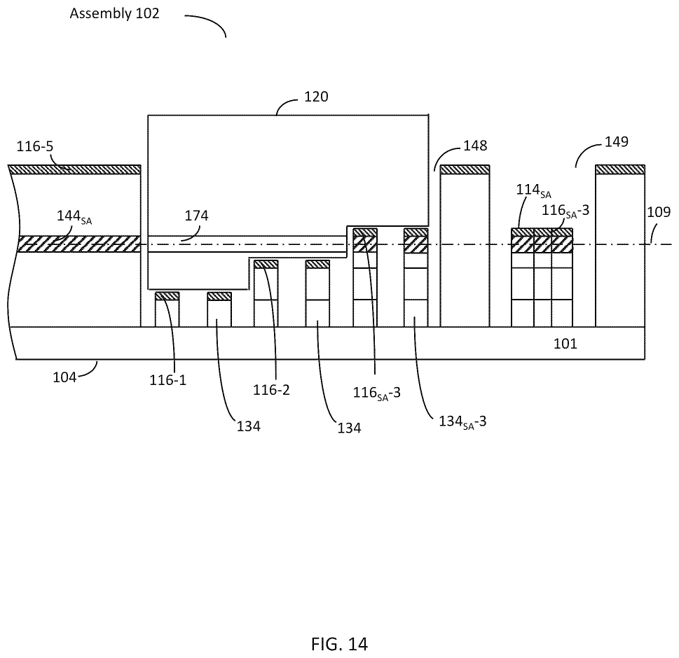

FIG. 14 shows an assembly 102 comprising a portion of an embodiment of optical interposer structure 104 having alignment aids 134_{SA}-3 formed self-aligned with patterned planar waveguide cores 144_{SA} in cavity 148. For clarity, the fiducial is shown formed in cavity 149 separated from cavity 148 having the alignment pillars 134. Assembly 102 further comprises optical device 120 mounted on alignment pillars 134 formed at a multiplicity of elevations in cavity 148. Optical device 120 is shown supported by alignment pillars bearing on the top surfaces of the alignment pillars at differing elevations for the configuration of optical device 120 shown having bearing surfaces at correspondingly differing elevations.

The optical axis of optical device 120 is shown in alignment with the optical axis of the patterned planar waveguide core 144_{SA} of the optical interposer structure 104 to form common axis 109 for the assembly 102. The optical axis of optical device 120 is shown in an active layer 174 of optical device 120. Four patterned mask layers are shown in FIG. 14 that include the first patterned mask layer 116-1 for the alignment pillars formed at a first elevation in cavity 148, the second patterned mask layer 116-2 for the alignment pillars formed at a second elevation in cavity 148, the third patterned mask 116_{SA}-3 for the alignment pillars formed at a third elevation in cavity 148, and the fifth patterned mask layer 116-5 for the formation of the cavity 148. A fourth patterned mask layer 116-4, as described in method 110D to facilitate the removal of the patterned mask layer 116_{SA}-3 from the patterned planar waveguide cores 144_{SA} of the portion of the planar waveguide layer 105 having the core layer 105_{core}, is not shown.

The optical device 120 is shown in contact with the three patterned mask layers at the top of each of the alignment pillars to provide the alignment of the optical axis of the mounted device with the optical axis of the patterned planar waveguide cores 144_{SA}.

The embodiment shown in FIG. 14 further illustrates the formation of alignment pillars at one or more heights for the purpose of providing alignment aids for mounted optical devices and how the formation of alignment pillars 134 at multiple heights in cavity 148 can be utilized in support of an optical device 120. The alignment of the optical axes for the mounted device and the patterned planar waveguide cores 144_{SA} is also shown.

In the embodiment shown in FIG. 14, a single optical device 120 is shown supported by the alignment pillars formed at multiple elevations within the cavity 148. In other embodiments, the alignment pillars formed at multiple heights may be utilized to provide alignment of multiple mounted devices 120.

In other embodiments, less than two pillars may be formed at each elevation in cavity 148. And in other embodiments, more than two pillars may be formed. In some embodiments, one alignment pillar may be formed at one or more elevation and more than one alignment pillar may be formed at one or more other elevations.

In yet other embodiments, the self-alignment layer having self-aligned fiducials 114_{SA}, alignment pillars 134_{SA}, and patterned planar waveguide cores 144_{SA} may be formed at another elevation within the layered structure of optical interposer structure 104 using patterned mask layer 116-1, for example, for an embodiment having the self-alignment layer formed using the first patterned mask layer 116-1. Other patterned mask layers may also be used to form the self-alignment layer in conjunction with other steps used in the formation of the self-aligned features described herein.

Although not shown in the embodiment in FIG. 14, the mounting of optical device 120 may further include electrical interconnections at one or more of the base of the cavity with electrical interconnect layer 103 of base structure 101 and with a second electrical interconnect layer 103-2 formed above the planar waveguide layer 105 as described, for example, in FIGS. 3E and 4E.

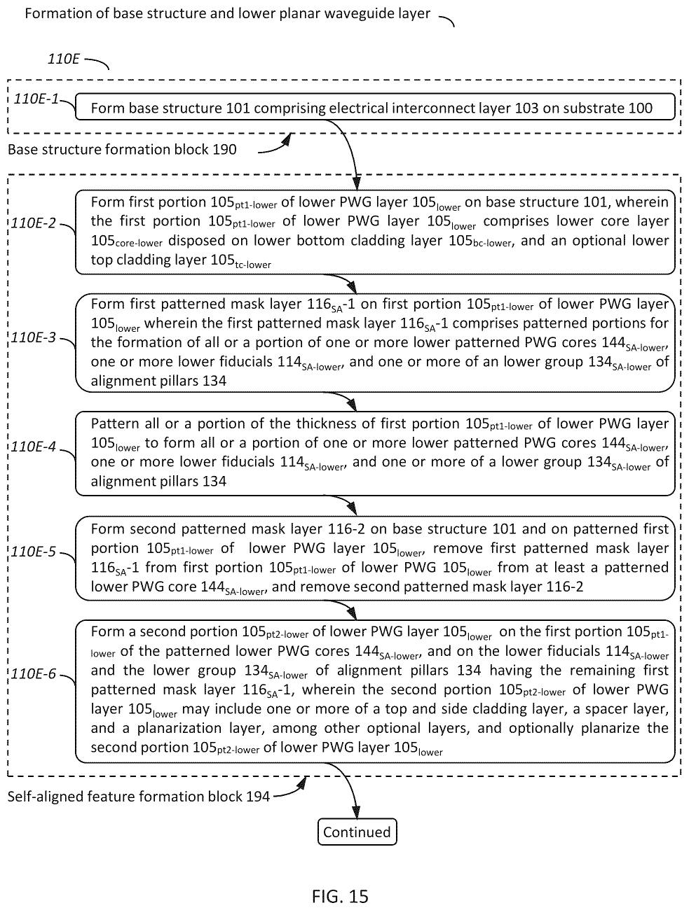

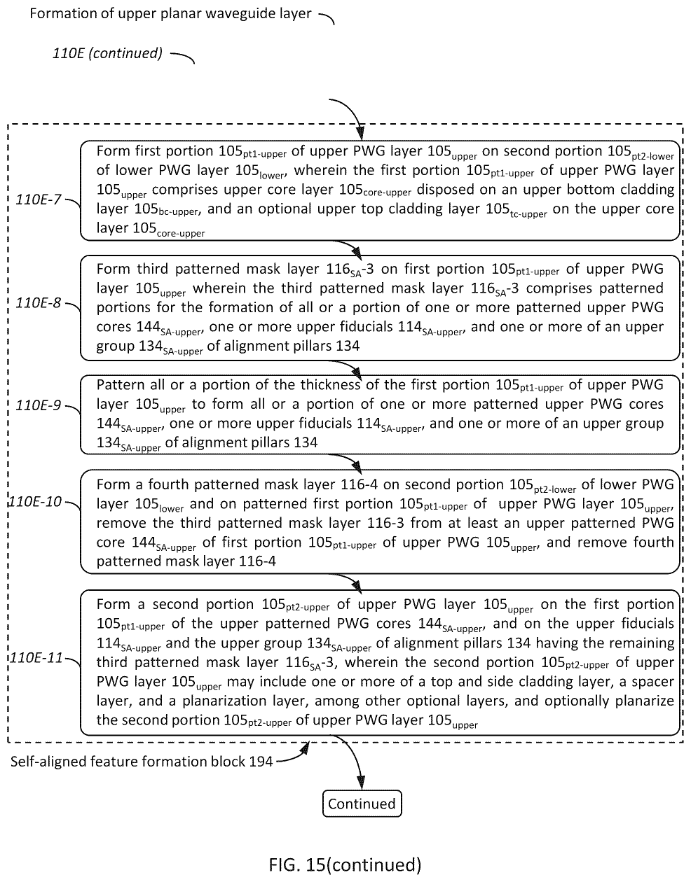

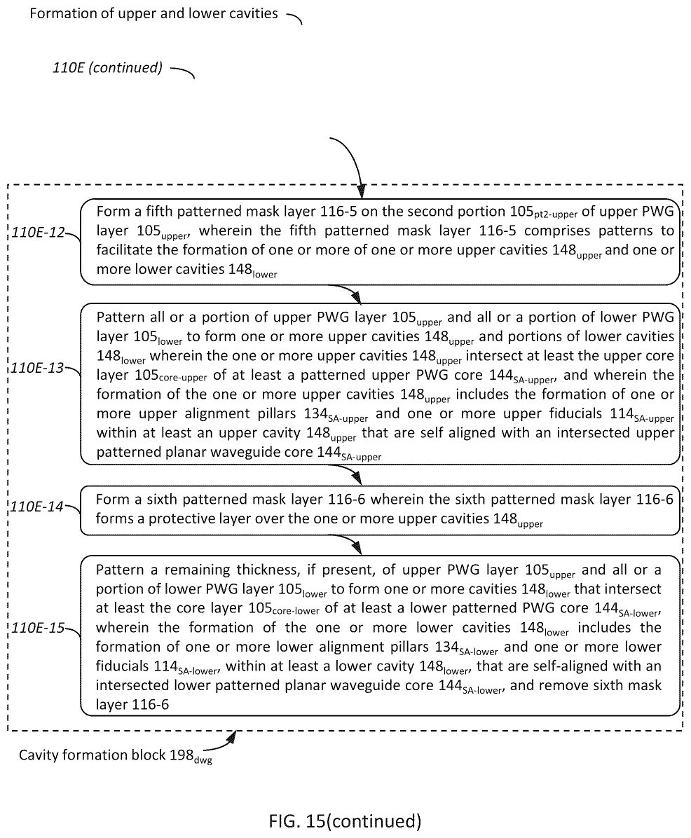

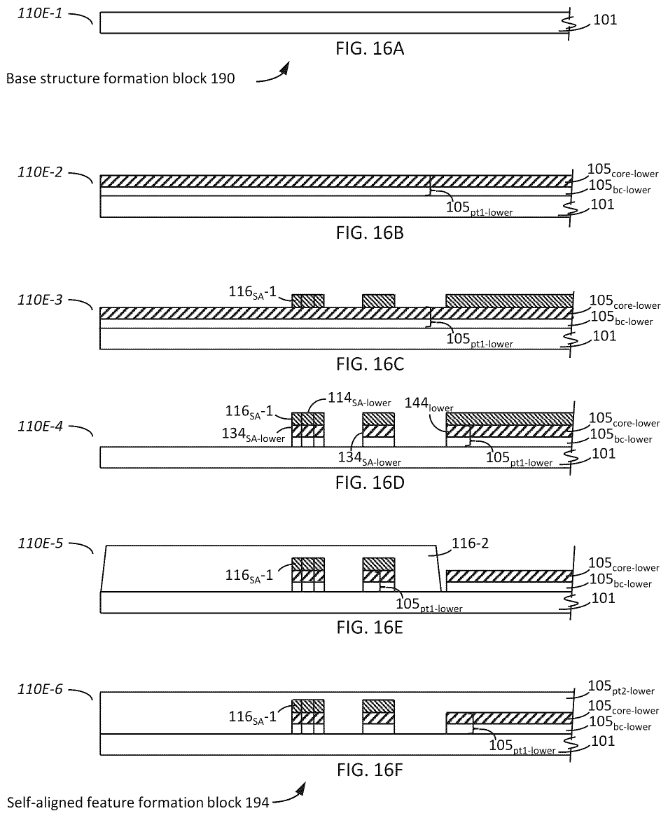

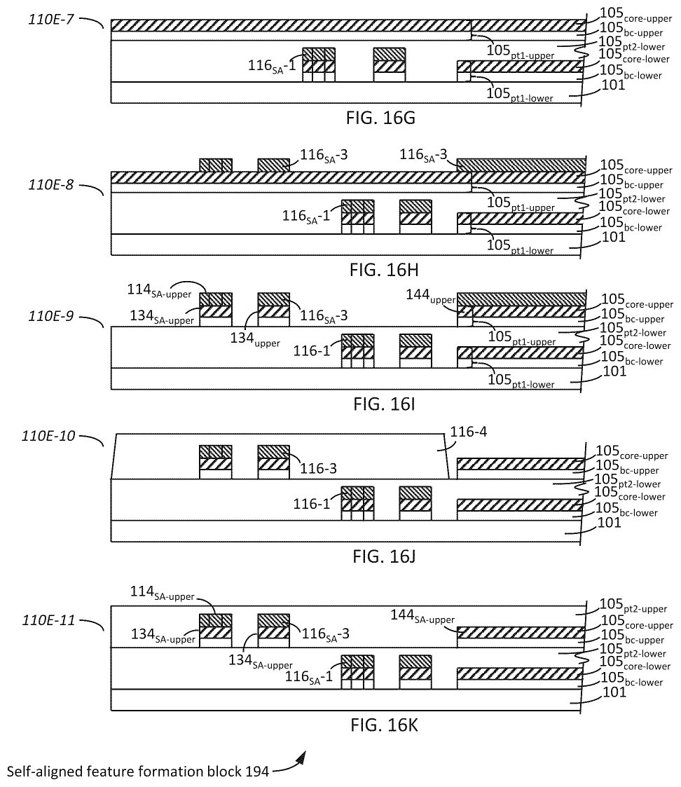

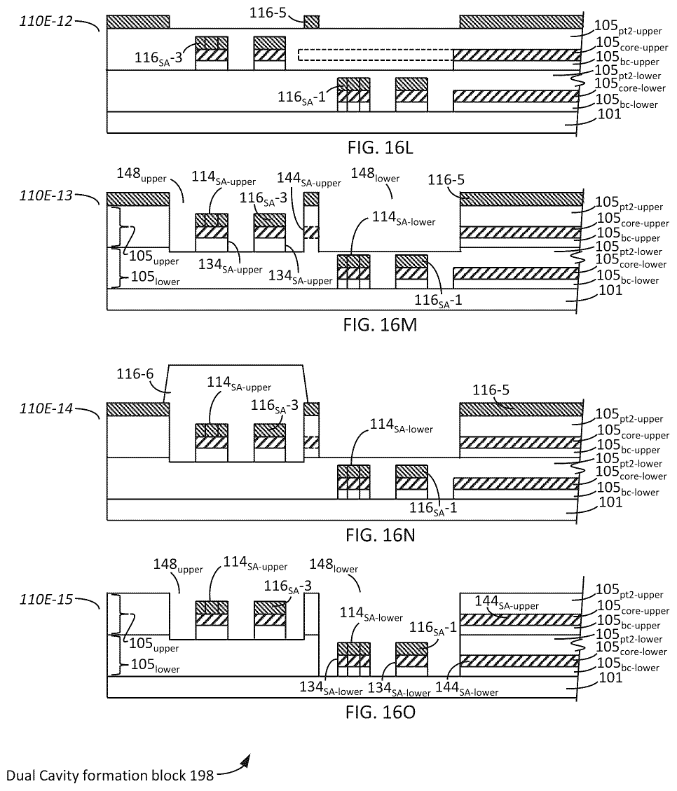

FIG. 15 shows a flowchart for method 110E for forming embodiments of an optical interposer structure 104 having a dual waveguide structure comprising an upper planar waveguide layer 105ᵤₚₚₑᵣ and a lower planar waveguide layer 105_{lower}, and wherein alignment aids 134_{SA-lower} formed at a lower elevation in a first cavity 148_{lower} are formed self-aligned to lower patterned planar waveguides cores 144_{SA-lower} of the lower planar waveguide layer 105_{lower}, and alignment aids 134_{SA-upper} formed at an upper elevation in a second cavity 148ᵤₚₚₑᵣ are formed self-aligned to upper patterned planar waveguides cores 144_{SA-upper} of the upper planar waveguide layer 105ᵤₚₚₑᵣ. Steps in method 110E are described in conjunction with the cross-sectional schematic drawings in FIGS. 16A-16O.

FIGS. 16A-16O show cross-sectional schematic drawings of the formation of an embodiment of an optical interposer structure 104 having a dual waveguide structure wherein self-aligned alignment aids 134_{SA-lower} are formed in a first lower cavity 148_{lower} self-aligned with a first lower patterned planar waveguide core 144_{SA-lower} and self-aligned alignment aids 134_{SA-upper} are formed in a second upper cavity 148ᵤₚₚₑᵣ self-aligned with a second upper patterned planar waveguide core 144_{SA-upper}.

FIGS. 16A-16F show cross-sectional schematic drawings of the formation of a lower planar waveguide layer 105_{lower} and the formation of patterned planar waveguide cores 144_{SA-lower} and associated self-aligned alignment pillars 134_{SA-lower} and fiducials 114_{SA-lower} of a dual waveguide structure in an embodiment of optical interposer structure 104.

Step 110E-1 of method 110E is a forming step in which interposer base structure 101 is formed, wherein base structure 101 comprises an optional electrical interconnect layer 103 disposed on a substrate 100.

Base structure formation block 190 of method 110E comprises Step 110E-1 wherein a base structure 101 is formed. In method 110E, base structure formation block 190 is followed by a lower self-aligned feature formation block 194, an upper self-aligned feature formation block 194, and cavity formation block 198_{dwg}.

FIG. 16A shows a cross-sectional schematic drawing of a portion of an embodiment of optical interposer structure 104 after formation of interposer base structure 101 as in Step 110E-1.

Steps 110E-2 to 110E-6 of method 110E pertain to the formation of a lower patterned planar waveguide layer 144_{lower} and associated self-aligned alignment pillars 134_{SA-lower} and fiducials 114_{SA-lower} of a dual waveguide structure in an embodiment of optical interposer structure 104, and are described in conjunction with FIGS. 16B-16F.

Step 110E-2 of method 110E is a forming step in which a first portion 105_{pt1-lower} of planar waveguide layer 105 is formed on base structure 101, wherein the first portion 105_{pt1-lower} of planar waveguide layer 105 comprises lower core layer 105_{core-lower} disposed on lower bottom cladding layer 105_{be-lower} and an optional lower top cladding layer 105_{tc-lower} disposed on lower core layer 105_{core}-lower.

FIG. 16B shows a cross-sectional schematic drawing of a portion of an embodiment of optical interposer structure 104 after formation of first portion 105_{pt1-lower} of lower planar waveguide layer 105_{lower} as in Step 110E-2, wherein the first portion 105_{pt1-lower} of planar waveguide layer 105_{lower} comprises a core layer 105 core-lower disposed on bottom cladding layer 105_{bc-lower}. In other embodiments, other configurations of 105_{pt1-lower} of planar waveguide layer 105_{lower} may be used as described, for example, in FIGS. 3A-3D and FIGS. 4A-4D. In some embodiments, for example, a top cladding layer may be included in first portion 105_{pt1-lower} of planar waveguide layer 105_{lower}.

Step 110E-3 of method 110E is a forming step in which a first patterned mask layer 116_{SA}-1 is formed on first portion 105_{pt1-lower} of lower planar waveguide layer 105_{lower} wherein the first patterned mask layer 116_{SA}-1 comprises patterned portions to facilitate formation of all or a portion of one or more lower patterned planar waveguide cores 144_{SA-lower}, one or more lower fiducials 114_{SA-lower}, and one or more of a lower group 134_{SA-lower} of alignment pillars 134.

FIG. 16C shows a cross-sectional schematic drawing of a portion of an embodiment of optical interposer structure 104 after formation of first patterned mask layer 116_{SA}-1 on first portion 105_{pt1-lower} of planar waveguide layer 105_{lower} as in Step 110E-3, wherein the first patterned mask layer 116_{SA}-1 comprises patterns to facilitate formation of alignment pillars 134_{SA-lower} and fiducials 114_{SA-lower} in self-alignment with lower patterned planar waveguide cores 144_{SA-lower}.

Step 110E-4 of method 110E is a patterning step in which all or a portion of the thickness of the first portion 105_{pt1-lower} of planar waveguide layer 105_{lower} is patterned to form all or a portion of one or more lower patterned planar waveguide cores 144_{SA-lower}, one or more fiducials 114_{SA-lower}, and one or more of a lower group 134_{SA-lower} of alignment pillars 134.

FIG. 16D shows a cross-sectional schematic drawing of a portion of an embodiment of optical interposer structure 104 after patterning of first portion 105_{pt1-lower} of planar waveguide layer 105_{lower} as in Step 110E-4. In the embodiment, the patterning of first portion 105_{pt1-lower} of lower planar waveguide layer 105_{lower} includes the patterning of all of the lower core layer 105_{core-lower} and all of the lower bottom cladding layer 105_{bc-lower}. In other embodiments, patterning of the first portion 105_{pt1-lower} of planar waveguide layer 105_{lower} may be limited to all or a portion of lower core layer 105_{core-lower} as described herein for embodiments in conjunction with FIGS. 3A-3D and FIGS. 4A-4D. In yet other embodiments, patterning of the first portion 105_{pt1-lower} of planar waveguide layer 105_{lower} may include all of the lower core layer 105_{core-lower} and a portion of the lower bottom cladding layer 105_{bc-lower}.

Step 110E-5 of method 110E is a forming and removing step in which a second patterned mask layer 116-2 is formed on base structure 101 and on patterned first portion 105_{pt1-lower} of lower PWG layer 105_{lower}, in which the first patterned mask layer 116_{SA}-1 is removed from first portion 105_{pt1-lower} of lower PWG 105_{lower} from at least a patterned lower PWG core 144_{SA-lower}, and in which the second patterned mask layer 116-2 is removed from optical interposer structure 104.

FIG. 16E shows a cross-sectional schematic drawing of a portion of an embodiment of optical interposer structure 104 after formation of second patterned mask layer 116-2 and removal of patterned mask layer 116_{SA}-1 from patterned planar waveguide core 144_{SA-lower} as in Step 110E-5.

Step 110E-6 of method 110E is a forming step in which a second portion 105_{pt2-lower} of lower PWG layer 105_{lower} is formed on the first portion 105_{pt1-lower} of the lower patterned PWG cores 144_{SA-lower}, and on the lower fiducials 114_{SA-lower} and the lower group 134_{SA-lower} of alignment pillars 134 having the remaining first patterned mask layer 116_{SA}-1, wherein the second portion 105_{pt2-lower} of lower PWG layer 105_{lower} may include one or more of a top and side cladding layer, a spacer layer, and a planarization layer, among other optional layers, and in which the second portion 105_{pt2-lower} of lower PWG layer 105_{lower} is optionally planarized.

Lower self-aligned feature formation block 194 in method 110E follows base structure formation block 190 and comprises steps 110E-2 to 110E-6. The steps 110E-2 to 110E-6 in method 110E include a sequence of steps in which patterned planar waveguide cores and alignment features are formed from a first portion of a planar waveguide layer 105 using a same patterned mask layer and buried in a second portion of the planar waveguide layer after removal of the patterned mask layer from the patterned planar waveguides. In method 110E, lower self-aligned feature formation block 194 is followed by cavity formation block 198_{dwg}.

FIG. 16F shows a cross-sectional schematic drawing of a portion of an embodiment of optical interposer structure 104 after removal of second patterned mask layer 116-2 as in Step 110E-5 and formation of second portion 105_{pt2-lower} of planar waveguide layer 105_{lower} as in Step 110E-6. FIG. 16K further shows lower alignment pillars 134_{SA-lower}, lower fiducial 114_{SA-lower}, and lower patterned planar waveguide cores 144_{SA-lower} encapsulated in lower planar waveguide layer 105_{lower} of the dual waveguide structure.

Steps 110E-7 to 110E-11 of method 110E pertain to the formation of an upper patterned planar waveguide layer 144_{SA-upper} and associated self-aligned alignment pillars 134_{SA-upper} and fiducials 114_{SA-upper} of a dual waveguide structure in an embodiment of optical interposer structure 104. Steps 110E-7 to 110E-11 of method 110E are described in conjunction with FIGS. 16G-16K.

FIGS. 16G-16K show cross-sectional schematic drawings of the formation of an upper planar waveguide layer 105ᵤₚₚₑᵣ and the formation of patterned planar waveguide cores 144_{SA-upper} and associated self-aligned alignment pillars 134_{SA-upper} and fiducials 114_{SA-upper} of a dual waveguide structure in an embodiment of optical interposer structure 104.

Step 110E-7 of method 110E is a forming step in which a first portion 105ₚₜ₁₋ᵤₚₚₑᵣ of upper PWG layer 105 upper is formed on second portion 105_{pt2-lower} of lower PWG layer 105_{lower}, wherein the first portion 105ₚₜ₁₋ᵤₚₚₑᵣ of upper PWG layer 105ᵤₚₚₑᵣ comprises upper core layer 105_{core-upper} disposed on an upper bottom cladding layer 105_{bc-upper} and an optional upper top cladding layer 105_{tc}-upper disposed on the upper core layer 105_{core-upper}.

FIG. 16G shows a cross-sectional schematic drawing of a portion of an embodiment of optical interposer structure 104 after formation of first portion 105ₚₜ₁₋ᵤₚₚₑᵣ of upper planar waveguide layer 105ᵤₚₚₑᵣ as in Step 110E-7, wherein the first portion 105ₚₜ₁₋ᵤₚₚₑᵣ of planar waveguide layer 105ᵤₚₚₑᵣ comprises a core layer 105 core-upper disposed on bottom cladding layer 105_{bc-upper}. In other embodiments, other configurations of 105ₚₜ₁₋ᵤₚₚₑᵣ of planar waveguide layer 105ᵤₚₚₑᵣ may be used as described, for example, in FIGS. 3A-3D and FIGS. 4A-4D. In some embodiments, for example, a top cladding layer may be included in first portion 105ₚₜ₁₋ᵤₚₚₑᵣ of planar waveguide layer 105ᵤₚₚₑᵣ.

Step 110E-8 of method 110E is a forming step in which a third patterned mask layer 116_{SA}-3 on first portion 105ₚₜ₁₋ᵤₚₚₑᵣ of upper PWG layer 105ᵤₚₚₑᵣ wherein the third patterned mask layer 116_{SA}-3 comprises patterned portions for the formation of all or a portion of one or more upper patterned PWG cores 144_{SA-upper}, one or more upper fiducials 114_{SA-upper}, and one or more of an upper group 134_{SA-upper} of alignment pillars 134.

FIG. 16H shows a cross-sectional schematic drawing of a portion of an embodiment of optical interposer structure 104 after formation of a third patterned mask layer 116_{SA}-3 on first portion 105ₚₜ₁₋ᵤₚₚₑᵣ of upper planar waveguide layer 105ᵤₚₚₑᵣ as in Step 110E-8, wherein the third patterned mask layer 116_{SA}-3 comprises patterns to facilitate formation of alignment pillars 134_{SA-upper} and fiducials 114_{SA-upper} in self-alignment with upper patterned planar waveguide cores 144_{SA-upper}.

Step 110E-9 of method 110E is a patterning step in which all or a portion of the thickness of the first portion 105ₚₜ₁₋ᵤₚₚₑᵣ of upper PWG layer 105ᵤₚₚₑᵣ is patterned to form all or a portion of one or more patterned upper PWG cores 144_{SA-upper}, one or more upper fiducials 114_{SA-upper}, and one or more of an upper group 134_{SA-upper} of alignment pillars 134.

FIG. 16I shows a cross-sectional schematic drawing of a portion of an embodiment of optical interposer structure 104 after patterning of first portion 105ₚₜ₁₋ᵤₚₚₑᵣ of upper planar waveguide layer 105ᵤₚₚₑᵣ as in Step 110E-9. In the embodiment, the patterning of first portion 105ₚₜ₁₋ᵤₚₚₑᵣ of upper planar waveguide layer 105 upper includes the patterning of all of the upper core layer 105_{core-upper} and all of the upper bottom cladding layer 105_{bc-upper}. In other embodiments, patterning of the first portion 105ₚₜ₁₋ᵤₚₚₑᵣ of planar waveguide layer 105ᵤₚₚₑᵣ may be limited to all or a portion of upper core layer 105_{core-upper} as described herein for embodiments described in conjunction with FIGS. 3A-3D and FIGS. 4A-4D. In yet other embodiments, patterning of the first portion 105ₚₜ₁₋ᵤₚₚₑᵣ of planar waveguide layer 105ᵤₚₚₑᵣ may include all of the upper core layer 105_{core-upper} and a portion of the upper bottom cladding layer 105_{bc-upper}.

Step 110E-10 of method 110E is a forming and removing step in which a fourth patterned mask layer 116-4 is formed on second portion 105_{pt2-lower} of lower PWG layer 105_{lower} and on patterned first portion 105ₚₜ₁₋ᵤₚₚₑᵣ of upper PWG layer 105ᵤₚₚₑᵣ, in which the third patterned mask layer 116_{SA}-3 is removed from at least an upper patterned PWG core 144_{SA-upper} of first portion 105ₚₜ₁₋ᵤₚₚₑᵣ of upper PWG 105ᵤₚₚₑᵣ, and in which the fourth patterned mask layer 116-4 is removed from the optical interposer structure 104.

FIG. 16J shows a cross-sectional schematic drawing of a portion of an embodiment of optical interposer structure 104 after formation of fourth patterned mask layer 116-4 and removal of third patterned mask layer 116_{SA}-3 from patterned planar waveguide core 144_{SA-upper} as in Step 110E-10.

Step 110E-11 of method 110E is a forming step in which a second portion 105ₚₜ₂₋ᵤₚₚₑᵣ of upper PWG layer 105ᵤₚₚₑᵣ is formed on the first portion 105ₚₜ₁₋ᵤₚₚₑᵣ of the upper patterned PWG cores 144_{SA-upper}, and on the upper fiducials 114_{SA-upper} and the upper group 134_{SA-upper} of alignment pillars 134 having the remaining third patterned mask layer 116_{SA}-3, wherein the second portion 105ₚₜ₂₋ᵤₚₚₑᵣ of upper PWG layer 105ᵤₚₚₑᵣ may include one or more of a top and side cladding layer, a spacer layer, and a planarization layer, among other optional layers, and in which the second portion 105ₚₜ₂₋ᵤₚₚₑᵣ of upper PWG layer 105ᵤₚₚₑᵣ is optionally planarized.

Upper self-aligned feature formation block 194 in method 110E follows lower self-alignment feature formation block 194 and comprises steps 110E-7 to 110E-11. The steps 110E-7 to 110E-11 in method 110E include a sequence of steps in which patterned planar waveguide cores and alignment features are formed from a first portion of a planar waveguide layer using a same patterned mask layer and buried in a second portion of the planar waveguide layer after removal of the patterned mask layer from the patterned planar waveguides. In method 110E, upper self-aligned feature formation block 194 is followed by cavity formation block 198_{dwg}.

FIG. 16K shows a cross-sectional schematic drawing of a portion of an embodiment of optical interposer structure 104 after removal of fourth patterned mask layer 116-4 as in Step 110E-10 and formation of second portion 105ₚₜ₂₋ᵤₚₚₑᵣ of upper planar waveguide layer 105ᵤₚₚₑᵣ as in Step 110E-11. FIG. 16K further shows upper alignment pillars 134_{SA-upper}, upper fiducial 114_{SA-upper}, and upper patterned planar waveguide cores 144_{SA-upper} encapsulated in upper planar waveguide layer 105ᵤₚₚₑᵣ of the dual waveguide structure.

Steps 110E-12 to 110E-15 of method 110E pertain to the formation of an upper cavity 148ᵤₚₚₑᵣ and a lower cavity 148_{lower} in one or more of the upper planar waveguide layer 105ᵤₚₚₑᵣ and lower planar waveguide layer 105_{lower} in an embodiment of optical interposer structure 104 having a dual waveguide structure, and are described in conjunction with FIGS. 16L-16O.

FIGS. 16L-16O show cross-sectional schematic drawings of the formation of an upper cavity 148ᵤₚₚₑᵣ in the upper planar waveguide layer 105ᵤₚₚₑᵣ and a portion of the lower planar waveguide layer 105_{lower} and a lower cavity 148_{lower} in the upper planar waveguide layer 105ᵤₚₚₑᵣ and the lower planar waveguide layer 105_{lower} in an embodiment of optical interposer structure 104 having a dual waveguide structure.

Step 110E-12 of method 110E is a forming step in which a fifth patterned mask layer 116-5 is formed on the second portion 105ₚₜ₂₋ᵤₚₚₑᵣ of upper PWG layer 105ᵤₚₚₑᵣ, wherein the fifth patterned mask layer 116-5 comprises patterns to facilitate the formation of one or more upper cavities 148ᵤₚₚₑᵣ and one or more lower cavities 148_{lower}.

FIG. 16L shows a cross-sectional schematic drawing of a portion of an embodiment of optical interposer structure 104 after formation of a fifth patterned mask layer 116-5 on second portion 105ₚₜ₂₋ᵤₚₚₑᵣ of upper planar waveguide layer 105ᵤₚₚₑᵣ as in Step 110E-12, wherein the fifth patterned mask layer 116-5 comprises patterns to facilitate formation of upper cavity 148ᵤₚₚₑᵣ and a portion of lower cavity 148_{lower} in upper planar waveguide 105ᵤₚₚₑᵣ, and a portion of upper cavity 148ᵤₚₚₑᵣ and a portion of lower cavity 148_{lower} in lower planar waveguide 105_{lower}.

Step 110E-13 of method 110E is a patterning step in which all or a portion of upper PWG layer 105ᵤₚₚₑᵣ and all or a portion of lower PWG layer 105_{lower} are patterned to form one or more upper cavities 148ᵤₚₚₑᵣ and portions of lower cavities 148_{lower} wherein the one or more upper cavities 148ᵤₚₚₑᵣ intersect at least the upper core layer 105_{core-upper} of at least a patterned upper PWG core 144_{SA-upper}, and wherein the formation of the one or more upper cavities 148ᵤₚₚₑᵣ includes the formation of one or more upper alignment pillars 134_{SA-upper} and one or more upper fiducials 114_{SA-upper} within at least an upper cavity 148ᵤₚₚₑᵣ that are self-aligned with an intersected upper patterned planar waveguide core 144_{SA-upper}.

FIG. 16M shows a cross-sectional schematic drawing of a portion of an embodiment of optical interposer structure 104 after formation of upper cavity 148ᵤₚₚₑᵣ in upper planar waveguide layer 105ᵤₚₚₑᵣ and a portion of lower planar waveguide layer 105_{lower} as in Step 110E-13, wherein upper cavity 148ᵤₚₚₑᵣ includes alignment pillars 134_{SA-upper} and fiducial 114_{SA-upper} formed self-aligned with patterned planar waveguide cores 144_{SA-upper}. In the embodiment shown in FIG. 16L, the upper cavity 148ᵤₚₚₑᵣ is shown to extend into a portion of the lower planar waveguide layer 105_{lower}. In other embodiments, the bottom of the upper cavity 148ᵤₚₚₑᵣ may be in the upper planar waveguide layer 105ᵤₚₚₑᵣ. And in other embodiments the bottom of the upper cavity 148ᵤₚₚₑᵣ may coincide with the bottom of the upper planar waveguide layer 105ᵤₚₚₑᵣ. In embodiments, the bottom of upper cavity 148ᵤₚₚₑᵣ having the alignment pillars 134_{SA-upper} may be formed at any depth below the top surface of the third patterned mask layer 116_{SA}-3 of alignment pillar 134_{SA-upper} and the bottom of the lower planar waveguide layer 105_{lower}. And in some embodiment, the bottom of the upper cavity 148ᵤₚₚₑᵣ may extend into the base structure 101.

Step 110E-14 of method 110E is a forming step in which a sixth patterned mask layer 116-6 is formed wherein the sixth patterned mask layer 116-6 forms a protective layer over the one or more upper cavities 148ᵤₚₚₑᵣ.

FIG. 16N shows a cross-sectional schematic drawing of a portion of an embodiment of optical interposer structure 104 after formation of a sixth patterned mask layer 116-6 as in Step 110E-14, wherein the sixth patterned mask layer comprises patterns to form a protective layer within and over the upper cavity 148ᵤₚₚₑᵣ.

Step 110E-15 of method 110E is a patterning step in which a remaining portion, if present of upper PWG layer 105ᵤₚₚₑᵣ, all or a portion of lower PWG layer 105_{lower}, and optionally a portion of base structure 101 is patterned to form one or more cavities 148_{lower} that intersect at least the core layer 105_{core-lower} of at least a lower patterned PWG core 144_{SA-lower}, wherein the formation of the one or more lower cavities 148_{lower} includes the formation of one or more lower alignment pillars 134_{SA-lower} and one or more lower fiducials 114_{SA-lower}, within at least a lower cavity 148_{lower}, that are self-aligned with an intersected lower patterned planar waveguide core 144_{SA-lower}, and remove sixth mask layer 116-6.

Cavity formation block 198_{dwg} follows upper self-aligned feature formation block 194 of method 110E and comprises steps 110E-12 and 110E-15. The steps 110E-12 and 110E-15 in method 110E include a sequence of steps for which one or more cavities having alignment features are formed on the optical interposer structure 104.

FIG. 16O shows a cross-sectional schematic drawing of a portion of an embodiment of optical interposer structure 104 after formation of lower cavity 148_{lower} in lower planar waveguide layer 105_{lower} as in Step 110E-15 wherein lower cavity 148_{lower} includes alignment pillars 134_{SA-lower} and fiducial 114_{SA-lower} formed self-aligned with patterned planar waveguide cores 144_{SA-lower}.

In the embodiment shown in FIG. 16O, the bottom of the lower cavity 148_{lower} is shown to coincide with the bottom of lower planar waveguide layer 105_{lower}. In other embodiments, the bottom of the lower cavity 148_{lower} may be formed within the lower planar waveguide layer 105_{lower}. And in other embodiments the bottom of the lower cavity 148_{lower} may extend into the interposer base structure 101. In embodiments, the bottom of lower cavity 148_{lower} having the alignment pillars 134_{SA-lower} may be formed at any depth below the top surface of the first patterned mask layer 116_{SA}-1 of alignment pillar 134_{SA-lower} and the bottom of the lower planar waveguide layer 105_{lower}. And in some embodiment, the bottom of the lower cavity 148_{lower} may extend into the interposer base structure 101.

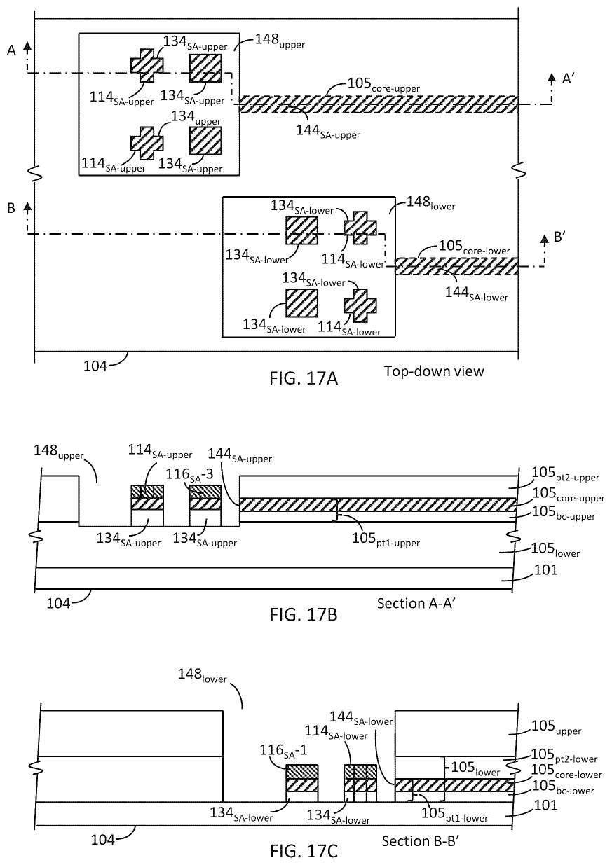

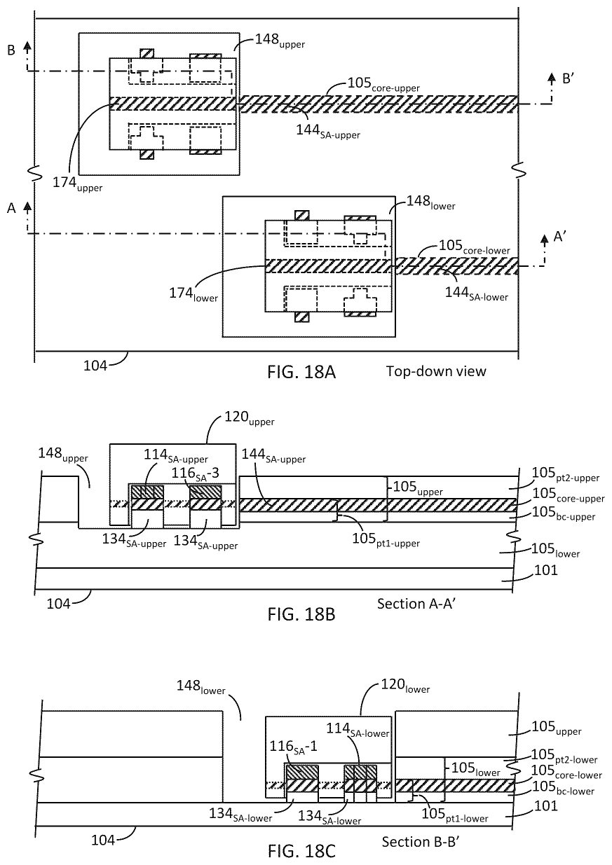

FIGS. 17A-17C and FIGS. 18A-18C show top-down and cross-sectional schematic drawings of an embodiment of optical interposer structure 104 configured having a dual waveguide structure, wherein the alignment pillars and fiducials are formed in self-alignment with patterned planar waveguide cores at multiple elevations.

FIG. 17A shows a top-down schematic drawing of an embodiment of an optical interposer structure 104 having a dual waveguide structure. Upper cavity 148ᵤₚₚₑᵣ and lower cavity 148_{lower} are each shown having alignment pillars 134_{SA-upper} and alignment pillars 134_{SA-lower}, respectively that are formed self-aligned with upper patterned planar waveguides 144_{SA-upper} and lower patterned planar waveguides 144_{SA-lower}, respectively. Two of the alignment pillars 134_{SA-upper} and two of the alignment pillars 134_{SA-lower} provide fiducials 114_{SA-upper} and fiducials 144_{SA-lower} in upper cavity 148ᵤₚₚₑᵣ and lower cavity 148_{lower}, respectively. In the embodiment, the positions of fiducial 14SA-lower and the alignment pillar 134SA-lower not having the shape of a fiducial, are shown in alternative configurations. FIGS. 17B and 17C show the section drawings Section A-A′ and Section B-B′ through upper cavity 148ᵤₚₚₑᵣ and lower cavity 148_{lower}, respectively. In the embodiment, the individual layers in the upper planar waveguide layer 105ᵤₚₚₑᵣ include the upper bottom cladding layer 105_{bc-upper} and the upper core layer 105_{core-upper} of the first portion 105ₚₜ₁₋ᵤₚₚₑᵣ, and the second portion 105ₚₜ₂ of the planar waveguide layer 105ᵤₚₚₑᵣ comprising one or more of an upper cladding layer, a spacer layer, a buffer layer, and an encapsulation layer, among other layers. FIGS. 17A and 17B show the alignment pillars 134_{SA-upper}, including the fiducials 114_{SA-upper} formed from a same patterned mask layer as is used to form upper patterned planar waveguide cores 144_{SA-upper} to provide lithographic level dimensional tolerance between these patterned features in the upper planar waveguide layer 105ᵤₚₚₑᵣ. FIGS. 17A and 17C show the alignment pillars 134_{SA-lower}, including the fiducials 114_{SA-lower} formed from a same patterned mask layer as is used to form upper patterned planar waveguide cores 144_{SA-lower} to provide lithographic level dimensional tolerance between these patterned features in the lower planar waveguide layer 105_{lower}. The precision of lithographic patterning with the use of a same patterned mask layer to form the self-aligned features, the subsequent burial of these features, and the subsequent un-burying of the alignment features ensures that the lithographic precision used in the formation of the features is maintained throughout the formation of the aligned features in embodiments of the optical interposer structure 104 shown in FIGS. 17A-17C and in other embodiments disclosed herein.

FIGS. 18-18C show the embodiment shown in FIGS. 17A-17C with the addition of optical device 120ᵤₚₚₑᵣ and optical device 120_{lower} to upper cavity 148ᵤₚₚₑᵣ and lower cavity 148_{lower}, respectively, to illustrate the use of the alignment pillars 134_{SA-upper} and 134_{SA-lower} to enable alignment of the optical devices in the cavities using the alignment features in the embodiment of the optical interposer structure 104 having a dual waveguide structure. Active features 174ᵤₚₚₑᵣ of optical device 120ᵤₚₚₑᵣ and active feature 174_{lower} of optical device 120_{lower} are shown in alignment with the upper patterned planar waveguide cores 144_{SA-upper} and lower patterned planar waveguide cores 144_{SA-lower}, respectively. The vertical heights of the optical device 120ᵤₚₚₑᵣ and optical device 120_{lower} are determined by the elevation of the alignment pillars within the respective cavities 148ᵤₚₚₑᵣ, 148_{lower} which establish the elevation of the optical axis of the optical devices mounted on the alignment pillars in the embodiment. The vertical elevations of the mounted devices include the thickness of the first patterned mask layer 116_{SA}-1 as shown in FIGS. 18B and 18C.

The description of the alignment features disclosed herein in FIGS. 1A to 18C and the methods of formation of these alignment features, has largely been limited to alignment pillars for mounting an optical device in a cavity. Other alignment features having one or more of lateral and vertical alignment characteristics for embodiments of optical interposer structure 104 may also be formed using the methods and structures disclosed herein. In the following paragraphs, embodiments of optical interposer structure 104 having lateral alignment features for alignment of optical fibers are disclosed. In an embodiment, for example, the core of an optical fiber that is mounted in a v-groove may be aligned with a patterned planar waveguide core 144 using structures and methods disclosed herein. In another embodiment, the cores of one or more optical fibers mounted in a fiber attachment unit (FAU) may be aligned with one or more patterned planar waveguide cores 144 using structures and methods disclosed herein. Descriptions of such embodiments are described herein.

Optical connectivity of photonic integrated circuit assemblies 102 having embodiments of optical interposer structures 104 can include optical fiber cables through which optical signals can be extracted from, or provided to, the patterned waveguides and other devices formed on the optical interposer structure 104. Optical fiber cables may be mounted to interposer structures using v-grooves and fiber attachment units (FAUs).

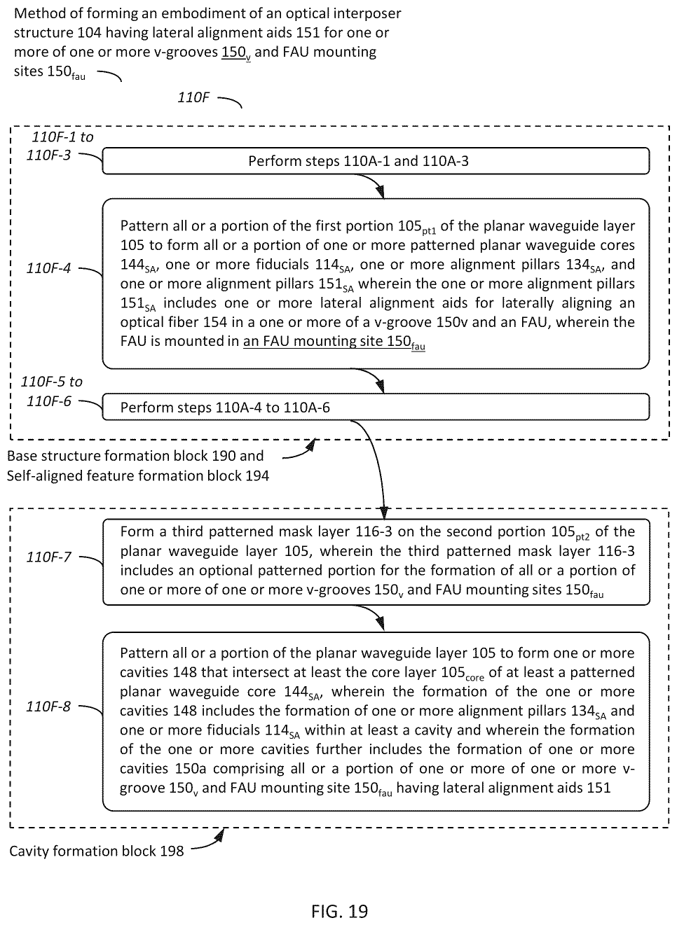

FIG. 19 shows a flowchart for method 110F for forming self-aligned lateral alignment aids for aligning the optical axis of a core of an optical fiber with the optical axis of a patterned planar waveguide core 144 formed in an embodiment of an optical interposer structure 104. In an embodiment, an optical fiber may be mounted in a v-groove to form an assembly. In another embodiment, the optical fiber may be mounted in an FAU to form an assembly. Lateral alignment aids for the alignment of an optical fiber, in embodiments, are formed from a same patterned mask layer used in the formation of patterned planar waveguides cores 144. The flowchart for method 110F describes a method for forming embodiments of an optical interposer structure 104 having alignment aids formed self-aligned with the patterned planar waveguide cores 144 of a planar waveguide layer 105, wherein the alignment aids include lateral alignment pillars 151 for aligning an optical fiber in one or more of a v-groove and a fiber attachment unit (FAU).

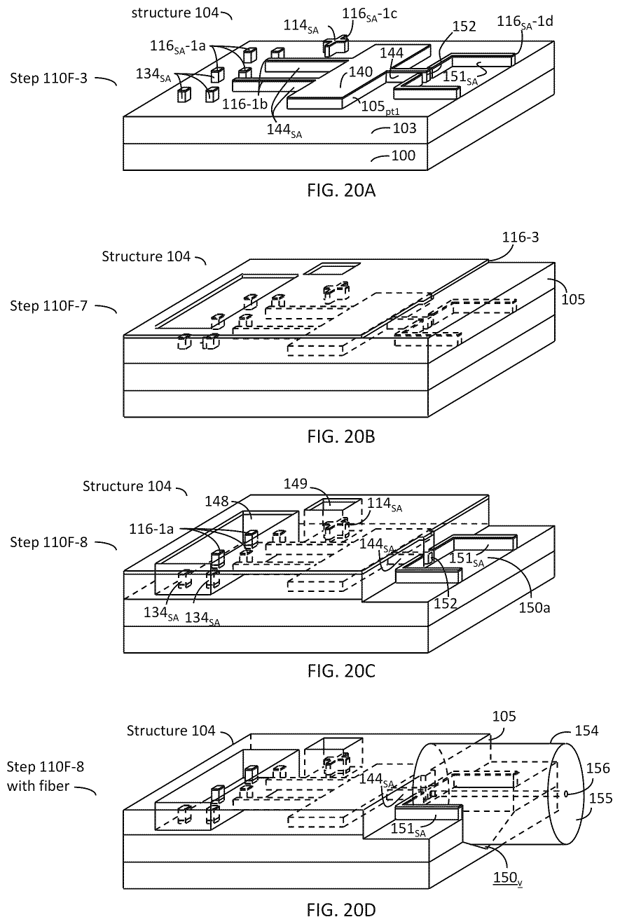

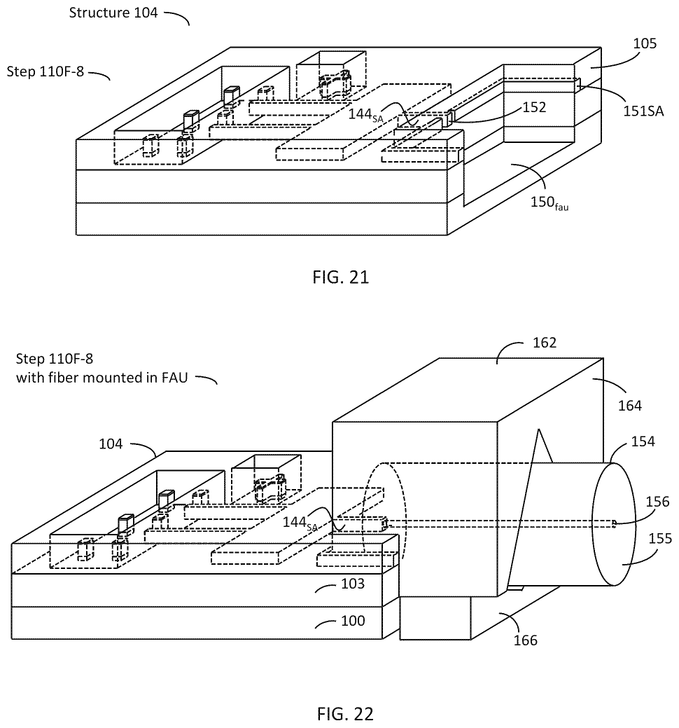

Steps 110F-1 to 110F-3 of method 110F are similar to steps 110A-1 to 110A-3 of method 110A shown in FIG. 5 with the addition of patterned portions in the first patterned mask layer for the lateral alignment features required for aligning an optical fiber. Steps 110A-1 to 110A-3 are of method 110A are described in conjunction with FIGS. 6A to 6C. Method 110F is described in conjunction with FIGS. 20A-20D for an embodiment having a v-groove wherein the v-groove is formed having lateral alignment aids, and in conjunction with FIGS. 21A-21B for an embodiment having an FAU mounting site wherein the FAU mounting site is formed having lateral alignment aids.

Steps 110F-1 to 110F-3 of method 110F are performing steps in which steps 110A-1 to 110A-3 are performed with the addition of patterned portions in the first patterned mask layer for the lateral alignment features required for aligning an optical fiber.

Step 110F-4 of method 110F is a patterning step in which all or a portion of the first portion 105ₚₜ₁ of the planar waveguide layer 105 is patterned to form all or a portion of one or more patterned planar waveguide cores 144_{SA}, one or more fiducials 114_{SA}, one or more alignment pillars 134_{SA}, and one or more alignment pillars 151_{SA} wherein the one or more alignment pillars 151_{SA} includes one or more lateral alignment aids for laterally aligning an optical fiber 154 in a one or more of a v-groove 150ᵥ and an FAU, wherein the FAU is mounted in an FAU mounting site 150_{fau}.

FIG. 20A shows a schematic perspective drawing of an embodiment of optical interposer structure 104 that includes self-aligned lateral alignment aids 151 for aligning the core 156 of an optical fiber 154 to patterned planar waveguide cores 144 as in Step 110F-4 of method 110F. The embodiment of optical interposer structure 104 shows lateral alignment pillar 151_{SA} that is formed using patterned portion 116_{SA}-1d of first patterned mask 116_{SA}-1. Lateral alignment pillar 151_{SA} is a lateral alignment aid used in the formation of a v-groove wherein the v-groove having the lateral alignment aid 151 may be used to align the optical axis of the core of an optical fiber with the optical axis of a patterned planar waveguide core 144 on the embodiment of the optical interposer structure 104.

Steps 110F-5 to 110F-6 of methods 110F are performing steps in which the steps 110A-4 to 110A-7 are performed. Steps 110A-4 to 110A-7 include the formation of a second patterned mask layer to facilitate removal of the patterned portion 116_{SA}-1b of first mask layer 116_{SA}-1 from the patterned planar waveguide cores 144_{SA}, the removal of the second patterned mask layer, and the formation of a second portion 105ₚₜ₂ of planar waveguide layer 105.

Base structure formation block 190 of method 110F comprises Step 110F-1 wherein a base structure 101 is formed. In method 110F, base structure formation block 190 is followed by self-aligned feature formation block 194 and cavity formation block 198. Self-aligned feature formation block 194 follows base structure formation block 190 and comprises steps 110F-2 to 110F-6. The steps 110F-2 to 110F-6 in method 110F include a sequence of steps for which patterned planar waveguide cores and alignment features are formed from a first portion of a planar waveguide layer using a same patterned mask layer and buried in a second portion of the planar waveguide layer after removal of the patterned mask layer from the patterned planar waveguides. In method 110F, alignment features are provided for mounting an optical fiber. In method 110F, self-aligned feature formation block 194 is followed by cavity formation block 198.

Step 110F-7 of method 110F is a forming step in which a third patterned mask layer 116-3 is formed on the second portion 105ₚₜ₂ of the planar waveguide layer 105, wherein the third patterned mask layer 116-3 includes a patterned portion for the formation of all or a portion of one or more of one or more v-grooves 150ᵥ and FAU mounting sites 150_{fau}.

FIG. 20B shows a schematic perspective drawing of an embodiment of optical interposer structure 104 that includes self-aligned lateral alignment aids 151 for aligning the core 156 of an optical fiber 154 to patterned planar waveguide cores 144 after formation of the second portion 105ₚₜ₂ of planar waveguide layer 105 and formation of third patterned mask layer 116-3 as in Step 110F-7 of method 110F. FIG. 20B shows the planar waveguide layer 105 comprising first portion 105ₚₜ₁ and second portion 105ₚₜ₂ and third patterned mask layer 116-3 in the embodiment.

Step 110F-8 of method 110F is a patterning step in which all or a portion of the planar waveguide layer 105 is patterned to form one or more cavities 148 that intersect at least the core layer 105_{core} of at least a patterned planar waveguide core 144_{SA}, wherein the formation of the one or more cavities 148 includes the formation of one or more alignment pillars 134_{SA} and one or more fiducials 114_{SA} within at least a cavity 148, and wherein the formation of the one or more cavities 148 further includes the formation of one or more cavities 150a comprising all or a portion of one or more of one or more v-groove 150ᵥ and FAU mounting site 150_{fau} having lateral alignment aids 151_{SA}.

Cavity formation block 198 follows self-aligned feature formation block 194 and comprises steps 110F-7 and 110F-8. The steps 110F-7 and 110F-8 in method 110F include a sequence of steps for which one or more cavities having alignment features are formed on the optical interposer structure 104.

FIG. 20C shows a schematic perspective drawing of an embodiment of optical interposer structure 104 that includes self-aligned lateral alignment pillars 151_{SA} for aligning the core 156 of an optical fiber 154 with a patterned planar waveguide core 144_{SA} as in Step 110F-8 of method 110F. FIG. 20C further shows cavities 148, 149 in patterned planar waveguide layer 105 that intersect the core layer 105_{core} of two patterned planar waveguide cores 144_{SA}, and six alignment pillars 134_{SA} formed within cavity 148. In the embodiment, fiducial 114_{SA} is shown in cavity 149. The embodiment shown in FIG. 20C also shows cavity 150a comprising all or a portion of one or more of one or more v-groove 150ᵥ and FAU mounting site 150_{fau} having lateral alignment pillars 151_{SA}. The alignment pillar 151_{SA} is shown in proximity to a patterned planar waveguide core 144_{SA} that is intersected by cavity 150a. The patterned planar waveguide core 144_{SA} intersected by cavity 150a forms facet 152 having the optical axis of the patterned planar waveguide core 144_{SA} in the embodiment.

FIG. 20D shows a schematic perspective drawing of an embodiment of optical interposer structure 104 that includes self-aligned lateral alignment aids 151 for aligning the core 156 of an optical fiber 154 to a patterned planar waveguide core 144_{SA} as in Step 110F-8 of method 110F with the addition of an optical fiber 154 mounted in v-groove 150ᵥ formed from all or a portion of cavity 150a. The formation of v-grooves is known in the art of semiconductor processing. In method 110F, the formation of the v-groove 150ᵥ is performed without removal of the self-aligned alignment pillar 151_{SA}. A protective patterned mask layer, for example, may be formed on the optical interposer structure 104 such that all but the area within the lateral alignment pillar 151_{SA} remains unprotected. That is, all but the area within which the v-groove is to be formed is covered with a protective mask layer in this example. A photoresist layer may be used, for example, to form the protective patterned mask layer used to facilitate the formation of the v-groove 150ᵥ. After a wet etch process, for example, to form the v-groove 150ᵥ, the protective mask layer may be removed, leaving the alignment pillar 151_{SA} to enable alignment of the fiber core with the self-aligned patterned planar waveguide core 144_{SA}.

FIG. 21 shows a schematic perspective drawing of an embodiment of optical interposer structure 104 that includes self-aligned lateral alignment aids 151_{SA} for aligning the core 156 of an optical fiber 154 mounted in an FAU 162 to patterned planar waveguide cores 144_{SA} as in Step 110F-8 of method 110F. In the embodiment, the core of an optical fiber mounted in an FAU in mounting site 150_{fau} is aligned with facet 152 of patterned planar waveguide core 144_{SA} intersected by cavity 150_{fau}.

FIG. 22 shows a schematic perspective drawing of an embodiment of optical interposer structure 104 that includes self-aligned lateral alignment aids 151 for aligning the core 156 of an optical fiber 154 mounted in an FAU to patterned planar waveguide cores 144 as in Step 110F-8 of method 110F shown with mounted optical fiber 154 in FAU 162 on mounting site 150_{fau}.

In some assemblies having embodiments of optical interposer structure 104 for which an optical fiber is mounted in an FAU, alignment pillars 134 that further enable vertical alignment in conjunction with the lateral alignment pillars 151 may be included. Enabling both lateral and vertical alignment of the axis of the core of an optical fiber mounted in an FAU with the optical axis of a patterned planar waveguide core 144_{SA} may be preferable, for example, for the implementation of passive alignment techniques that may require both lateral and vertical alignment structures.

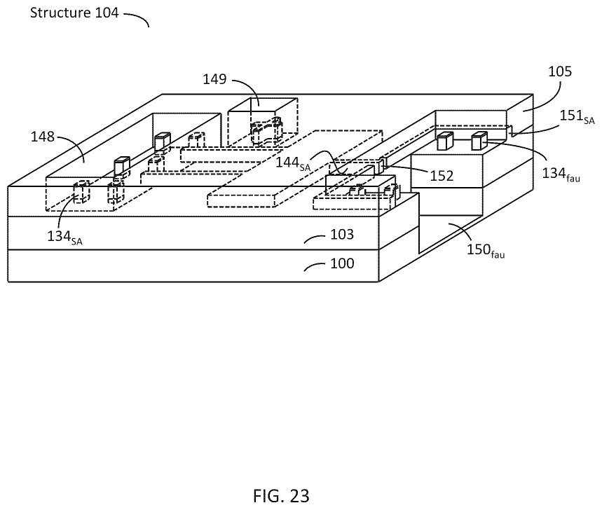

FIG. 23 shows a schematic perspective drawing of an embodiment of optical interposer structure 104 that includes self-aligned lateral alignment aids 151 and vertical alignment pillars 134_{fau} for aligning the core 156 of an optical fiber 154 mounted in an FAU 162 to patterned planar waveguide cores 144_{SA}.

The alignment pillars 134_{fau} may be formed using a number of methods and portions of methods described herein. In an embodiment in which the alignment pillars 134_{fau} are formed self-aligned with the patterned planar waveguide cores 144_{SA}, a simple addition of a patterned portion of the first patterned mask 116_{SA}-1 as in method 110A may be used. In such an embodiment, self-aligned lateral alignment pillars 151_{SA} may be included as described, for example, in method 110F. In other embodiments, the alignment pillars 134_{fau} may be formed on an optical interposer structure 104 without the lateral alignment pillars 151_{SA}.

Using method 110A as a basis for the formation of self-aligned alignment features, a variety of alignment features may be formed to accommodate the alignment of a range of optical devices simply by adding a patterned portion to the first patterned mask layer 116_{SA}-1 as described in method 110A.

Alternatively, method 110B may be modified to include a patterned portion of the patterned mask layer 116-3 of method 110B shown in FIG. 9G. Coupled with an appropriate spacer layer thickness in second portion 105ₚₜ₂ of planar waveguide layer 105, alignment pillars 134_{fau} may be formed that enable precise vertical alignment of an optical fiber mounted in an FAU with patterned planar waveguide cores 144 formed on the embodiment of optical interposer structure 104.

Method 110C provides yet another alternative for including alignment pillars 134_{fau} that enable precise vertical alignment of an optical fiber mounted in an FAU with patterned planar waveguide cores 144 in embodiments of optical interposer structure 104. In method 110C, the vertical alignment pillar is formed below the self-alignment layer. The formation of vertical alignment pillars 134_{fau} that are formed below the self-alignment layer that includes the patterned planar waveguide layer 144_{SA} may be better suited for vertical alignment of an FAU in an FAU mounting site for FAU's that may require alignment pillars having a top surface that is formed to accommodate the bottom surface of an FAU having a large thickness.

Other methods of forming alignment pillars 134_{fau} may also be used in other embodiments. Assemblies comprising embodiments of optical interposer structure 104 and mounted devices 120, are further described herein.

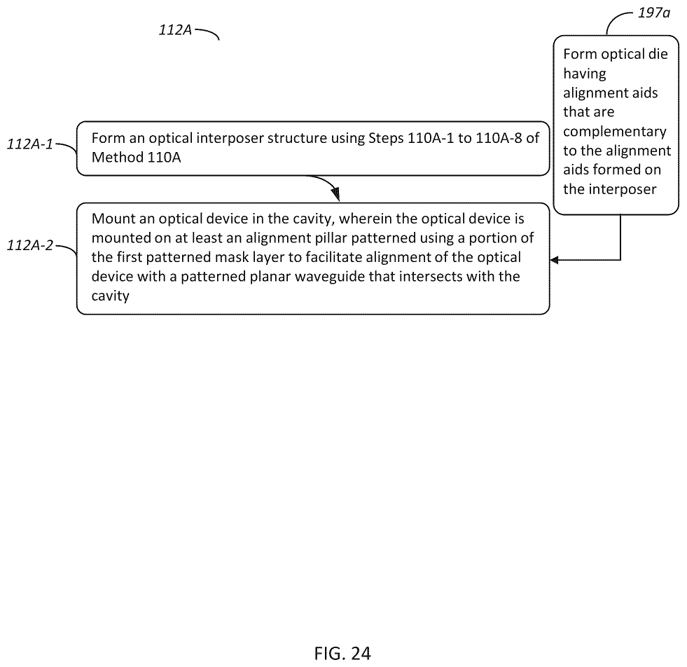

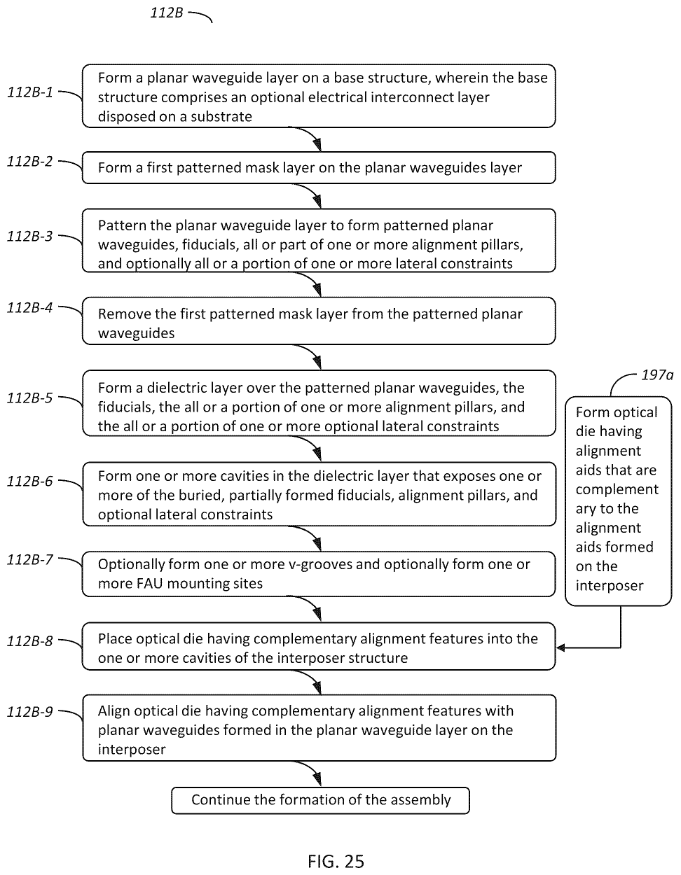

Methods of formation of assemblies 102 having embodiments of optical interposer structures 104 are described in the flowchart in FIGS. 24 and 25.

FIG. 24 shows a flowchart for method 112A for forming assemblies comprising embodiments of optical interposer structure 104 and mounted optical device 120 wherein the mounted optical device 120 are mounted in cavity 148 of the optical interposer structure 104. The flowchart for method 110H in FIG. 24 shows a method of forming an assembly 102 having an embodiment of an optical interposer structure 104 wherein the optical interposer structure 104 comprises patterned planar waveguide core 144_{SA} and alignment pillars 134_{SA} that include fiducial 114_{SA} formed from a planar waveguide layer 105 using a same first patterned mask layer 116_{SA}.

Steps 112A-1 of method 112A is a forming step in which an optical interposer structure 104 is formed. Step 112A-1 may use, for example, steps 110A-1 through 110A-8 of method 110A disclosed herein with the inclusion of an optional step for removal of the third patterned mask layer as shown for example in FIGS. 7H and 7I.

Step 112A-2 of method 112A is a mounting step in which an optical device 120 is mounted in a cavity 148 formed on the optical interposer structure 104, wherein the optical device 120 is mounted on at least an alignment pillar 134_{SA} patterned using a portion of a first patterned mask layer to facilitate alignment of the optical device 120 with a patterned planar waveguide core 144_{SA} that intersects the cavity 148. In some embodiments, one or more optical devices 120 are mounted in one or more cavities 148 formed in all or a portion of the planar waveguide layer 105, wherein the one or more optical devices 120 are positioned in the one or more cavities 148 using at least an alignment pillar 134_{SA} formed from the same patterned mask layer as used in the patterning of the planar waveguide cores 144_{SA} formed from the planar waveguide layer 105 of the optical interposer structure 104.

Step 197a of method 112A is a forming step, in which one or more mountable optical device 120 are formed having alignment aids that are complementary to the alignment aids formed on the optical interposer structure 104. In assemblies 102 formed from embodiments of the optical interposer structure 104, complementary alignment aids formed on an optical device 120 are alignment aids that enable alignment of the optical axis of an active layer 174 of a mountable optical device 120 with the optical axis of a patterned planar waveguide core 144_{SA} or other device having a preferred optical axis on the optical interposer structure 104 wherein the alignment aids of the mountable optical die can be used with the alignment pillars 134_{SA} formed in a cavity 148 on the optical interposer structure 104. Example optical device 120 having complementary alignment aids to alignment aids 134_{SA} in embodiments of the optical interposer structure 104 are provided herein. An example of an optical device 120 having complementary alignment aids, may be, for example, a laser structure having alignment pillars that facilitates the alignment of the optical output from an emission facet of the laser with a facet 152 of a patterned planar waveguide core 144_{SA} that intersects cavity 148. The complementary alignment aids of the laser are complementary to the alignment pillars 134 of the interposer to facilitate the alignment of the optical axes of the laser and of the waveguide core 144_{SA} to which the optical output from the laser is coupled.

In the formation of assemblies 102 having embodiments of the optical interposer structure 104 as described, for example, in method 112A, and wherein patterned planar waveguide cores 144_{SA} on embodiments, are formed self-aligned with alignment pillars 134_{SA} formed in one or more cavities 148, the assemblies 102 comprise an optical interposer structure 104 and an optical device 120 mounted in a cavity 148 on the self-aligned alignment aids 134_{SA} formed in the cavity 148. In other assemblies, the optical interposer structure 104 may further comprise alignment features for a plurality of optical devices mounted in one or a plurality of cavities 148, as further described herein, and the embodiment of optical interposer structure 104 may further comprise fiber optic cables 154 in the assembly 102 mounted and aligned using one or more of lateral and vertical alignment aids formed self-aligned to patterned planar waveguide cores 144_{SA} formed in the embodiment.

FIG. 25 shows a flowchart for a method 112B of forming an assembly 102 having an embodiment of an optical interposer structure 104 wherein the assembly comprises optical interposer structure 104 having alignment features 134_{SA} formed in a cavity 148 in self-alignment with patterned planar waveguide cores 144_{SA}, further comprises mounted devices 120 that utilize the alignment aids 134_{SA} formed in the cavities 148, and yet further comprises one or more of lateral alignment aids and vertical alignment aids used to mount and align one or more optical fibers onto the optical interposer structure 104, wherein the lateral and vertical alignment aids used in the alignment of the one or more optical fibers 154 are formed in self-alignment with patterned planar waveguide cores 144_{SA} formed on the optical interposer structure 104.

Step 112B-1 of method 112B is a forming step in which a planar waveguide layer 105 is formed on a base structure 101, wherein the base structure 101 comprises an optional electrical interconnect layer 103 disposed on a substrate 100. In embodiments, the planar waveguide layer 105 may be all or a portion of a planar waveguide layer comprising a bottom cladding layer 105_{bc}, a core layer 105_{core}, and a top cladding layer 105_{tc}, among other layers such as, for example, one or more spacer layers.

Step 112B-2 of method 112B is a forming step in which a first patterned mask layer is formed on the planar waveguide layer 105.

Step 112B-3 of method 112B is a patterning step in which the planar waveguide layer is patterned to form patterned planar waveguide cores, fiducials, all or a portion of one or more alignment pillars, and optionally all or a portion of one or more lateral constraints. Lateral constraints may be formed for example, in portions of the interposer structure on which an optional v-groove, FAU, optical device, or other device or structure is mounted to an embodiment of optical interposer structure 104.

Step 112B-4 of method 112B is a removing step in which the first patterned mask layer is removed from the patterned planar waveguide cores 144 formed from the planar waveguide layer 105. Patterned mask layers, particularly those that are formed from a metal layer, may interfere with the propagation of optical signals in the core layer of a patterned planar waveguide. In embodiments, the removal of the first patterned mask layer from the patterned planar waveguide cores 144 ensures that the mask does not interfere with optical signals propagating in the patterned planar waveguide cores 144. In removing step 112B, the first patterned mask layer is not removed from the fiducials 114, the all or a portion of one or more alignment pillars 134, and the all or a portion of one or more optional lateral constraints.

Step 112B-5 of method 112B is a forming step in which a dielectric layer is formed over the patterned planar waveguide cores 144, the fiducials 114, the all or a portion of one or more alignment pillars 134, and the all or a portion of one or more optional lateral constraints. In embodiments, the dielectric layer may be a portion of a planar waveguide comprising a top cladding layer, a side cladding layer, an encapsulation layer, a spacer layer, a planarization layer, among other layers. The dielectric layer, when combined with the planar waveguide layer of step 112B-1, forms at least the bottom cladding layer, the core layer, and the top and side cladding layers of a planar waveguide structure, and may further include other layers.

Step 112B-6 of method 112B is a forming step in which one or more cavities are formed in the dielectric layer formed in Step 112B-5 that expose one or more of the buried, partially formed fiducials, alignment pillars, and optional lateral constraints. Step 112B-6 of method 112B comprises a first step of forming a cavity mask pattern in a cavity mask layer, and a patterning step in which the dielectric material in the planar waveguide structure is removed through open areas in the cavity mask layer. The cavity mask layer, may be, for example, an aluminum layer or an alloy of aluminum and a patterning process for the formation of the cavities in a dielectric planar waveguide structure may be, for example, a fluorine-based, plasma etching process used to remove the dielectric material comprising the planar waveguide layer. As the one or more cavities are formed in the dielectric layer and all or a portion of the underlying planar waveguide layer, the buried portions of the first patterned mask layer are exposed by the removal of the material from within the cavity by the patterning process used for the cavity formation. Patterning processes that are selective to the dielectric layer in comparison to the material used in the formation of the first patterned mask layer are used to enable the removal of the dielectric material without excessive removal of the buried first patterned mask layer that is exposed during cavity formation.

Step 112B-7 of method 112B is an optional forming step in which one or more optional v-grooves and one or more optional FAU mounting sites are formed on the interposer structure. The formation of an optional v-groove, for example, enables the inclusion of an optical fiber to an assembly formed using embodiments of the interposer structure formed using steps 112B-1 to 112B-6 of method 112B. Alternatively, or in addition to, one or more FAU mounting sites may optionally be formed in step 112B-7 of method 112B to enable the inclusion of one or more optical fibers mounted in an FAU to the assembly formed from embodiments of the optical interposer structure formed using steps 112B-1 to 112B-6 of method 112B.

Step 112B-8 of method 112B is a placing step in which optical die having complementary alignment features to those of the embodiment of the interposer structure 104 are placed into the one or more cavities 148 of the optical interposer structure 104. In some embodiments, placing step 112B may be performed manually. In other embodiments, placing step may be performed using automated pick-and-place apparatus. In some embodiments, flip chip automated pick-and-place apparatus may be used. In some embodiments, optical device 120 having complementary alignment features to those of the optical interposer structure step 112B-8 are required for place die to conform to the cavities formed on the optical interposer structure 104. In other embodiments, alignment aids 134 formed in the cavities 148 conform to the mountable optical device 120 that are to be placed into the cavities 148.

Step 197a of method 112B is a forming step, in which one or more optical device 120 are formed having alignment aids that are complementary to the alignment aids 134 formed on the optical interposer structure 104. Step 197a of method 610A is a forming step in which optical device 120 having complementary alignment features to those of the optical interposer structure 104 are formed. Step 197a may be performed independently of the steps 112B-1 to 112B-9 of method 112B used in the formation of the optical interposer structure 104. In some embodiments, the optical devices 120 may be, for example, laser devices formed using epitaxially grown structures of indium phosphide. Lasers formed from indium phosphide may be used, for example, to emit light in the range of wavelengths commonly utilized in telecommunications. Examples of complementary alignment aids formed on optical devices 120 and on embodiments of optical interposer structure 104 are provided herein.

Step 112B-9 of method 112B is an aligning step in which optical device 120 having complementary alignment features to those of the embodiment of the optical interposer structure 104 on which the optical device 120 is to be mounted, is aligned with patterned planar waveguide cores 144_{SA} formed from the planar waveguide layer 105. In an example aligning step, as further described herein, the optical axis of the optical device 120 placed in a cavity 148 of optical interposer structure 104 is aligned with the optical axis of a patterned planar waveguide core 144_{SA} that intersects the wall of the cavity 148 formed in the planar waveguide layer 105 of the optical interposer structure 104.

In assemblies 102 formed from embodiments of the optical interposer structure 104, complementary alignment aids formed on an optical device 120 are alignment aids that enable alignment of the optical axis of the optical device 120 with the optical axis of a device having a preferred optical axis. Example optical die having complementary alignment aids to alignment aids 134 in embodiments of the optical interposer structure 104 are provided herein.

An example of an optical device having complementary alignment aids, may be, for example, a laser structure having alignment pillars that facilitate the alignment of the optical output from an emission facet of the laser with a facet of a patterned planar waveguide core 144_{SA} that intersects cavity 148. The complementary alignment aids of the laser are complementary to the alignment aids of the optical interposer structure insofar as the alignment aids facilitate the alignment of the optical axes of the laser and of the waveguide to which the optical output from the laser is optically coupled.

Upon completion of aligning step 112B-9, the PIC formation may be continued.

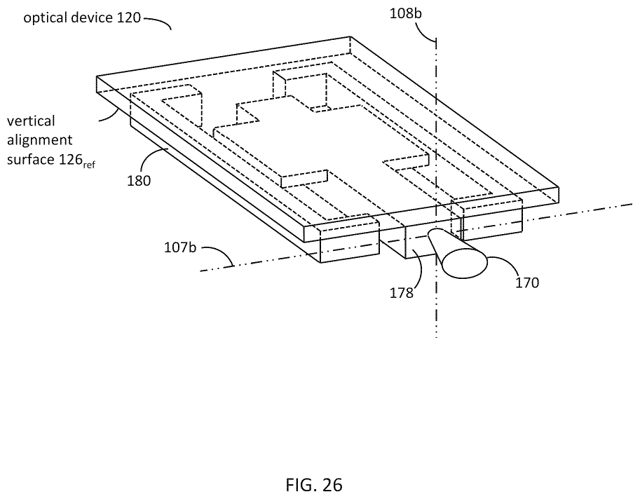

FIG. 26 shows a perspective drawing of an example mountable optical device 120 having alignment features.

Optical device 120 may be, for example, an optical emitting device such as a laser, or an optical receiving device such as a photodiode, for example. Optical device 120 may be any optical emitting device that emits, sends, forms, modifies, transfers, transforms, or otherwise provides an optical signal. Optical device 120 may be any optical device that receives, reflects, transfers, transforms, or is otherwise receptive to an optical signal. Optical device 120 may be a receiving device such as a photodiode or other form of photodetector. Optical device 120 may be a waveguide, an arrayed waveguide, a grating, a lens, a modulator, a spot size converter, among other devices. Optical device 120 may be a waveguide or may be a device that includes a waveguide or a plurality of waveguides through which optical signals are propagated, routed, modulated, focused, transformed, or otherwise included in a photonic circuit to receive, direct, modify and carry optical signals within all or a portion of the photonic circuit. In yet other embodiments, the optical device 120 is an echelle grating or other form of grating. In yet other embodiments, the optical device 120 is a lens. Optical device 120 can be any optical or optoelectrical device that can be formed into a mountable device that can be mounted using the alignment features as described herein.

Optical device 120 is shown in FIG. 26 having facet 178. Facet 178 is a surface of the optical device 120 through which an optical function of the optical device 120 is accessed or interfaced external to the optical device 120. Facet 178 for embodiments in which the optical device 120 is a laser, for example, is the surface through which the optical signal from the laser is emitted. For embodiments in which the optical device 120 is a photodetector, for example, facet 178 is the surface through which the optical signal is received or otherwise detected. Also shown in FIG. 26 is an example optical axis of optical device 120 that includes horizontal axis 107b and vertical axis 108b. Horizontal axis 107b is a projection of a hypothetical horizontal plane that intersects a primary center of an active optical layer of optical device 120. The horizontal axis can be used in embodiments, to identify a suitable elevation for an optical device 120 mounted on alignment pillars 134 formed in cavity 148 in embodiments of an optical interposer structure 104. Vertical axis 108b of optical device 120 is a projection of a hypothetical vertical plane that intersects a primary center of an active optical layer of optical device 120. The vertical axis 108b can be used in embodiments, to identify a suitable lateral position for an optical device 120 mounted on alignment pillars 134 formed in cavity 148 in embodiments of an optical interposer structure 104. The horizontal and vertical axes 107b, 108b, respectively are shown in the embodiment in FIG. 26 at the center of an optical signal on the facet 178 of optical device 120 and the alignment of axes such as those shown in FIG. 26 with the optical axis or axes of other devices in PICs are further described herein.

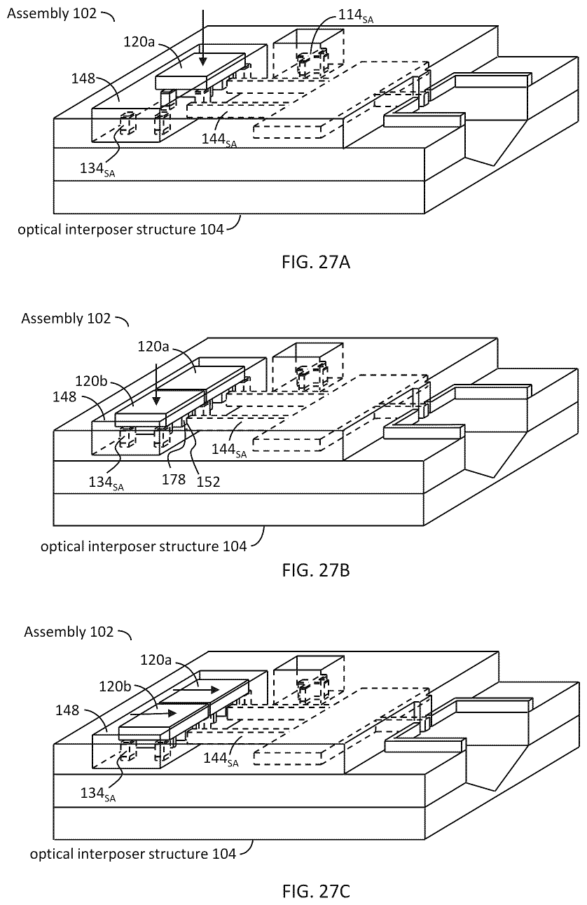

FIGS. 27A-27C show perspective schematic drawings of assembly 102 at various steps in the formation of the assembly 102 that includes an embodiment of optical interposer structure 104 and two mounted optical device 120.

FIG. 27A shows a perspective schematic drawing of an assembly 102 that includes an embodiment of optical interposer structure 104 and a first optical device 120a after placement of first optical device 120a into cavity 148 (placement is indicated by the arrow). Initial positioning of optical device 120 over cavity 148 may rely on fiducials detected using pattern recognition systems integrated within an automated pick-and-place apparatus. Fiducials 114_{SA} formed self-aligned with alignment pillars 134_{SA} enable precise correspondence between the position of the fiducials 114_{SA} and the position of the alignment pillars 134_{SA}. Formation of the fiducials 114_{SA} at the same elevation as the alignment pillars 134_{SA} also ensures precise correspondence between the focusing of the fiducials 114_{SA} and the focusing of the alignment pillars 134_{SA}. Precise correspondence is provided in embodiments as a result of having formed the fiducials 114_{SA} and the alignment pillars 134_{SA} from a same planar waveguide layer or portion of a planar waveguide layer and as a result of using a same patterned mask layer to pattern the self-aligned fiducials 114_{SA} and alignment pillars 134_{SA}. Use of a same patterned mask layer for the formation of the fiducials 114_{SA} and alignment pillars 134_{SA} provides lithographic level of feature patterning integrity which can be on the order of several nanometers or less depending on the lithographic technology used.

FIG. 27A shows a schematic perspective drawing of an embodiment of an optical interposer structure 104 after placement of a first optical device 120a into cavity 148. Optical device 120a is, for example, a laser die. The optical device 120a can be placed with a high degree of accuracy into the cavity 148 using automated pick-and-place apparatus to place optical device 120a within the spacing between the alignment pillars 134 using automated pattern recognition apparatus. This high placement accuracy is further enabled, in embodiments, as a consequence of having formed the fiducials 114_{SA} and the alignment pillars 134_{SA} from a same mask layer using a same lithographic patterning process, and then subsequently maintaining the self-alignment provided with the use of the same patterned mask layer throughout the formation of the optical interposer structure 104.

Placement of a first optical device 120a as shown in FIG. 27A is followed by the placement of a second optical device 120b as illustrated in FIG. 27B.

FIG. 27B shows a perspective schematic drawing of an assembly 102 that includes an embodiment of optical interposer structure 104, a first optical device 120a, and a second optical device 120b after placement of second optical device 120b into cavity 148 (placement is indicated by the arrow).

In the embodiment shown in FIG. 27A and FIG. 27B, a cavity 148 is shown for which allowances are made to accommodate two optical device 120a, 120b. In other embodiments, more than two optical device 120 are accommodated within a cavity 148 and following placement of the second optical device 120b, the additional optical devices 120 may be positioned over additional alignment pillars 134_{SA} formed within a cavity 148 having the additional alignment pillars 134. In other embodiments, cavity 148 accommodates only a single optical device 120a and thus only a single optical device 120 is placed in the cavity 148.

In the formation of the assembly 102 shown in FIG. 27B, after placement of the first and second optical devices 120a, 120b, the optical and electrical features of the optical device 120a, 120b that have been placed into the cavities 148 require alignment with the optical and electrical features on the optical interposer structure 104, namely the optical axes of patterned planar waveguide cores 144_{SA}.

FIG. 27C shows a perspective schematic drawing of an assembly 102 that includes an embodiment of optical interposer structure 104, first optical device 120a, and second optical device 120b after alignment of the first and second optical device 120a, 120b (alignment direction is indicated by the arrow). The arrows shown in FIG. 27C indicate the direction of motion of optical devices 120a, 120b, in the embodiment, upon initiation of an alignment step in which one or more optical and electrical features are brought into alignment between the optical device 120a, 120b and the optical and electrical features of the optical interposer structure 104. The positioning of the optical device 120a, 120b over the alignment pillars 134_{SA} using the fiducial marks 114_{SA} for lateral reference provides for the subsequent alignment with the other features and devices formed in the planar waveguide layer 105. In the embodiment shown in FIG. 27C, facets 178 of the mounted optical devices 120a, 120b are moved into alignment with the terminal facets 152 of the patterned planar waveguide cores 144_{SA} that intersect with the wall of the cavity 148. Additional details are provided herein for the placement, alignment, and associated steps, with additional detailed descriptions of embodiments of the alignment pillars 134 configured having variations in the shape of the alignment pillars 134_{SA} on the optical interposer structure 104 and optical devices 120 having complementary alignment pillars.

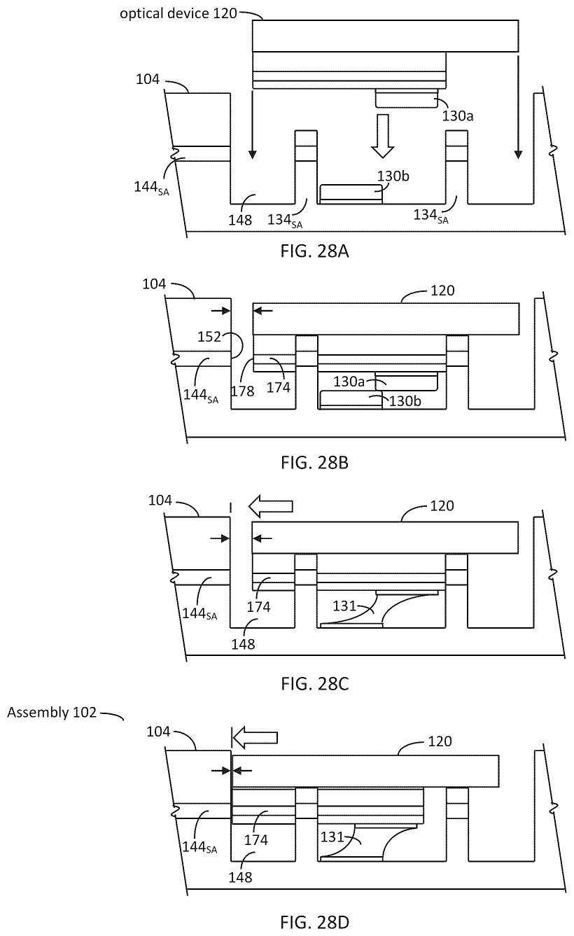

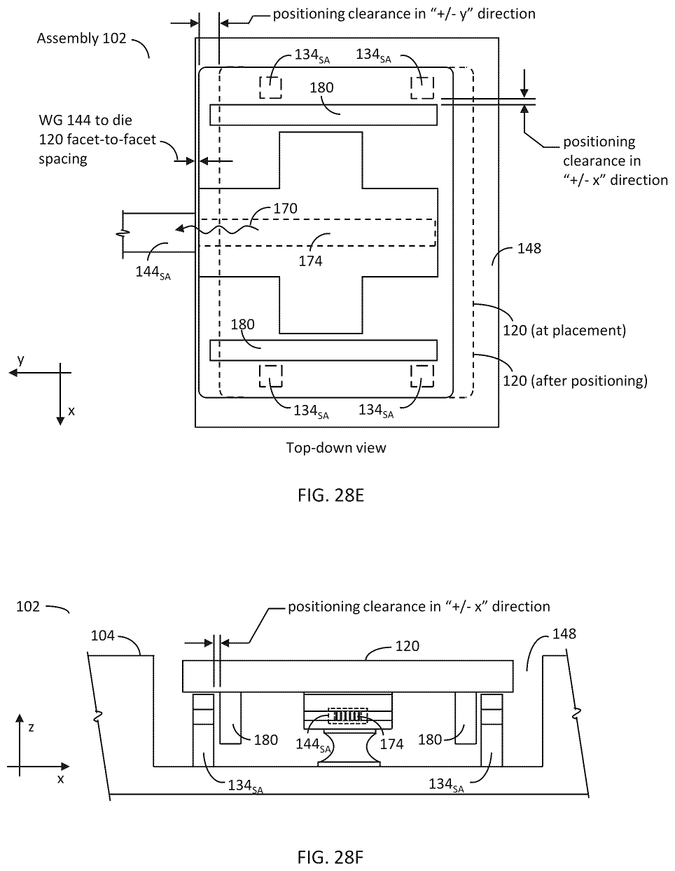

FIGS. 28A-28F show schematic drawings of an assembly 102 at various steps in the formation of the assembly 102 that includes the placement and alignment of an optical device 120 into cavity 148 of an embodiment of optical interposer structure 104. The sequence of cross-sectional drawings in FIGS. 28A-28D and the top-down drawing in FIG. 28E illustrate a method that can be utilized in the alignment of optical and optoelectrical devices in embodiments, as for example, the alignment procedure described for mounted devices 120a, 120b shown in FIGS. 27A-27C. The sequence of steps may be used in a method of performing an alignment step, as for example, in aligning step 1011-9 of method 112B shown in FIG. 25.

A lateral force can be provided to an optical device 120 mounted on an optical interposer structure 104 by bringing into proximity, pairs of solder contact layers on mating surfaces, and upon bringing the pairs of solder contacts into proximity, subsequently raising the temperature of the solder until the solder melts. Surface tension in the molten solder can act to pull the two contacts together and into alignment. The lateral force is formed when the solder contact surfaces, misaligned at placement, act to be brought into areal alignment. In embodiments, the use of surface tension in molten solder to bring a mounted optical device 120 into alignment with a patterned planar waveguide core 144_{SA} in an embodiment of optical interposer structure 104 is illustrated in the sequence of cross-sectional drawings in FIGS. 28A-28D.

FIG. 28A shows a cross-sectional schematic drawing of an embodiment of an optical interposer structure 104 and an optical device 120 after alignment and prior to placement of the optical device 120 into cavity 148, wherein the optical device 120 and the cavity 148 are shown having electrical contacts 130a, 130b. In the embodiment shown, electrical contacts 130a,130b include a layer of solder. In other embodiments, solder may be used on one or more of the electrical contact 130a formed on the optical device 120 and the electrical contact 130b formed in the cavity 148. The schematic drawing in FIG. 28A shows optical device 120 positioned over cavity 148 of an optical interposer structure 104. Electrical contact 130a, formed for example, as shown on optical device 120, is misaligned at placement with electrical contact 130b on the optical interposer structure 104 as the optical device is placed into the cavity 148.

FIG. 28B shows a cross-sectional schematic drawing of an embodiment of an optical interposer structure 104 and an optical device 120 after placement of the optical die into cavity 148.

After placement of the optical device 120 onto the alignment pillars 134_{SA} in cavity 148, the intentional misalignment of the electrical contacts 130a,130b after placement is further shown in FIG. 27B. In some embodiments, after one or more optical devices have been placed onto the optical interposer structure 104, one or more of a heating source and an energy source is applied such that a solder layer on the electrical contacts 130a,130b are raised in temperature above the melting temperature of the solder.

FIG. 28C shows a cross-sectional schematic drawing of an embodiment of an optical interposer structure 104 and an optical device 120 after heating of the solder-containing portions of electrical contacts 130a,130b on the optical device 120 and on cavity 148, respectively.

As the solder melts and the solder layer from each electrical contact 130a,130b is combined into a single molten contact 131 as illustrated in FIG. 28C, the surface tension in the molten solder will cause lateral movement of the optical device 120 in a direction such that the two misaligned electrical contacts 130a, 130b will be brought into further areal alignment which then causes the spacing between the optical features of the optical device 120 and the patterned planar waveguide core 144_{SA} to be reduced. Movement of the die, in the direction of the large arrow in FIG. 28C, is expected to continue, for example, until the motion is blocked by one or more of a surface-to-surface contact formed between a surface of optical device 120 with a surface of the wall of cavity 148, a surface-to-surface contact formed between the surface of a feature of the optical device 120 and the surface of an alignment pillar 134_{SA} within the cavity 148, and removal of the heating source. As the optical devices 120 is moved into aligned positions, facet 178 of active layer 174 of optical device 120 is brought closer in proximity to facet 152, in the embodiment, resulting in a reduction of the spacing shown between the two opposing arrows shown in FIGS. 28A-28D.

FIG. 28D shows a cross-sectional schematic drawing of an embodiment of assembly 102 comprising an optical interposer structure 104 and an optical device 120 after mounting and alignment of the optical device 120 wherein the optical axis of the optical device 120 and the optical axis of the patterned planar waveguide core 144_{SA} are brought into alignment using surface tension of the molten solder in electrical contacts 130a,130b and alignment aids 134.

The movement of the optical device 120 is shown in FIG. 28D to have been halted by surface-to-surface contact formed between the wall of the cavity 148 and the substrate or other portion of the optical device 120 after the facet 178 of the optical device 120 has been brought into alignment with the facet 152 of the optical interposer structure 104 as indicated by the large arrow reaching the termination line in FIG. 28D. FIGS. 28B and 28D show the patterned planar waveguide core 144_{SA} in alignment with the facet 178 of optical device 120. The optical axis of an optical device 120 is typically contained with an active layer 174 of the optical device 120.

FIG. 28E shows a top-down schematic drawing of the embodiment of assembly 102 shown in the cross-section of FIG. 28D.

The top-down drawing of the assembly 102 shown in FIG. 28E further illustrates the effect of the alignment process described in conjunction with the cross-sectional drawings of FIGS. 28A-28D. In the embodiment, alignment pillars 134_{SA} on the optical interposer structure 104 are shown in relation to alignment features 180 on the optical device 120 that may act to guide the optical device 120 into an aligned position in the cavity 148 during the alignment process for an alignment process as described in conjunction with FIGS. 28A-28D. Other alignment processes may also be used in other embodiments. The dotted line with label “120 (at placement)” shown in the top-down view in FIG. 28E shows the edge of the optical device 120 at placement in cavity 148 and solid edge labeled “120 (after positioning)” shows the position of the optical device 120 after alignment. Clearance between the physical features of the mounted die and the alignment pillars 134_{SA} and cavity sidewalls must be provided to avoid contact during placement in the placed position. Typical automated state of the art pick-and-place apparatus enables placement to within ˜5 um. Manual placement may enable closer tolerances of less than 0.5 um. An initial positioning clearance is noted in FIG. 28E with the label “positioning clearance in “+/−y” direction to illustrate an initial distance in the y-direction at placement between the physical features of the mounted die 120, such as the device substrate 160 and alignment features 180 of the mounted device 120 and the sidewalls of cavity 148 and alignment pillars 134_{SA} formed within the interposer cavity 148 The positioning clearance in the “+/−y” direction as noted should be such to enable adequate clearance for placement. The distance between the facet 178 of the active layer 174 of mounted device 120 and the facet 152 of the patterned planar waveguide core 144_{SA}, is reduced as the mounted device 120 is brought into an aligned position due either to a contact between the mounted device 120 and a sidewall of the cavity 148, as in the example shown in the embodiment in FIGS. 28A-28F or due to a contact formed between an alignment pillar 134_{SA} and a lateral alignment feature such as the lateral alignment surface 181 as shown, for example, in FIG. 1A.

Alignment of optical features on the optical device 120 with optical features on the optical interposer structure 104 is required in the formation of assemblies 102, for example, to ensure that optical signals can be exchanged or otherwise coupled between the optical interposer structure 104 and the mounted optical device 120. Example optical signal 170 shown FIG. 28E is shown propagating from the active layer 174 of optical device 120, for example, to a patterned planar waveguide core 144_{SA} on the optical interposer structure 104.

FIG. 28F shows a cross-sectional schematic drawing of an embodiment of assembly 102 comprising an optical interposer structure 104 and an optical device 120 after mounting and alignment of the optical device 120 wherein the cross-sectional view is a left-side view from the top-down view of FIG. 28E. FIG. 28F shows the alignment of the active layer 174 of the mounted optical device 120 with the patterned planar waveguide core 144_{SA}. The perimeter of patterned planar waveguide core 144_{SA} is shown in dotted lines and the active layer 174 is shown having vertical hatch marks in FIG. 28F. The alignment pillars 134_{SA} in the embodiment, provide containment for the rail-shaped alignment features 180 of the mounted device 120, such that the movement of the mounted device after placement, is limited to a point at which contact is made between one of the alignment features 180 of the mounted device 120 and the alignment pillars 134_{SA}. An initial positioning clearance is noted in FIG. 28F with the label “positioning clearance in “+/−x” direction to illustrate an initial distance in the x-direction at placement between the alignment feature 180 of the mounted device 120 and the alignment pillar 134_{SA}. This noted distance may increase as the die is moved into position up until such movement causes a contact to be made between an alignment feature 180 and an alignment pillar 134_{SA}.

It should be noted that the procedure for alignment utilizing the melting of solder as described in conjunction with FIGS. 28A-28E may be utilized in embodiments for both optical and optoelectrical devices regardless of whether or not the contact formed with the solder functions as an electrical contact to an underlying electrical interconnect in, for example, the electrical interconnect layer 103. For optical devices that do not require electrical connectivity, such as a grating or a lens, for example, optical interposer structure 104 may be configured with one or more solder contacts 130b that may be used to facilitate alignment. For optoelectrical devices such as a laser or a photodetector, the solder connections described in FIGS. 28A-28D may be utilized for alignment and to form an electrical contact with the underlying electrical interconnects in the electrical interconnect layer 103.

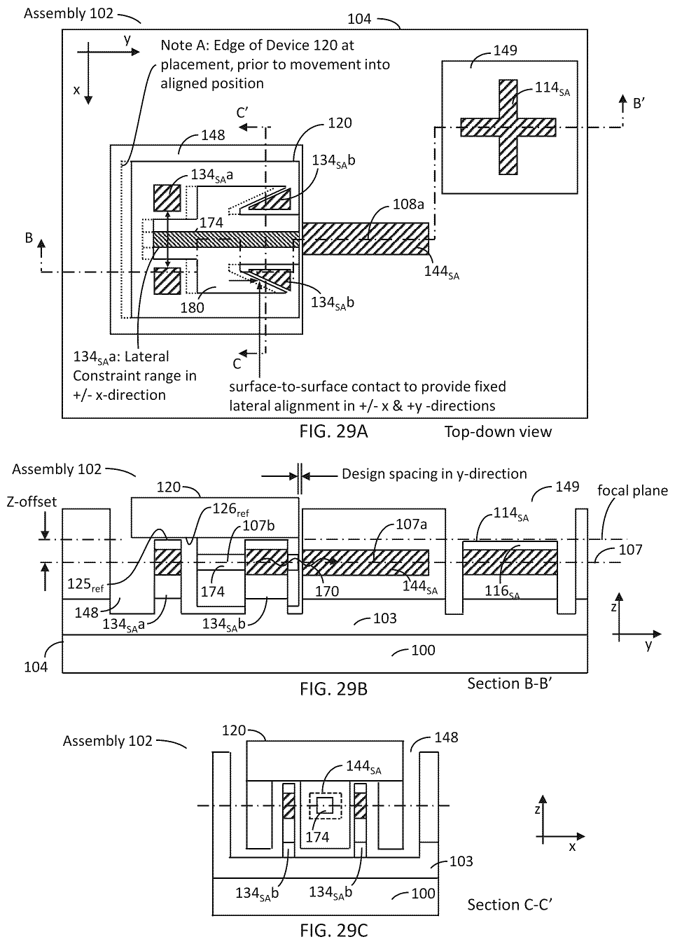

FIG. 29A shows a top-down schematic drawing of another assembly 102 comprising an embodiment of optical interposer structure 104 and a mounted optical device 120 wherein the alignment pillars 134_{xy} are formed to facilitate lateral alignment in both the “x” and “y” directions and wherein fiducial 114_{SA} is shown in fiducial cavity 149. The top-down view in FIG. 29A shows square-shaped alignment pillars 134_{SA}a and triangular-shaped alignment pillars 134_{SA}b.

FIG. 29B shows a schematic cross-section drawing of the assembly 102 of FIG. 29A comprising an embodiment of optical interposer structure 104 and a mounted optical device 120 wherein the alignment pillars 134_{xy} are formed to facilitate lateral alignment in both the “x” and “y” directions and wherein fiducial 114 is shown in fiducial cavity 149.

FIG. 29C shows an end view cross-sectional schematic drawing for Section C-C′ of FIG. 29A. FIG. 29C shows the end view of the cavity 148 and the optical device 120 mounted over the triangularly-shaped alignment pillars 134_{SA}b. The active layer 174 of the optical device 120 is shown in alignment with an overlay (in dotted lines) of the terminal facet of the patterned planar waveguide core 144_{SA}.

In the assembly 102 in the top-down drawing shown in FIG. 29A, an example configuration is shown for an embodiment of optical interposer structure 104 in which a first group is alignment pillars 134_{SA}a, is provided that together form a lateral constraint in the “+x” and “−x” directions (as noted with the reference coordinated system superimposed on FIG. 29A) and a second group of alignment pillars 134_{SA}b that provide lateral alignment in the “+x” and “−x” directions and in the “+y” directions. The combination of these alignment features can provide a robust alignment structure for the alignment of optical device 120 having a complementary alignment pillar 180.

The first group 134_{SA}a of alignment pillars 134_{SA} restricts the spatial range with which the optical device 120 can occupy. The width of the alignment feature 180 of the optical device 120 in combination with the x-direction spacing between the two sets of alignment pillars 134_{SA}a, 134_{SA}b forms a mechanical constraint that restricts the movement of the optical device 120 in the x-direction. The alignment pillars 134_{SA}a do not influence movement in the y-direction as configured. Optical device 120 is initially free to move unrestricted between the two sets of alignment pillars 134_{SA}a but cannot move beyond the point in either the +x or −x directions at which contact is made between one of the alignment pillars 134_{SA}a and the alignment structure 180 of the optical device 120. In the x-direction, placement in a first placement position as noted by the dotted line outline of optical device 120, may be provided within the tolerances of the placement apparatus if the clearance between the two sets of alignment pillars 134_{SA}a exceeds the placement tolerance. The label showing the “134_{SA}a: Lateral constraint range in +/−x direction” in the figure shows the width of the spacing between the first group 134_{SA}a within which the mechanical feature 180 of the optical device 120 must be positioned at placement. Alignment feature 180 must be small enough to allow clearance for placement of the optical device 120 into the cavity 148 without inducing a collision between the optical device 120 and either of the alignment pillars 134_{SA}a during placement. This resolution of current advanced pick-and-place apparatus is in the range of 0.3 to 0.5 micrometers.

The second group 134_{SA}b of alignment pillars 134_{SA}, in the embodiment, facilitates fixed positional alignment in both the “x” and “y” directions. After placement of the optical device 120 into cavity 148 into the placement position noted, for example, by the dotted line outline of the optical device 120, the second group 134_{SA}b of alignment pillars in conjunction with the pillar 180 on the optical device 120 facilitates the alignment of optical device 120 by guiding the alignment pillar 180 into mating surfaces on the second group 134_{SA}b on the optical interposer structure 104.

The guided movement of the optical device enables the repositioning of the optical device into an aligned position within the cavity 148. Prior to movement of the optical device into an aligned position within the cavity, the feature 180 is not in contact with the second group 134_{SA}b of the alignment pillars 134_{SA}. As the optical device 120 is moved into position to the right (+y-direction) surface-to-surface contact is made between the second group 134_{SA}b of alignment pillars 134_{SA} of the optical interposer structure 104 and the alignment pillar 180 of the optical device 120 to achieve alignment in the +y-direction, and as the device is guided into alignment in the +y-direction, the triangular shape of the alignment pillars 134_{SA}b will further guide the optical device 120 into an aligned position in one or more of the “+x” and “−x”-direction.

The spacing between devices in an example aligned position is denoted in FIG. 29B as “Design spacing in y-direction”. In forming a surface-to-surface contact between the alignment pillar 180 of optical device 120, the alignment pillars 134a, 134b restrict the movement in the “+x” direction, the “−x” direction and in the “+y” direction in the embodiment shown in FIGS. 29A and 29B. Prior to formation of the surface-to-surface contact with the alignment pillar 180, the optical device 120 is free to move in the “+y” and “−y” directions within the spacing between the two groups 134_{SA}a, 134_{SA}b of alignment pillars 134AS. In embodiments, a preferred location may be identified for optimal signal transfer or other coupling between optical device 120 and a patterned planar waveguide core 144_{SA}. In such instances, a lateral constraint design may be implemented that enables the movement to this preferred position. In FIG. 29B, for example, a preferred aligned position is shown with lateral spacing between devices as indicated by the “design spacing in y-direction.” The spacing shown is achieved in the embodiment as a result of the contact that is formed between the long edges of the of triangular-shaped second group 134_{SA}b of alignment pillars 134_{SA} and the long edges of the alignment pillar 180 of the optical device 120 that together form a surface-to-surface contact as noted in the top-down drawing in FIG. 29A. This surface-to-surface contact provides a fixed lateral alignment position in the “+y” and one or more of the “+x” and “−x” directions as noted in the top-down drawing in FIG. 29A. The lithographic level precision resulting from the co-formation of the patterned planar waveguide cores 144_{SA}, the alignment pillars 134_{SA}a, 134_{SA}b, and the fiducial 114_{SA} yields lithographic level precision in the achievable positioning of the mounted optical device 120 on the optical interposer structure 104. With the positioning of the mounted optical device in the aligned position, alignment of the optical axis of the mounted optical device 120 with the optical axis of the patterned planar waveguide cores 144_{SA} may also be provided.

It should be noted that the use of alignment pillars 134_{SA} for alignment of optical devices 120 in the vertical (z-direction) direction is typically unaffected by the addition of the lateral constraint features of the alignment pillars 134_{SA} as described, for example, for the embodiment shown in FIGS. 29A and 29B. The mounted elevation of optical device 120 is determined in the embodiment in FIG. 29B by the mechanical feature having noted reference plane 126_{ref} that forms a contact with the top surface of the alignment pillars 134_{SA}a, 134_{SA}b at a corresponding reference plane 125_{ref}. This surface-to-surface contact provides a high level of accuracy in the ultimate vertical position of the device 120, and subsequently to the alignment of the optical axis 107b of optical device 120 with the optical axis 107a of the patterned planar waveguide cores 144_{SA}. A z-offset, as noted, typically results from the finite thickness of the patterned mask layer 116_{SA} used in the formation of the self-aligned features.

Upon positioning of the optical device 120 between and over the alignment pillars 134_{SA}a, 134_{SA}b, the optical device 120 is positioned vertically as contact is formed between the top of the alignment pillars 134_{SA}a, 134_{SA}b and the mechanical feature of the optical device 120 at the reference plane 126_{ref}.

Fiducial 114_{SA} in cavity 149 is shown formed at the same focal plane as noted as the top of the alignment pillars 134_{SA}a, 134_{SA}b.

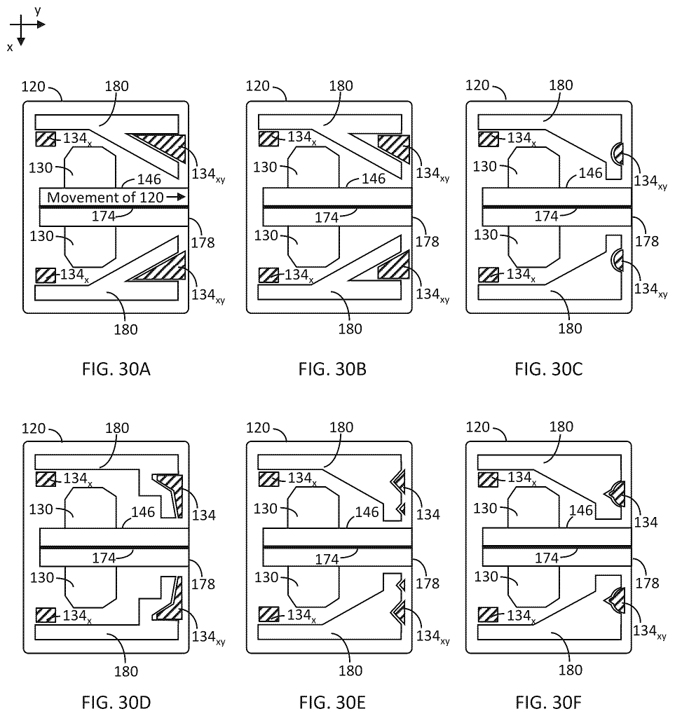

FIGS. 30A-30F show top-down schematic drawings of assemblies comprising embodiments of optical interposer structures 104 and mounted optical device 120 wherein alignment pillars 134_{xy} formed on the optical interposer 104 are configured to facilitate lateral alignment in both “x” and “y” directions for example complementary alignment features formed on the example optical device 120.

Alignment pillars 134 formed on embodiments of optical interposer structure 104 described herein can be formed in a range of configurations and can include variations in the quantities, the shapes, the lateral positions, and the vertical positions of these alignment aids. Configurations of alignment aids 134 formed on embodiments of optical interposer structure 104 are shown with complementary alignment pillars formed on optical devices 120 in which the shapes, quantities, and positions of the alignment pillars 134 and alignment pillars 180 on optical device 120 are shown in FIGS. 30A-30F. It should be noted, that additional variations in the shape and positioning of alignment pillars may be anticipated from the embodiments shown, and that other shapes, positions, and quantities for the alignment pillars and lateral alignment aids may be used and remain within the scope of embodiments.

FIG. 30A shows a top-down schematic drawings of an assembly comprising an embodiment of an optical interposer structure 104 and mounted optical device 120 wherein the alignment pillars 134_{xy} on the optical interposer structure 104 are triangular in shape and the alignment pillars 180 on the optical device 120 are receptive to the triangularly shaped alignment pillars 134_{xy} (hatched pillars 134ₓ and 134_{xy} are of the optical interposer structure 104). The alignment pillar configuration shown in FIG. 30A is similar to that shown in FIGS. 29A and 29B.

The alignment pillar configuration in FIG. 30A includes two square shaped pillars and two triangular shaped pillars. The triangular shaped pillars are aligned with cavities formed in the alignment feature 180 of the optical device 120. The hatched alignment pillars 134ₓ and 134_{xy} in FIG. 30A may be formed, for example, on an embodiment of optical interposer structure 104 using the methods described herein such as method 110A, for example. As the optical device 120 is moved into position over the alignment pillars 134_{xy}, the optical facet 178 of the active optical feature 174 of the optical device 120 is moved laterally into an aligned position. An arrow is shown to indicate the direction of movement for a mounted optical device 120 over the hatched fixed lateral alignment pillars 134ₓ,134_{xy} shown. The subscript “x” in alignment pillar 134ₓ, for example, indicates an alignment pillar that provides lateral constraint in the “x” directions. The subscript “xy” in alignment pillar 134_{xy}, for example, indicates an alignment pillar that provides lateral constraint in the “x” directions and in at least the “+y” direction.

FIGS. 30B to 30F show additional embodiments of optical interposer structures 104 configured having alignment pillars that enable precise positioning of optical device 120 with respect to the patterned planar waveguide cores 144_{SA} formed on the optical interposer structures 104. Variations in the shapes and quantities of the configured alignment pillars 134 are shown. These configurations illustrate a range of alignment shapes and quantities that may be utilized in embodiments of optical interposer structure 104 having such alignment pillars that enable precise lateral positioning. The vertical alignment is not, in general, dependent on the shape of the alignment pillars 134. The alignment features shown in FIGS. 30A to 30F are not intended to limit the scope of embodiments as the key attributes of the alignment pillars are provided in conjunction with the description of the embodiment of FIGS. 29A and 29B and other embodiments disclosed herein. In each of the configurations of the embodiments of optical interposer structure 104 shown in FIGS. 30A-30F, the complementary shapes of the alignment pillars 134 of the interposer device structure 104 and the alignment pillars 180 of a complementary optical device 120 provide lateral guidance in both the x and y directions as shown in the reference coordinate system in the upper left corner of FIG. 30A and as consistent with the reference coordinates shown in FIGS. 29A and 29B and throughout this disclosure.

FIG. 30B shows a top-down schematic drawings of an assembly comprising an embodiment of an optical interposer structure 104 and mounted optical device 120 wherein the alignment pillars 134_{xy} on the optical interposer structure 104 are trapezoidal in shape and the alignment pillars 180 on the optical device 120 are receptive to the trapezoidal shaped alignment pillars 134_{xy} (hatched pillars 134ₓ and 134_{xy} are of the optical interposer structure 104).

FIG. 30C shows a top-down schematic drawings of an assembly comprising an embodiment of an optical interposer structure 104 and mounted optical device 120 wherein the alignment pillars 134_{xy} on the optical interposer structure 104 are semicircular in shape and the alignment pillars 180 on the optical device 120 are receptive to the semicircular shaped alignment pillars 134_{xy} (hatched pillars 134ₓ and 134_{xy} are of the optical interposer structure 104).

FIG. 30D shows a top-down schematic drawings of an assembly comprising an embodiment of an optical interposer structure 104 and mounted optical device 120 wherein the alignment pillars 134_{xy} on the optical interposer structure 104 are composite trapezoidal (multiple joined trapezoids) in shape and the alignment pillars 180 on the optical device 120 are receptive to the composite trapezoidal shaped alignment pillars 134_{xy} (hatched pillars 134ₓ and 134_{xy} are of the optical interposer structure 104).

FIG. 30E shows a top-down schematic drawings of an assembly comprising an embodiment of an optical interposer structure 104 and mounted optical device 120 wherein the alignment pillars 134_{xy} on the optical interposer structure 104 comprise multiple triangularly shaped pillars and the alignment pillars 180 on the optical device 120 are receptive to the plurality of triangularly shaped alignment pillars 134_{xy} (hatched pillars 134ₓ and 134_{xy} are of the optical interposer structure 104).

FIG. 30F shows a top-down schematic drawings of an assembly comprising an embodiment of an optical interposer structure 104 and mounted optical device 120 wherein the alignment pillars 134_{xy} on the optical interposer structure 104 are shaped having a composite of a triangular and a semicircle and the alignment pillars 180 on the optical device 120 are receptive to the composite shaped alignment pillars 134_{xy} comprising a triangular shape and a semicircular shape (hatched pillars 134ₓ and 134_{xy} are of the optical interposer structure 104).

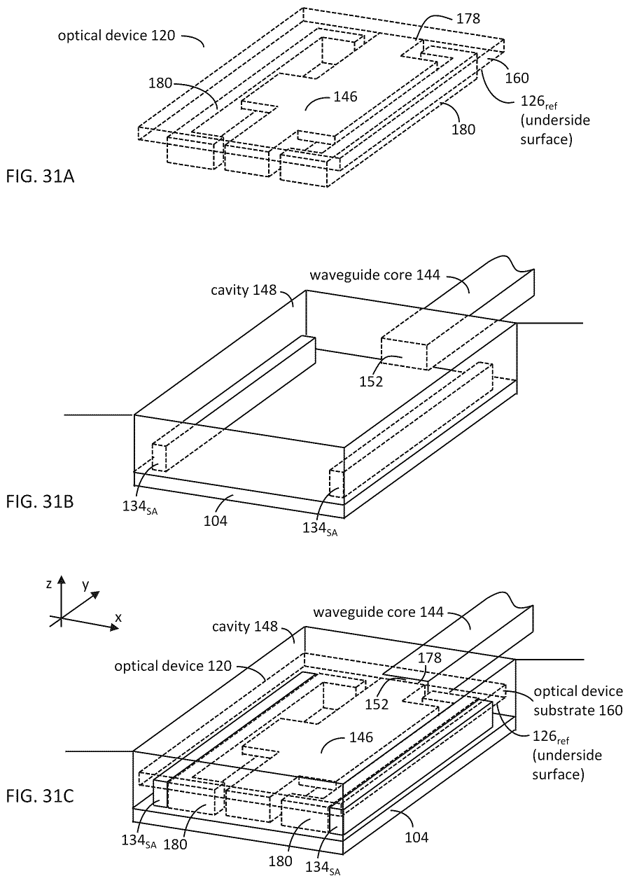

FIG. 31A-31C show perspective schematic drawings of optical device 120 having nestable alignment pillars 180, a mounting cavity 148 of an embodiment of an optical interposer structure 104 receptive to the optical device, and an assembly formed after mounting of the optical device 120 into the cavity 148. Nestable rail-shaped alignment pillars 134 are illustrated in the embodiment of optical interposer structure 104 in FIGS. 31A-31C.

FIG. 31A shows a perspective schematic drawing of an optical device 120 having nestable rail-shaped alignment pillars 180 formed on an optical device 120 and on an embodiment of optical interposer structure 104 . . .

The alignment pillars 180 in FIG. 31A are shown for an optical device 120 having a device body 146 formed on device substrate 160. An emitting or receiving facet 178 of the optical device 120 is also shown.

FIG. 31B shows a perspective schematic drawing of a mounting cavity 148 of an embodiment of an optical interposer structure 104 having alignment pillars 134. Alignment pillars 134 of the embodiment of the optical interposer structure 104 has a nestable structure complementary to the alignment pillars 180 for the optical device 120 shown in FIG. 31A. A patterned planar waveguide core 144 is shown intersecting a wall of cavity 148.

FIG. 31C shows perspective schematic drawings of a portion of an assembly 102 comprising the optical device 120 of FIG. 31A and a mounting cavity 148 of the embodiment of optical interposer structure 104 shown in FIG. 31B (optical interposer structure 104 is shown in solid lines and optical die is shown with dotted lines without regard for hidden features).

The assembly shown in FIG. 31C shows the optical device 120 shown in FIG. 31A mounted in an aligned position in cavity 148 of the portion of the optical interposer structure 104 shown in FIG. 31B. The hidden and unhidden outlines of the three-dimensional structure of optical device 120 are shown with dotted lines, and the unhidden outline of the three-dimensional structure of the portion of the optical interposer structure 104 having alignment pillars 134 to which the optical device 120 is aligned is shown with solid lines. Hidden lines for the optical interposer structure 104 and alignment pillars 134 are not shown. The substrate 160 of optical device 120 is shown transparent for clarity. The rail-like alignment pillars 180 of optical device 120 are shown in an aligned position in the assembly 102 of FIG. 31C alongside the rail-like alignment pillars 134 of the embodiment of the optical interposer structure 104. In the aligned position shown in FIG. 31C for optical device 120, the alignment pillars 134 are not necessarily in contact with a portion of the alignment pillars 180 of the optical device 120. In the embodiment, the alignment of the optical device 120 within the rail-like alignment pillars of the embodiment of the optical interposer structure 104 is limited to restricted movement in the “+x” and “-x” directions as shown with respect to the reference coordinate system accompanying FIG. 31C. In the embodiment, use of the cavity wall may be used to restrict movement in the “+/−y” directions.

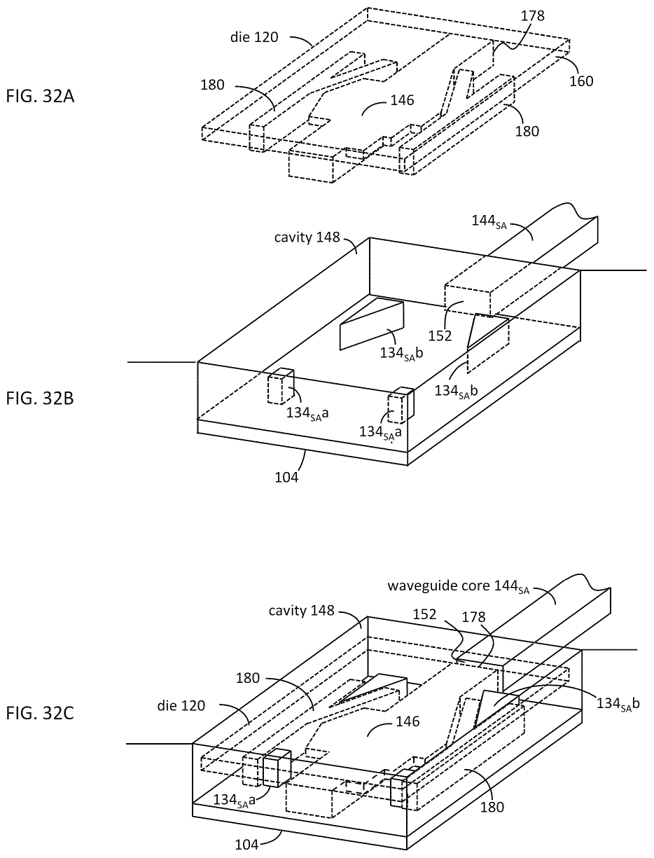

FIG. 32A-32C show perspective schematic drawings of another optical device 120 having nestable alignment pillars 180, a mounting cavity 148 of another embodiment of an optical interposer structure 104 having complementary alignment pillars receptive to those of the optical device 120, and an assembly formed after mounting of the optical device 120 into the cavity 148. The alignment pillars 134_{SA}a, 134_{SA}b in the embodiment shown in FIGS. 32A-32C are similar to those described herein in conjunction with FIGS. 29A and 29B. FIGS. 32A-32C are shown as a basis for describing other configurations of alignments pillars 134 used in embodiments of optical interposer structure 104 that pertain to cavities 148 that support a plurality of optical devices 120 and that pertain to cavities that enable the aligning and mounting of optical devices having a plurality of optical axes in optical device 120

FIG. 32A shows a perspective schematic drawing of an optical device 120 having alignment pillars 180 receptive to nestable triangular-shaped alignment pillars 134b in cavity 148 of the embodiment of the optical interposer structure 104 shown in FIG. 32B.

The perspective drawing in FIG. 32A shows optical device 120 having nestable alignment pillars 180 wherein the alignment pillars 120 are receptive to the alignment pillars 134 of the cavity 148 shown in the embodiment of the optical interposer structure 104 shown in FIG. 32B. The alignment pillars 180 and device body 146 of the optical device 120 are formed on device substrate 160. The device body includes emitting or receiving facet 178 of the optical device 120.

FIG. 32B shows a perspective schematic drawing of a mounting cavity 148 of an embodiment of an optical interposer structure 104 having alignment pillars 134_{SA}a, 134_{SA}b complementary to the alignment pillars 180 of the configuration of the optical device 120 shown in FIG. 32A. The self-aligned alignment pillars 134_{SA} in the embodiment, are configured with two rectangularly-shaped pillars 134_{SA}a (when viewed from top down) and two triangular-shaped alignment pillars 134_{SA}b (also when viewed from top down). Alignment pillars 134_{SA}a, 134_{SA}b are configured as shown in FIG. 32B to be nested within the complementary shaped alignment pillars 180 of the optical device 120 shown in FIG. 32A.

FIG. 32C shows perspective schematic drawings of a portion of an assembly 102 comprising the optical device 120 of FIG. 32A and a mounting cavity 148 of the embodiment of an optical interposer structure 104 shown in FIG. 32B (optical interposer structure 104 is shown in solid lines and optical die is shown with dotted lines).

In FIG. 32C, the optical device 120 is shown in an aligned position in cavity 148 of the optical interposer structure 104. A portion of the patterned planar waveguide core 144_{SA} that intersects the wall of the cavity 148 having facet 178 is shown in alignment with optical facet 152 of optical device 120.

The mounted optical device 120 is shown mounted in an aligned position within the cavity 148 of the portion of the optical interposer structure 104 shown in FIG. 32B. In FIG. 32C, the hidden and unhidden outlines of the three-dimensional structure of the optical device 120 are shown with dotted lines, and the unhidden outline of the three-dimensional structure of the portion of the optical interposer structure 104 having alignment pillars 134_{SA}a, 134_{SA}b to which the optical device 120 is mounted is shown with solid lines. Hidden lines for the interposer 104 and alignment pillars 134_{SA}a, 134_{SA}b are not shown, although substrate 160 of the optical device 120 is shown transparent for clarity. The top of the alignment pillars 134sa, 134_{SA}b form a surface-to-surface contact with the underside of substrate 160 of the optical device 120. The triangular shaped alignment pillars 134_{SA}b are aligned with a triangular cavity formed in the alignment pillar 180 and the rectangularly-shaped alignment pillars 134_{SA}a are shown in a position alongside a straight section of the alignment pillar 180 of the optical device 120. In the aligned position as shown in FIG. 32C, a portion of a triangularly-shaped alignment pillar 134_{SA}b of the optical interposer structure 104 forms a surface-to-surface with the triangularly shaped cavity in the alignment pillar 180 of the optical device 120. This surface-to-surface contact between the alignment pillars 134_{SA}b of the optical interposer structure 104 and the alignment pillars 180 of the optical device 120 provides the lateral alignment required for alignment of the optical axes of the optical device 120 and the patterned planar waveguide core 144_{SA} on the optical interposer structure 104.

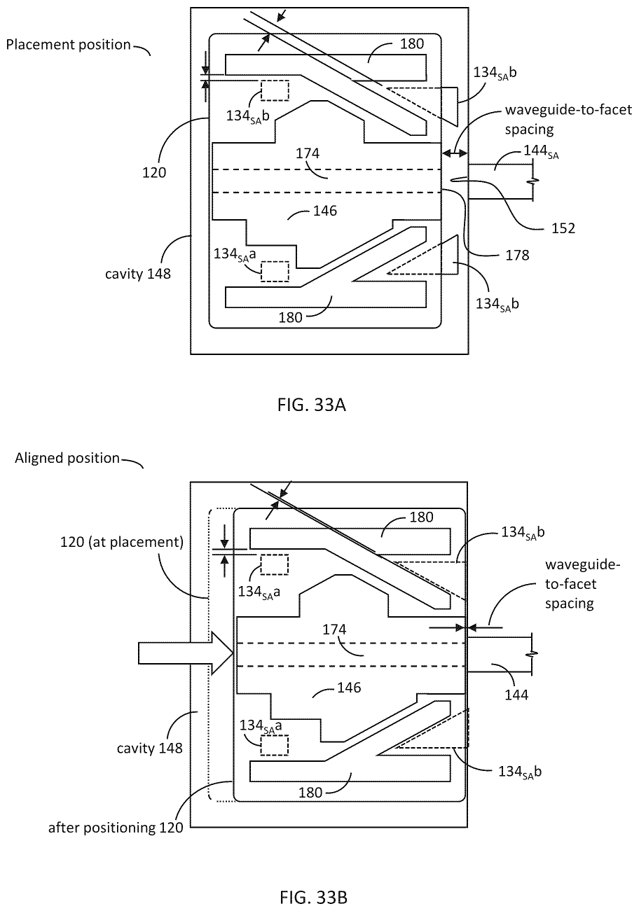

FIG. 33A shows a top-down schematic drawing of an optical device 120 in an example placement position in cavity 148 of an embodiment of an optical interposer structure 104.

In the top-down view of FIG. 33A, the embodiment of the optical interposer structure 104 of FIGS. 32A-32C is shown with an optical device 120 having complementary alignment pillars 180 after placement in cavity 148. Patterned planar waveguide core 144_{SA} is shown intersecting the wall of cavity 148. Spatial clearance is shown between the alignment pillars 134_{SA}a, 134_{SA}b and the alignment pillars 180 of optical device 120 to allow for the placement of the optical device 120 as shown. Facets 152, 178 of the patterned planar waveguide core 144_{SA} and the active layer 174 of optical device 120, respectively, are shown.

FIG. 33B shows a top-down schematic drawing of optical device 120 in an example aligned position in cavity 148 of an embodiment of an optical interposer structure 104. The movable optical device 120 is shown in FIG. 33B after being moved into an aligned position within the cavity 148 (in the direction of the large arrow) and in a position for which the facets 152, 178 of the patterned planar waveguide cores 144_{SA} and the optical device 120, respectively, are in substantial alignment. The left edge of the placement position with label “120 (at placement)” is shown for reference with dotted lines as noted. The alignment pillars 134sa, 134_{SA}b are in a fixed relative position on the optical interposer structure 104 to the alignment pillars 180 as the optical device 120 is moved into position. The noted “WG-to-facet 120 spacing” is limited in the embodiment shown by the surface-to-surface contact formed between the triangularly-shaped alignment pillars 134_{SA}b and the corresponding inside surface of the triangularly-shaped cavity in the alignment pillar 180 of the optical device 120. This surface-to-surface contact between the triangularly shaped alignment pillar 134_{SA}b and the alignment pillar 180 on the optical device can be configured in embodiments to establish a minimum distance that can be achieved between the optical facets 152, 178 of the optical device 120 and the patterned planar waveguide core 144_{SA}, respectively. In an aligned position having facets 152, 174 of the optical device 120 and the patterned planar waveguide core 144_{SA}, respectively, in close proximity, optical signals may be transferred, for example, having low signal loss between the optical device 120 and the patterned planar waveguide core 144_{SA}.

The embodiment of the optical interposer structure 104 shown in FIGS. 32A-32C and in FIGS. 33A and 33B facilitates the alignment of a single optical device 120 in cavity 148 of the optical interposer structure 104. The cavity 148 in the embodiment is shown to have a capacity of a single optical device 120. In other embodiments, more than one discrete optical device 120 may be positioned and aligned in a cavity 148 configured with a capacity to enable more than one optical device 120 to be mounted. And in yet other embodiments, an optical device 120 may provide a plurality of active layers each having an optical axis that may be mounted in alignment with a patterned planar waveguide core 144_{SA} formed in an embodiment of an optical interposer structure 104 having a cavity 148 that intersects a plurality of patterned planar waveguide cores 144_{SA}.

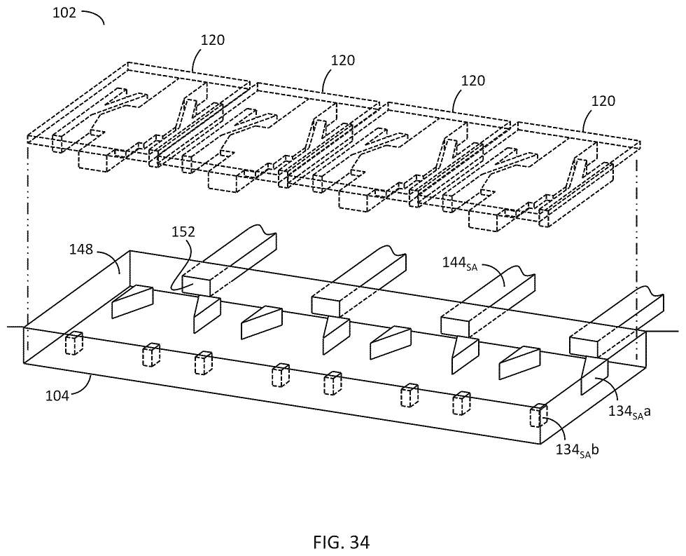

FIG. 34 shows an exploded perspective view of an assembly 102 comprising a plurality of optical devices 120 and an embodiment of an optical interposer structure 104, wherein the plurality of optical devices 120 are mounted in cavity 148 of the embodiment of the optical interposer structure 104 and wherein the cavity 148 is configured to be receptive to the alignment and mounting of the plurality of optical devices 120. The cavity 148 in the embodiment is configured having fours sets of alignment pillars 134_{SA} wherein each set of alignment pillars comprises a first group 134_{SA}a of two rectangularly-shaped alignment pillars 134_{SA} and a second group 134_{SA}b of two triangularly shaped alignment pillars 134_{SA} in the embodiment. In other embodiments, other alignment pillars, groups of alignment pillars, and sets of alignment pillars may be used.

Four discrete optical devices are shown in the embodiment of the assembly of FIG. 34. Optical device 120 shown in FIG. 34, may be, for example, a laser or other emitting device. Optical device 120 may be a detecting device such as a photodiode, for example, or other receiving device.

FIG. 34, the discrete optical device 120 is shown with features similar to those described in conjunction with the embodiment shown in FIGS. 31A-31C. Cavity 148 in the embodiment in FIG. 34 is shown having a capacity for four optical devices 120 wherein the four optical devices 120 are configured having alignment pillars 134_{SA}a, 134_{SA}b that are complementary to the alignment pillars 180 of the optical device 120. Cavity 148 in FIG. 34 shows portions of four patterned planar waveguide cores 144_{SA} intersected by the wall of cavity 148 to form optical facet 152.

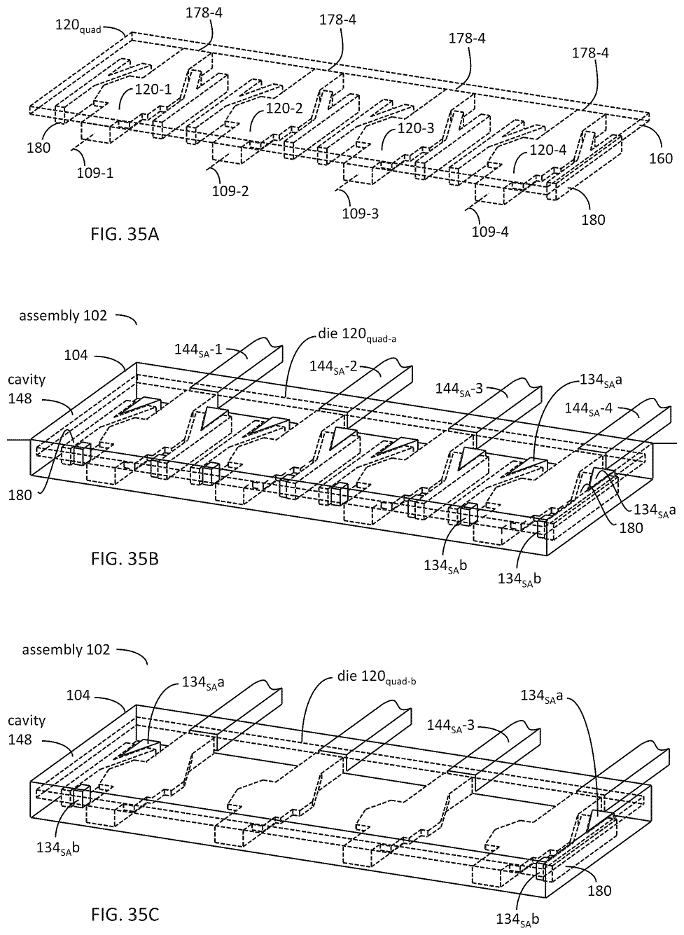

FIG. 35A shows a perspective schematic drawing of an optical device 120_{quad} configured having a plurality of optical devices 120-1 to 120-4 on a single substrate 160. Each optical device 120-1 to 120-4 has an optical axis 109-1 to 109-4, respectively. In some embodiments of optical interposer structure 104, a cavity 148 is configured having alignment aids receptive to an optical device 120 having a plurality of devices mounted on a single substrate. Optical device 120_{quad} is a device that includes four optical devices 120 on a single substrate. Optical devices such as optical device 120_{quad} configured having a plurality of optical devices 120, may enable more efficient fabrication of assemblies that are suited for using such devices. Improvements in efficiency, may be achieved, for example, with the capability to use placement, alignment, and mounting processes that can be performed on the plurality of devices on a single substrate in comparison to processes performed on discrete devices.

In some configurations of optical device 120, each of the four optical devices 120 on the optical device 120_{quad} shown may be a functional device with features similar to those described in the optical device 120 described in conjunction with FIG. 32A. In other configurations of optical device 120 having a plurality of optical devices 120, one or more devices may be the same as one or more other devices. And in yet other configurations of optical device 120 having a plurality of optical devices 120, one or more of the devices may differ from one or more other optical devices 120. And in yet other configurations of optical device 120 having a plurality of optical devices 120, each optical device may be different than other optical devices.

FIG. 35B shows an assembly 102 comprising an optical device 120_{quad-a} and an embodiment of an optical interposer structure 104 having a cavity 148 configured to be receptive to a plurality of devices 120 wherein the optical device 120_{quad-a} mounted in cavity 148 comprises a plurality of devices enabling simultaneous alignment and mounting of the plurality of devices with a plurality of patterned planar waveguide cores formed on the optical interposer structure 104, and wherein the cavity 148 is configured having a group of alignment pillars for each device on the optical device 120_{quad-a}. Optical axes 109-1 to 109-4 of devices 120-1 to 120-4, respectively, are aligned with the optical axes of patterned planar waveguide cores 144_{SA}-1 to 144_{SA}-4 intersecting the wall of cavity 148 in the assembly 102. Optical device 120_{quad-a} is shown mounted in cavity 148 wherein the cavity 148 is configured having a plurality of groups 134_{SA}a, 134_{SA}b of self-aligned alignment pillars 134_{SA}.

In the embodiment shown in FIG. 35B, cavity 148 is configured to receive four devices on optical device 120_{quad-a}. In other embodiments, cavity 148 may be configured to receive less than four devices on an optical device substrate 160 having a plurality of optical devices. And in yet other embodiments, cavity 148 may be configures to receive an optical device substrate 160 having more than five optical devices. And in yet other embodiments, not all of the devices 120 need to aligned with a patterned planar waveguide core 144_{SA} that intersects the wall of cavity 148.

FIG. 35C shows an assembly 102 comprising an embodiment of an optical interposer structure 104, configured to be receptive to a plurality of devices 120, and an optical device 120_{quad-b} wherein the optical device 120_{quad-b} is configured having a pair of alignment pillars 180 to facilitate alignment with a set of interposer-based alignment pillars 134_{SA}a, 134_{SA}b. The set of alignment pillars on optical device 120_{quad-b} is configured to align with optical interposer structure 104 having one group 134_{SA}a of alignment pillars and one group 134_{SA}b of alignment pillars 134_{SA} in the configuration of optical device 120_{quad-b}.

The simplified alignment feature structure shown in FIG. 35C using only a single set of alignment features may be beneficial for reducing resistive frictional forces from having multiple surface-to-surface contact points in comparison to the optical device 120_{quad-a} shown in FIG. 35B.

In other embodiments, more than two sets of alignment pillars 135SA may be provided on the optical interposer structure 104 to accommodate other configurations of alignment pillars on optical devices having a plurality of active layers. In other embodiments, cavities 148 on the optical interposer structure 104 may be configured to be receptive to mountable substrates 160 configured having two or more optical devices 120.

Further simplification may be achieved with the removal of the first group 134_{SA}a of alignment pillars 134_{SA}, for example, in cavity 148 in some embodiments.

In FIG. 34, a cavity 148 is shown having a capacity of one quad optical device 120_{quad} (or four discrete optical devices 120) and that contains alignment pillars 134_{SA}a, 134_{SA}b that are complementary to the alignment pillars 180 of the optical device 120 shown in FIG. 34. FIG. 35B shows portions of four planar waveguides 144_{SA} having facets 152 intersecting the wall of the cavity 148. In FIG. 35B, an assembly is shown wherein quad optical device 120_{quad} is positioned in the cavity 148 over the alignment pillars 134_{SA}a, 134_{SA}b and the facets 178 of which are aligned with the facets 152 of the planar waveguides 144_{SA}. In the embodiments shown in FIGS. 35B and 35C, four optical devices 120 are included on the optical device 120_{quad} a and 120_{quad-b}, respectively. In other embodiments, two optical devices 120 are included on a substrate 160 and placed into a cavity 148 that has a capacity for mounting two optical devices 120. In yet other embodiments in which two optical devices 120 are included on a common substrate 160, these devices are positioned in a cavity 148 that has a capacity for a multiple of two devices 120 including a cavity 148 that has a capacity for four devices, six devices, eight devices, or any other multiple of two devices. In other embodiments, three optical devices 120 are included on a substrate 160 and placed into a cavity 148 that has a capacity for mounting three optical devices 120. In yet other embodiments in which three optical devices 120 are included on a common substrate 160, these devices are positioned in a cavity 148 that has a capacity for a multiple of three devices 120 including a cavity 148 that has a capacity for six devices, nine devices, twelve devices, or any other multiple of three devices. In yet other embodiments, four optical devices 120 are included on a substrate 160 and placed into a cavity 148 that has a capacity for mounting four optical devices 120. In yet other embodiments in which four optical devices 120 are included on a common substrate 160, these devices are positioned in a cavity 148 that has a capacity for a multiple of four devices 120 including a cavity 148 that has a capacity for eight devices, twelve devices, sixteen devices, or any other multiple of four devices. In yet other embodiments, one or more optical devices are included on a substrate 160 and placed into a cavity 148 that has a capacity for multiple devices 120 and to fully or partially fill the cavity 148 with the one or more devices. An example configuration includes a single device formed on a first substrate in combination with two devices formed on a second substrate that are placed in a cavity with a capacity for three devices. Another example configuration includes a single device formed in a first substrate in combination with three devices formed on a second substrate that are placed in a cavity with a capacity for four devices, Other example configurations include other quantities of optical devices formed on a first substrate with the same or another quantity of optical devices formed one or more additional substrates to fully or partially fill the cavity on the substrate. In preferred configurations of embodiments, the optical device capacity of a cavity matches the number of devices in the cavity. The scope of configurations of alignment pillars 134 in cavity 148 and the corresponding scope of configurations of complementary optical devices 120 disclosed herein are not intended to restrict the scope of embodiments, but rather are intended to illustrate features that are applicable to a wider range and scope of embodiments, including the scope of applicable configurations of optical devices, and the corresponding scope of configurations of alignment pillars formed in cavity 148 to enable such configurations of optical devices in embodiments of optical interposer structure 104.

It should be noted that in the embodiments described in FIG. 29A and in FIGS. 30A to 35C, the substrate 160 is shown to be transparent for clarity. Vertical alignment between the alignment pillars 134_{SA} and optical devices 120 in assemblies 102 in these embodiments, uses the surface-to-surface contact between the tops of the alignment pillars 134 and the substrate 160 of the optical device 120 to form an alignment in the vertical (z) direction.

Optical devices 120 used in embodiments may be configured with electrical features. For an optical device 120 configured as a laser, for example, power delivery is required to the laser. In embodiments of optical interposer structure 104, power may be provided to cavity 148 and other portions of the optical interposer structure 104 via the electrical interconnect layer 103 of optical interposer structure 104.

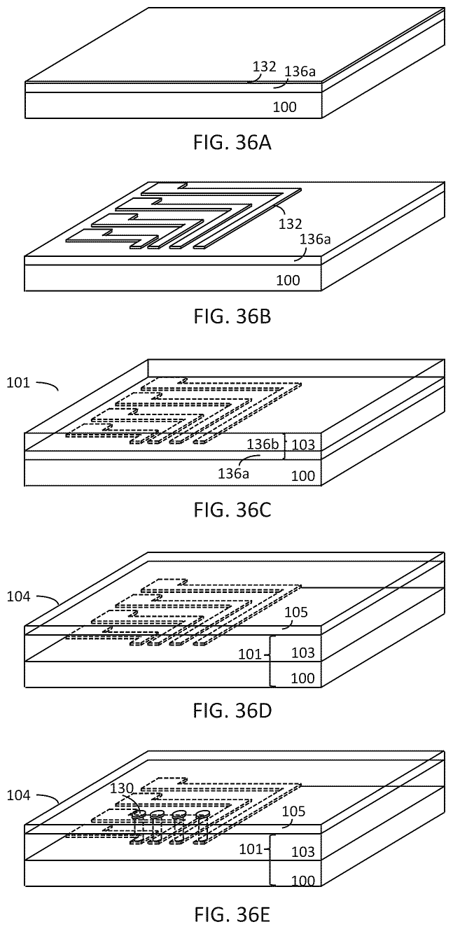

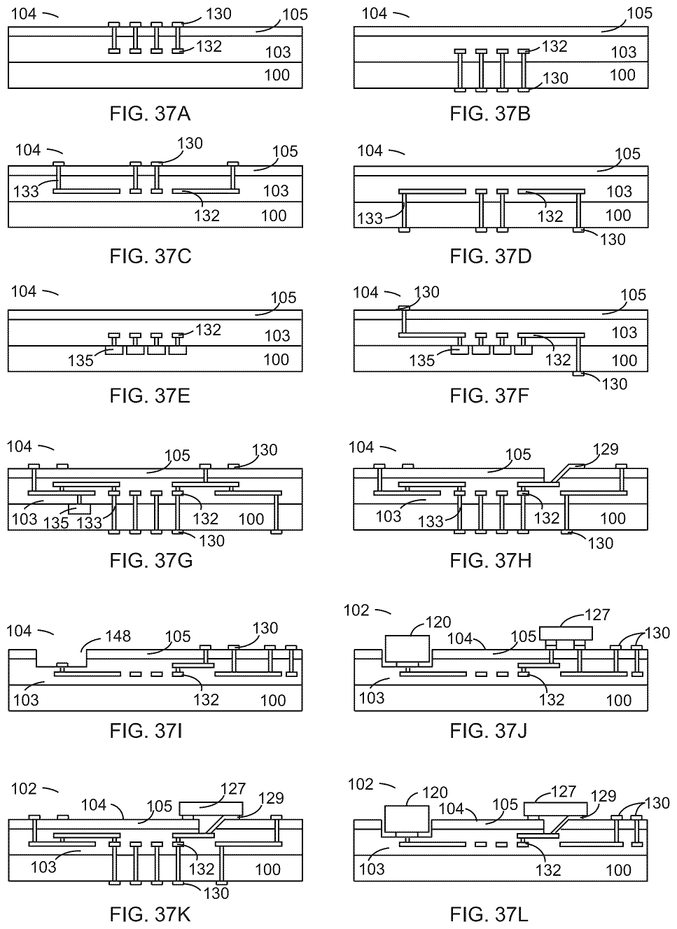

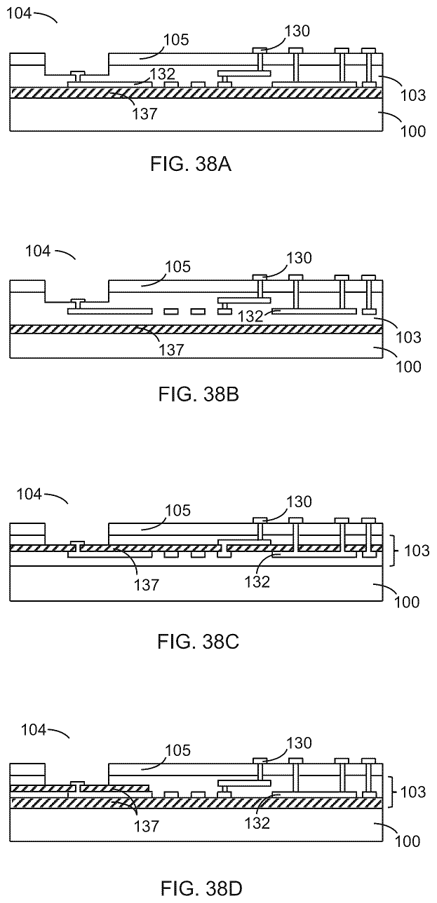

FIGS. 36A-36E show a sequence of steps in the formation of an optical interposer structure 104 having an electrical interconnect layer 103 and the formation of conductive electrical traces 132 encapsulated within an intermetal dielectric layer 136. Some example configurations of the conductive layers formed on embodiments of optical interposer structure 104 are provided in FIGS. 37A-37L. And in FIG. 38, some example configurations are shown that include the use of thermally conductive insulating layers in the intermetal dielectric layers of the electrical interconnect layer 103.

FIG. 36A-36E show example steps in the formation of an electrical interconnect layer 103 on an embodiment of an optical interposer structure 104. In the embodiment of the optical interposer structure 104, a single conductive layer 132 is formed in electrical interconnect layer 103. In other embodiments, more than two conductive layers 132 may be formed.

FIG. 36A shows a portion of an embodiment of an optical interposer structure 104 comprising substrate 100, first intermetal dielectric layer 136a, and unpatterned conductive layer 132. FIG. 36A shows substrate 100. Substrate 100 in some embodiments is a semiconductor substrate such as silicon. Other semiconductor materials may also be used, as well as insulating materials, metal materials, and combinations of semiconductor, insulating, and metal layers to form a substrate 100. FIG. 36A also shows a first dielectric layer 136a on substrate 100. First dielectric layer 136a is a first layer of intermetal dielectric layer 136a. First intermetal dielectric layer 136a may be a layer of silicon dioxide, for example. Other dielectrics may also be used. FIG. 36C also shows the conductive metallization layer 132 on insulating dielectric layer 136a. Conductive layer 132 may be, for example, a layer of aluminum or an alloy of aluminum. Conductive layer may be a layer of copper, for example. Other conductive layers and combinations of conductive layers may also be used to form conductive layer 132 in the embodiment.

FIG. 36B shows a portion of an embodiment of an optical interposer structure 104 comprising substrate 100, first intermetal dielectric layer 136a, and conductive layer 132 after patterning of conductive layer 132 to form conductive electrical interconnect traces. The patterning of the conductive layer may be performed, for example, using lithographic patterning and etching of the conductive layer 132. The formation of patterned conductive traces may also be performed using dual damascene processing well known in the art of semiconductor processing.

FIG. 36C shows a portion of an embodiment of an optical interposer structure 104 comprising substrate 100, first intermetal dielectric layer 136a, patterned conductive layer 132 after patterning of conductive layer 132 to form conductive electrical interconnect traces, and formation of second intermetal dielectric layer 136b.

FIG. 36C shows a second layer of intermetal dielectric layer 136b on patterned conductive layer 132 and on first dielectric layer 136a to form interposer base structure 101. In the embodiment shown, one layer of electrically conductive interconnects is provided within the layers of intermetal dielectric 136a,136b. In other embodiments, more than one layer of electrically conductive interconnects may be provided in the electrical interconnect layer 103. In some embodiments, the intermetal dielectric layer 136b may be planarized.

FIG. 36D shows an embodiment of an optical interposer structure 104 comprising substrate 100, electrical interconnect layer 103, and planar waveguide layer 105.

FIG. 36D shows the interposer base structure 101 with planar waveguide layer 105. Planar waveguide layer 105 may be comprised of multiple layers including one or more core layers, one or more cladding layers, and may also include spacer layers, buffer layers and other layers as described herein. FIG. 36D shows optical interposer structure 104 comprised of the planar waveguide layer on base structure 101 further comprised of electrical interconnect layer 103 and substrate 100.

FIG. 36E shows an embodiment of an optical interposer structure 104 comprising substrate 100, electrical interconnect layer 103, and planar waveguide layer 105 after formation and filling of vertical conductive vias to form vertical interconnections.

It should be noted that the optional interconnect layer 103 may not be required in some embodiments that do not include optoelectrical or electrical devices. PIC structures may be formed, for example, in some embodiments with optical devices that do not require electrical interconnections, and for these embodiments, the electrical interconnect layer 103 may not be included, but that may utilize methods and structures disclosed herein that enable the formation of alignment pillars self-aligned to patterned planar waveguide cores 144 as described herein.

FIG. 37A-37L show embodiments of optical interposer structure 104 having electrical interconnect layer 103 configured with various example routings of the conductive traces.

FIGS. 37A-37L show schematic cross-sectional drawings of example configurations for the routing of conductive layers in electrical interconnect layer 103 and other portions of the layered film structure in embodiments of optical interposer structure 104. In FIGS. 37A-37L, example configurations of the routing of the electrically conductive layer 132 within the electrical interconnect layer 103 and from within the electrical interconnect layer 103 to locations at the front and back surfaces of the optical interposer structure 104 are described.

In the description of the configurations shown in FIGS. 37A-37L provided herein, the front side of the optical interposer structure 104 is the closer to the top of the page and the back side of the optical interposer structure 104 is the closer to the bottom of the page with the label “FIG. 37K” positioned at the bottom of the page.

FIG. 37A shows an embodiment of the electrically conductive layer 132 with connections formed to the top surface of the optical interposer structure 104. In the embodiment shown, the planar waveguide layer 105 may include a top dielectric layer such as a spacer layer, a buffer layer, a planarization layer or other layer. Electrical contacts 130 are formed at the top surface as shown to accommodate electrical connections to mounted devices and to other locations on interposer-based PICs, via for example, wire bonding or other metallization schemes. Electrical contacts 130 may also facilitate mounting of the interposer to another interposer, submount, or other device.

FIG. 37B shows an embodiment of optical interposer structure 104 with electrically conductive layer 132 of electrical interconnect layer 103 having vertical connections formed to the back surface of the optical interposer structure 104. FIG. 37C shows an embodiment in which the electrically conductive layer 132 has lateral traces within the electrical interconnect layer 103 and with vertical connections to the top surface of the optical interposer structure 104 with terminal connections 130. FIG. 37D similarly shows an embodiment having lateral traces within the electrical interconnect layer 103 and with vertical connections to the back surface of the optical interposer structure 104 also terminating with contacts 130. FIG. 37E shows an embodiment of the optical interposer structure 104 with electrical interconnect layer 103 having electrically conductive layer 132 that include electrical interconnects that form a contact with embedded devices 135 in the substrate 100. Embedded devices 135 may be, for example, transistors, resistors, capacitors, inductors, or other electrical or optoelectrical devices. FIG. 37F shows an embodiment having lateral traces within the electrical interconnect layer 103 and with vertical connections to embedded devices 135 in the substrate 100 and vertical connections to the front and back of the optical interposer structure 104 terminating in contacts 130. In other embodiments, the vertical connections may terminate in either the front or back of the optical interposer structure 104. Embedded devices 135 may be formed in the substrate 100 or in the electrical interconnect layer 103 or another layer in the optical interposer structure 104.

FIG. 37G shows an embodiment of optical interposer structure 104 with electrical interconnect layer 103 having multiple electrically conductive layers 132 with vertical interconnections between these layers. This embodiment also shows vertical connections from the electrically conductive lateral traces 132 to contacts 130 formed on the front surface of the optical interposer structure 104 and vertical connections from the lateral traces 132 to contacts 130 on the back side of the optical interposer structure 104.

FIG. 37H shows an embodiment similar to that described for FIG. 37G with the addition of an electrically conductive optical reflector structure 128 that also forms an electrical contact between an electrically conductive layer 132 and the top surface of the optical interposer structure 104.

FIG. 37I shows an embodiment having a cavity formed in the planar waveguide layer 105, and optionally into the intermetal dielectric layer 136. In the embodiment, vertical connections are provided from an electrically conductive layer 132 to the cavity 148. Cavity 148, in the embodiment, enables the mounting of optoelectrical devices, for example, that can be coupled to patterned planar waveguides formed from the planar waveguide layer 105 as shown in FIG. 37J. Optical device 120, in embodiments, may be an optoelectrical device that couples to the waveguide layer 105 or to patterned planar waveguides formed from the waveguide layer 105. Also shown in FIG. 37J is surface mounted device 127 mounted to electrical contacts 130 formed on the top surface of the optical interposer structure 104 to form assembly 102.

FIG. 37K shows an embodiment of assembly 102 that includes optical interposer structure 104 having electrical interconnect layer 103 and surface mounted device 127. The surface mounted device has an electrical contact formed with a contact 130 and another electrical contact formed through the reflector 129, in the embodiment, to an electrical interconnect layer 132. In the embodiment, the surface mounted device can receive a signal from, or deliver a signal to, the planar waveguide layer 105 or patterned planar waveguides formed from the planar waveguide layer 105 with the change in direction provided by the reflector 129. The embodiment shown in FIG. 6A also includes vertical connections to the back surface of the optical interposer structure 104 of assembly 102.

FIG. 37L shows an embodiment of assembly 102 comprised of an embodiment of optical interposer structure 104 and cavity-mounted optical device 120 and surface mounted device 127 in which an electrical contact is formed between the surface mounted device 127 and the electrical interconnect layer 132 through reflector structure 129.

In FIGS. 37A-37L, embodiments of optical interposer structure 104 and assemblies 102 that include optical interposer structures 104 are shown. In these embodiments, various configurations of electrically conductive layer 132 in the electrical interconnect layer 103 are shown. Other configurations that utilize combinations of the features of the embodiments shown are also within the scope of embodiments.

Additionally, patterned electrically conductive traces may also be formed on the top of the planar waveguide layer and on other dielectric layers formed on the planar waveguide layer.

Additionally, electrical interconnections formed using wire bonding techniques and solder ball methods may also be used to form electrical connections, particularly between electrical contacts 130 and other contacts formed above the planar waveguide layer 105. Electrical connections may also be formed within mounted devices connected to the electrical contacts 130, for example.

The embodiments shown in FIGS. 37A-37L illustrate a number of various configurations of the electrically conductive layer 132 for the electrical interconnect layer 103. In other embodiments, portions of the intermetal dielectric layer 136 can be formed from thermally conductive dielectric layers, for example, to improve the extraction of thermal energy from heat generating portions of the optical interposer structure 104. FIG. 38A-38D shows some embodiments in which thermally conductive layers are incorporated into the electrical interconnect layer 103 and other portions of the optical interposer structure 104.

It should be noted that the optional interconnect layer 103 may not be required in some embodiments that do not include optoelectrical or electrical devices. PIC structures and assemblies may be formed, for example, in some embodiments with optical devices that do not require electrical interconnections, and for these embodiments, the electrical interconnect layer 103 may not be included.

FIG. 38A-38D show embodiments of optical interposer structure 104 configured with one or more high thermal conductivity layers.

FIG. 38A shows an embodiment of optical interposer structure 104 having thermally conductive layer 137 in a portion of the electrical interconnect layer 103. In the embodiment shown, the thermally conductive layer 137 is shown with coverage across the substrate 100. In other embodiments, the thermally conductive layer 137 may occupy a portion of the area of the substrate 100. In the embodiment, the thermally conductive layers are shown in contact with electrically conductive layers 132 in the electrical interconnect layer 103.

Thermally conductive layer 137 is an electrically insulating layer and may be, for example, a layer of aluminum nitride or an alloy of aluminum nitride. Other thermal conductive layers may also be used.

FIG. 38B shows another embodiment of optical interposer structure 104 having thermally conductive layer 137 in a portion of the substrate 100. In the embodiment shown, the thermally conductive layer 137 is shown with coverage across the substrate 100. In other embodiments, the thermally conductive layer 137 may occupy a portion of the area of the substrate 100. In the embodiment, the thermally conductive layers are shown in contact with an electrically insulating layer 136 in the electrical interconnect layer 103.

FIG. 38C shows yet another embodiment of optical interposer structure 104 having thermally conductive layer 137 in another portion of the electrical interconnect layer 103. In the embodiment shown, the thermally conductive layer 137 is shown within the electrical interconnect layer 103.

FIG. 38D shows yet another embodiment of optical interposer structure 104 having thermally conductive layer 137 in yet other portions of the electrical interconnect layer 103. In the embodiment shown, the thermally conductive layer 137 is shown above and below the electrically conductive layer 132 of the electrical interconnect layer 103.

The inclusion of thermally conductive layers 137 at and below the electrical interconnect layer enables more effective control of temperature in optical interposer structures 104 and the control of optical devices 120 mounted in cavity 148 of the optical interposer structure 104 in assemblies 102.

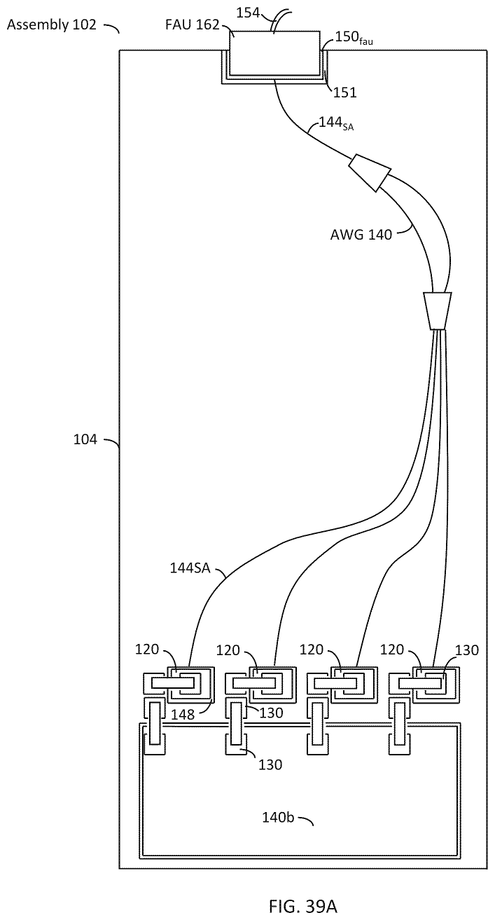

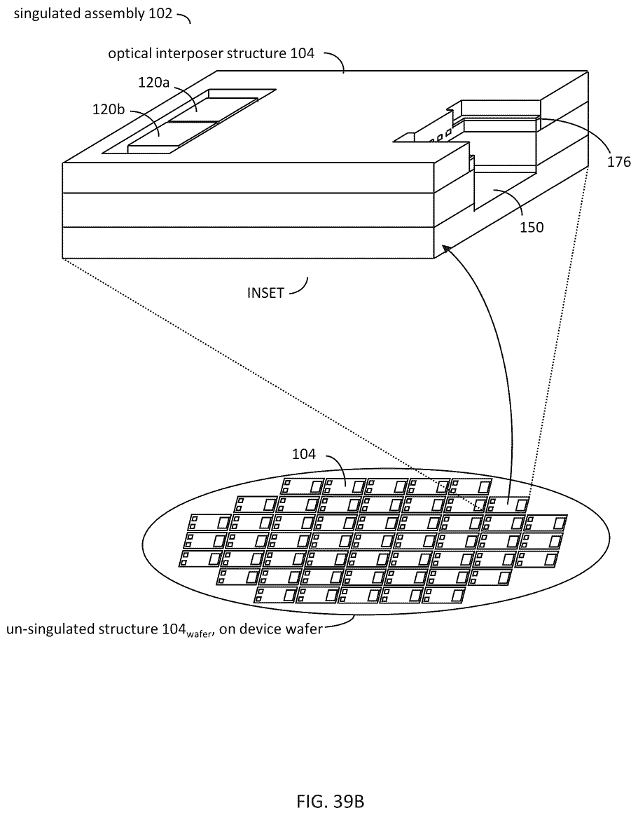

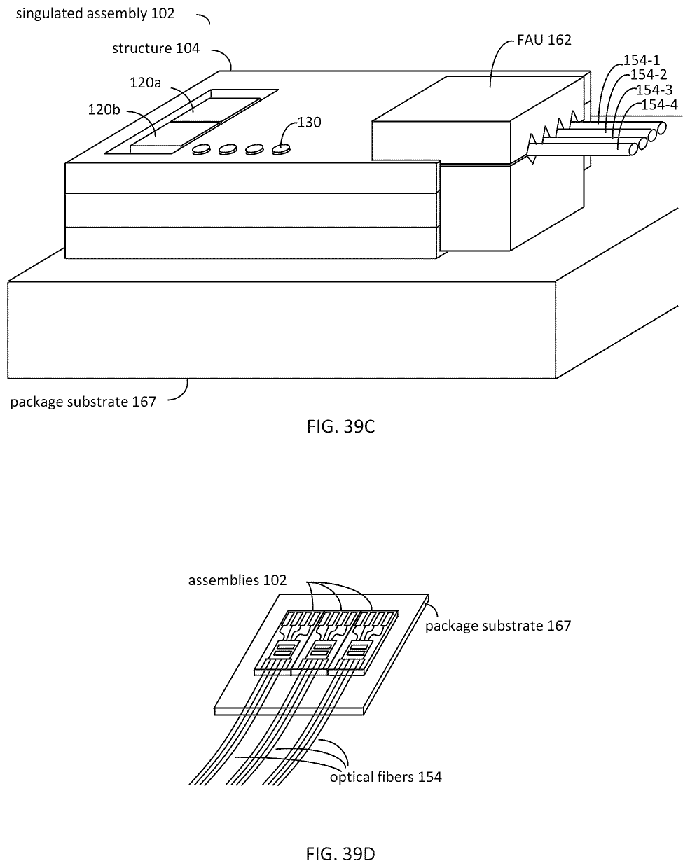

FIGS. 39A-39D show example configurations of assembly 102, and in the formation of singulated devices formed from optical interposer structures 104 used in assemblies 102.

FIG. 39A shows an example photonic integrated circuit formed using assembly 102 comprising an embodiment of optical interposer structure 104 and mounted devices 120 as may be used for example in receiver devices and transmitter devices in optical communications networks. In the embodiment, optical interposer structure 104 is shown having a plurality of patterned planar waveguide cores 144_{SA}. In the example photonic integrated circuit formed on the embodiment, an arrayed waveguide (AWG) 140 is shown. All or a portion of the AWG 140 may be formed from planar waveguide layer 105 as disclosed herein for devices 140 described herein. A second PIC structure 140b is shown mounted on optical interposer structure 104 in the embodiment in FIG. 39A.

Patterned planar waveguide cores 144_{SA} are formed self-aligned with alignment pillars formed in cavities 148. Optical devices 120 are shown mounted in the plurality of cavities in the embodiment. Electrical contacts 130 formed on the optical interposer structure 104 enable electrical connections to be formed between the optical devices 120 and the electrical interconnect layer 103. Other devices 140 may be formed on the optical interposer structure 104, such as, for example a modulator, a transimpedance amplifier, among other devices used in photonic integrated circuits. Other devices may also be mounted that do not require electrical interconnections such as lenses, isolators, among others. Electrical and non-electrical devices may be positioned on embodiments of optical interposer structure 104 using alignment aids formed using the methods and structures disclosed herein.

An FAU 162 is shown mounted on optical interposer structure 104 in the embodiment, wherein the FAU mounting site 150_{fau} is shown having lateral alignment aid 151. Lateral alignment aid 151 enables lateral alignment of the core of optical fiber 154 to be aligned with the patterned planar waveguide core 144_{SA}. Mounting sites for other optical devices 120 and other optoelectrical devices 120 may also be aligned using methods and structures disclosed herein in other embodiments.

FIG. 39B shows a perspective schematic drawing of a wafer level formation of a plurality of optical interposer structures 104 and in the INSET shows a singulated optical interposer structure 104 having mounted devices 120a, 120b to form an embodiment of an assembly 102. A plurality of optical interposer structures 104 may be formed at the wafer level as shown, for example, in unsingulated optical interposer 104_{wafer} in FIG. 39B. Wafer level processing provides more efficient fabrication methods to be used in the formation of optical interposer structure 104.

FIG. 39C shows a perspective schematic drawing of an embodiment of a singulated optical interposer structure 104 having mounted devices 120a, 120b and mounted optical fibers 154-1 to 154-4 in FAU 162 to form an embodiment of an assembly 102 wherein the assembly 102 is mounted onto a package substrate 167. Packaging substrates may be formed from one or more of a metal, a ceramic, and an insulator, and combinations of these materials to facilitate the mounting and assembly of one or more optical interposer structures 104 with other devices and structures used in the formation of all or a portion of photonic integrated circuits.

FIG. 39D shows another perspective schematic drawing of an embodiment of a plurality of assemblies 102 comprising a plurality of optical interposer structures 104 and a plurality of optical fibers 154 mounted onto a package substrate 167. Package substrate 167 may be used in pluggable modules, for example, and other modules to facilitate implementation into optical networks that utilize photonic integrated circuits.

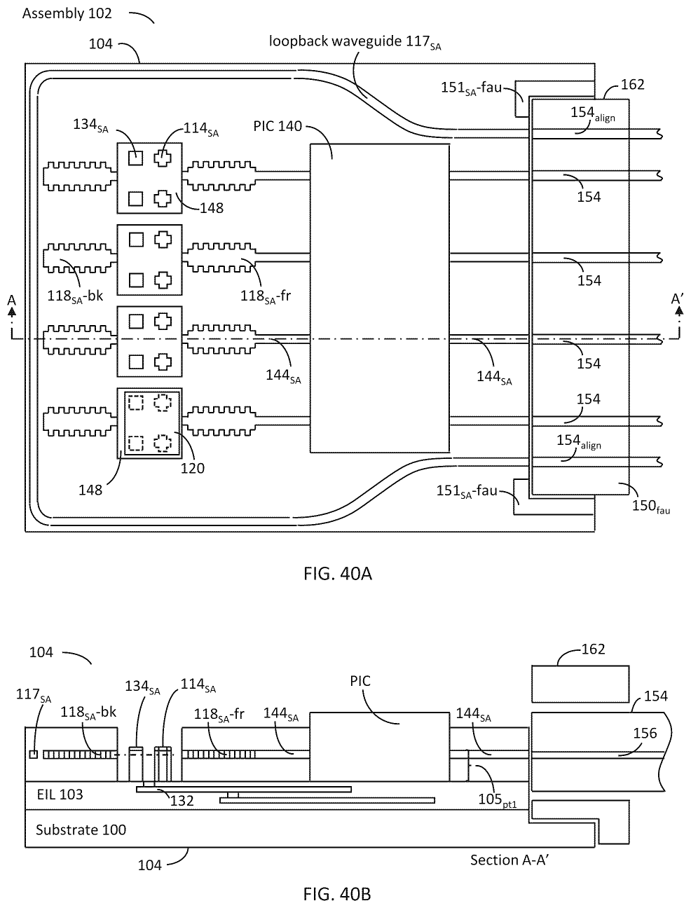

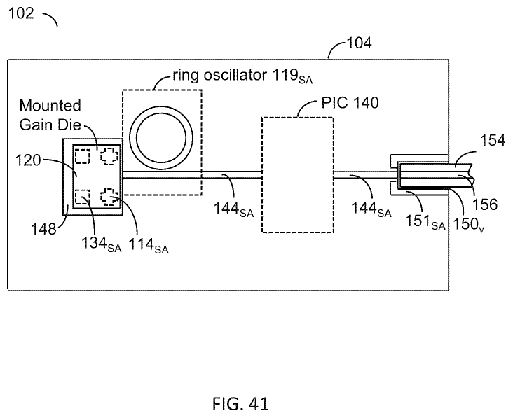

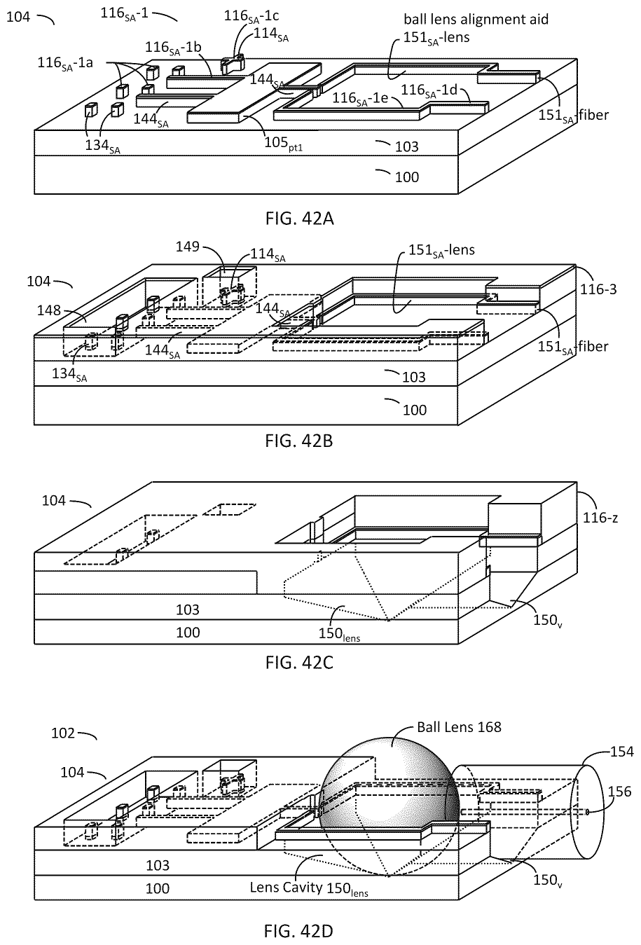

The self-aligned lateral alignment features as disclosed herein in embodiments, may be used to form alignment features for other devices such as a ball lens, for example, among other devices. Additionally, self-aligned devices that may be formed from all or a portion of the core layer 150_{core} of the planar waveguide layer 105, may be formed in self-alignment with other self-aligned patterned planar waveguide cores 144_{SA} and with self-aligned alignment features such as fiducials 114_{SA} and alignment pillars 134_{SA}. FIGS. 40A-40B and FIG. 41 embodiments of optical interposer structure 102 having alignment features wherein the self-aligned structures include wavelength selection devices such as distributed Bragg reflectors (DBRs) and ring oscillators. FIGS. 42A-42D show and embodiment that includes a ball lens mounted in self-alignment with the core of an optical fiber and a patterned planar waveguide core 144_{SA}.

FIG. 40A shows a top-down schematic drawing an assembly 102 comprising a mounted device 120 and an embodiment of optical interposer structure 104 that includes patterned first portion of planar waveguide layer 105ₚₜ₁ having self-aligned features wherein the self-aligned features include patterned planar waveguides 144_{SA}, front and back DBR grating structures 118_{SA}-fr, 118_{SA}-bk, alignment pillars 134_{SA}, fiducials 114_{SA}, a loopback waveguide 117_{SA}, and FAU lateral alignment pillars 151_{SA}. FIG. 40B shows a cross-section schematic drawing of the assembly 102 shown in FIG. 40A, taken through Section A-A′ of FIG. 40A.

The formation of devices such as front DBR 118_{SA}-fr and back DBR 118_{SA}-bk, from planar waveguide layer 105, shows an example of a device that can be formed in self-alignment with other devices and structures on the optical interposer structure 102 in embodiments. An optical device 120 such as a semiconductor gain device having self-alignment features, may be placed over alignment pillars 134_{SA} in cavity 148 and mounted in alignment with the DBR structure formed in self-alignment with the front and back DBRs, 118_{SA}-fr, 118_{SA}-bk, respectively.

FIG. 40A further shows additional structures that include a loopback waveguide 117_{SA}, and the alignment pillars 151_{SA}-fau. The loopback waveguide 117_{SA} may be used in embodiments either without or in combination with the lateral alignment aids 151_{SA}-fau to provide active alignment using the self-alignment feature of the patterned planar waveguide cores 144_{SA} and the loopback waveguide 117_{SA} to measure the output from an optical signal propagating through one of the alignment fibers 154_{align}, through the loopback waveguide 117_{SA}, and exiting through the second alignment fiber 154_{align}. By maximizing the power output from the alignment fiber 154_{align}, for example, or another optical parameter, one can use the alignment fibers 154_{align} in conjunction with the loopback waveguide 117_{SA} to align all of the other fibers 154 mounted in the FAU with corresponding patterned planar waveguide cores 144_{SA} on the optical interposer structure 102.

The lateral alignment pillars 151_{SA}-fau may be used with, or instead of, the power measurement for alignment. Self-alignment of the FAU alignment aids 151_{SA}-fau and the patterned planar waveguide cores 144_{SA} may provide satisfactory alignment of the FAU, and alignment of the cores 156 of the fibers 154 mounted in the FAU 162 with the patterned planar waveguide cores 144_{SA} that are formed self-aligned with the patterned planar waveguide cores 144_{SA}.

FIGS. 40A and 40B show an embodiment having both front and back DBRs. In other embodiments, only one DBR may be used in combination, for example, with a metallic reflector on a facet of a gain device to form a second reflector.

And in other embodiments, additional self-alignment devices may be included, as for example, the arrayed waveguides as all or a portion of PIC 140 described herein in FIG. 39A.

FIG. 41 shows a top-down schematic drawing an assembly 102 comprising a mounted device 120 and an embodiment of optical interposer structure 104 that includes patterned first portion of planar waveguide layer 105ₚₜ₁, including the waveguide core, having self-aligned features wherein the self-aligned features include patterned planar waveguides 144_{SA}, ring oscillator 119_{SA}, alignment pillars 134_{SA}, fiducials 114_{SA}, and FAU lateral alignment pillars 151_{SA}. FIG. 41 shows yet another embodiment of an optical interposer structure 104 having a multiplicity of self-aligned features. Ring oscillators 119 SA may be formed in embodiments in self-alignment with patterned planar waveguide cores 144_{SA} and with alignment pillars 134_{SA} and fiducials 114_{SA} to enable, for example, passive alignment of an optical device 120 such as a semiconductor gain device. The alignment of a semiconductor gain device having complementary alignment features to those in cavity 148 enables more precise alignment of the mounted gain device with the waveguide of ring oscillator 119 SA formed in self-alignment with the alignment aids in the cavity 148. More precise and repeatable alignment of the gain device with the waveguide of the ring oscillator 119_{SA}, may provide more repeatable wavelength selection output from the ring oscillator while providing passive alignment of the gain devices.

FIGS. 42A-42D show perspective schematic drawings of some steps in the formation of an embodiment of an optical interposer structure 104 having self-aligned alignment features that include lateral alignment aids for aligning a ball lens mounted in a cavity, the core of an optical fiber mounted in a v-groove, and patterned planar waveguide core 144 of planar waveguide layer 105.

FIG. 42A shows a schematic perspective drawing of an embodiment of optical interposer structure 104 that includes self-aligned lateral alignment aids 151_{SA-fiber} for laterally aligning the core 156 of an optical fiber 154 and lateral alignment aids 151_{SA}-lens for laterally aligning the optical axis of a ball lens to patterned planar waveguide cores 144_{SA} after formation of patterned first mask layer 116_{SA}-1 and patterning of first portion of patterned planar waveguide layer 105ₚₜ₁. Patterned portions of self-aligned mask layer 116_{SA}-1 include 116_{SA}-1a to facilitate formation of alignment pillars 134_{SA}, 116_{SA}-1b to facilitate formation of patterned planar waveguide cores 144_{SA}, 116_{SA}-1c to facilitate formation of fiducial 114_{SA}, 116_{SA}-1d to facilitate formation of fiber alignment aid 151_{SA-fiber}, and 116_{SA}-le to facilitate formation of ball lens alignment aid 151_{SA}-lens. Other additional patterns for other alignment features and devices may be included in other embodiments.

FIG. 42B shows a schematic perspective drawing of the embodiment of optical interposer structure 104 of FIG. 42A after removal of the first patterned mask layer 116_{SA} from the patterned planar waveguide cores 144_{SA}, after formation of the second portion of planar waveguide layer 105ₚₜ₂, formation of cavities 148, 149, and formation of a first portion of cavities for mounting a ball lens and a fiber 154. Patterned mask layer 116-3, which includes patterns to facilitate formation of cavities 148,149, is shown

FIG. 42C shows a schematic perspective drawing of the embodiment of optical interposer structure 104 of FIG. 42B after formation of cavity 150ₗₑₙₛ and v-groove 150ᵥ for mounting a ball lens 168 and optical fiber 154 in lateral alignment with a patterned planar waveguide core 144_{SA}. Mask layer 116-z that includes the patterned portions for the formation of the v-groove and lens cavity is shown in FIG. 42C.

FIG. 42D shows a schematic perspective drawing of the embodiment of optical interposer structure 104 of FIG. 42C after removal of patterned mask layer 116-z and after mounting a ball lens 168 and optical fiber 154 in lateral alignment with a patterned planar waveguide core 144_{SA}. In the embodiment, the fiber is shown in close proximity to the ball lens 168 for clarity. In other embodiments, additional spacing may be provided between the facet of the core of the optical fiber 154, the surface of the ball lens 168, and between the surface of the ball lens and the facet of the patterned planar waveguide core 144_{SA}.

Lateral alignment of a ball lens using lateral alignment aids 151_{SA}-lens formed in self-alignment with patterned planar waveguide cores 144_{SA}, and further coupled with lateral alignment aids 151_{SA}-fau, enables the formation of assemblies 102 having multiple devices including the optical fiber 154, the ball lens 168, and the patterned planar waveguide cores 144_{SA} of the optical interposer structure 102.

The foregoing descriptions of embodiments have been presented for purposes of illustration and description and are not intended to be exhaustive or to limit embodiments to the forms disclosed. Modifications to, and variations of, the disclosed embodiments will be readily apparent to those skilled in the art, and the general principles defined herein may be applied to other embodiments without departing from the spirit and scope of the embodiments disclosed herein. Thus, embodiments should not be limited to those specifically described herein but rather are to be accorded the widest scope consistent with the principles and features disclosed herein.

What is claimed is:

1. An optical subassembly comprising:
a substrate;
an electrical interconnection layer disposed on the substrate, wherein the electrical interconnection layer comprises at least a first electrical interconnection line,
wherein the at least a first electrical interconnection line is configured to be electrically coupled to a first terminal of a first device assembled on the electrical interconnection layer;
a waveguide formed on the electrical interconnection layer,
wherein the waveguide comprises a top cladding layer on a core layer on a bottom cladding layer,
wherein the top cladding layer extends toward the core layer to cover two opposite sides of the core layer and the bottom cladding layer,
wherein the core layer comprises silicon oxynitride.

2. An optical subassembly as in claim 1,
wherein the at least a first electrical interconnection line is configured to be electrically coupled to a first terminal of a first device disposed on the electrical interconnection layer,
wherein the first device comprises an optical element or an optoelectrical element configured to be aligned with the waveguide.

3. An optical subassembly as in claim 1, further comprising
a second device fabricated on the substrate under the electrical interconnection layer,
wherein the at least a first electrical interconnection line or a second electrical interconnection line in the electrical interconnection layer is coupled to a second terminal of the second device.

4. An optical subassembly as in claim 1,
wherein the at least a first electrical interconnection line is configured to be electrically coupled to a first terminal of a first device disposed on the electrical interconnection layer,
wherein the first device comprises an optical element or an optoelectrical element configured to be aligned with the waveguide,
the optical assembly further comprising
a second device fabricated on the substrate under the electrical interconnection layer,
wherein the at least a first electrical interconnection line or a second electrical interconnection line in the electrical interconnection layer is coupled to a second terminal of the second device,
wherein the second device is configured for electrically communication with the first device.

5. An optical subassembly comprising
a substrate;
an electrical interconnection layer disposed on the substrate,
wherein the electrical interconnection layer comprises at least a first electrical interconnection line;
a waveguide formed on the interconnection layer,
wherein the waveguide comprises a top cladding layer disposed on a core layer, with the core layer disposed on a bottom cladding layer,
wherein the core layer is embedded at least partially in the top cladding layer,
wherein the core layer comprises silicon oxynitride;
a cavity formed on and through at least the top cladding layer,
wherein the cavity contacts the waveguide to expose a facet of the core layer,
wherein the cavity is configured to house a device coupled to the facet of the core layer,
wherein the device comprises a terminal configured to electrically couple to the at least an electrical interconnection line.

6. An optical subassembly as in claim 5,
wherein the core layer is partially embedded in the top cladding layer, with the top cladding layer disposed on the embedded core area, with the top cladding layer disposed on a portion of the core layer not embedded in the top cladding layer, and with a portion of the core layer not embedded in the top cladding layer disposed on the bottom cladding layer at areas outside the embedded core area,
wherein the cavity is formed through the top cladding layer, the portion of the core layer not embedded in the top cladding layer, and the bottom cladding layer.

7. An optical subassembly as in claim 5,
wherein the core layer is totally embedded in the top cladding layer, with the top cladding layer disposed on the embedded core area and disposed on the bottom cladding layer at areas outside the embedded core area,
wherein the cavity is formed through the top cladding layer, and the bottom cladding layer.

8. An optical subassembly as in claim 5,
wherein the core layer and the bottom cladding layer are totally embedded in the top cladding layer, with the top cladding layer disposed on the embedded core area and on the electrical interconnection layer outside the embedded core and bottom cladding area,
wherein the cavity is formed through the top cladding layer.

9. An optical subassembly as in claim 5, further comprising
a second device fabricated on the substrate under the electrical interconnection layer,
wherein the at least a first electrical interconnection line or a second electrical interconnection line in the electrical interconnection layer is coupled to a second terminal of the second device.

10. An optical subassembly comprising
a substrate;
an electrical interconnection layer disposed on the substrate,
wherein the electrical interconnection layer comprises at least a first electrical interconnection line;
a waveguide formed on the electrical interconnection layer,
wherein the waveguide comprises top cladding layer on a core layer on a bottom cladding layer,
wherein the top cladding layer extends toward the core layer to cover at least portions of two opposite sides of the core layer,
wherein the top cladding layer extends outward from the two opposite sides of the core layer,
wherein the core layer comprises a first optical axis configured to show a first propagation direction of optical signals in the waveguide,
wherein the core layer and the cladding layers comprise silicon oxynitride;
a cavity formed on the top cladding layer and through at least the top cladding layer, wherein the cavity is adjacent to the waveguide to expose a facet of the core layer,
one or more alignment aid elements disposed in the cavity,
wherein the one or more alignment aids are configured to assist in aligning a second optical axis of an optical or optoelectronic device assembled in the cavity with the first optical axis,
wherein the device is configured to be electrically coupled to the at least a first electrical interconnection line.

11. A substrate as in claim 10,
wherein the one or more alignment aid elements comprise a first alignment aid element,
wherein the first alignment aid comprises a first outer surface,
wherein the first outer surface is separated by a first distance with the first optical axis,
wherein the first distance is configured to match with a second distance,
wherein the second distance is a separation between a second outer surface of the device and a second optical axis of the device with the second optical axis configured to show a second propagation direction of optical signals to or from the device,
wherein the matching is configured to allow an alignment of the first optical axis with the second optical axis when the device is assembled in the cavity on the substrate with the second outer surface contacting with the first outer surface.

12. A substrate as in claim 10,
wherein the one or more alignment aid elements comprise a second alignment aid element,
wherein the second alignment aid element comprises a third outer surface parallel to the first outer surface,
wherein the third outer surface is in a vicinity of the first optical axis,
wherein the second alignment aid element comprises a fiducial pattern configured for assisting in placing the device in the cavity on the substrate.

13. A substrate as in claim 10,
wherein the one or more alignment aid elements comprise a third alignment aid element,
wherein the third alignment aid element comprises a fourth outer surface not parallel to the first outer surface,
wherein the fourth outer surface is configured to be separated with a fifth outer surface of the device by a distance less than an alignment tolerance between the first and second optical axes.

14. A substrate as in claim 10,
wherein the one or more alignment aid elements comprise a fourth alignment aid element,
wherein the fourth alignment aid element comprises an alignment constraint for laterally aligning an optical fiber,
wherein the alignment constraint is configured to align an optical axis of the optical fiber with the first optical axis in a lateral direction.

15. A substrate as in claim 10,
wherein the first or second alignment aid element comprises a pillar or a recess comprising a top layer comprising a top surface with the top surface being the first or third outer surface, respectively.

16. A substrate as in claim 10,
wherein the first or second alignment aid element comprises a top layer comprising Al, an alloy of aluminum, AlOx, Au, Ag, Ni, Pt, Ti, TiOx, Ta, or TaOx.

17. A substrate as in claim 10,
wherein the third outer surface is aligned with the first surface with a tolerance of a photolithography process.

18. A substrate as in claim 10,
wherein the fourth outer surface is configured to establish a limit for the device optical component to travel in a direction parallel to the lateral plane to be within the alignment tolerance.

19. A substrate as in claim 10,
wherein the third alignment aid element is configured to prevent misalignments of the second optical axis with the first optical axis by limiting movements of the device during a soldering aligning process.

20. A substrate as in claim 10,
wherein the fourth alignment aid element comprises a v-groove alignment aid disposed along the optical fiber.
